(19) United States
(12) Patent Application Publication
(10) Pub. No.: US 2008/0292357 A1
(43) Pub. Date: Nov. 27, 2008

(54) Image Forming Apparatus, Computer-Readable Medium, Image Forming System, and Image Forming Method

(76) Inventors: Keiichi Taguchi, Nagano-ken (JP); Ken Yoshizuka, Nagano-ken (JP); Ken Ikuma, Nagano-ken (JP)

Correspondence Address: HOGAN & HARTSON L.L.P., 1999 AVENUE OF THE STARS, SUITE 1400, LOS ANGELES, CA, 90067, US

(21) Appl. No.: 10/571,517

(22) PCT Filed: Mar. 8, 2005
(86) PCT No.: PCT/JP2005/003992

§ 371 Date: Aug. 18, 2008

(30) Foreign Application Priority Data
Mar. 10, 2004 (JP) 2004-068034
Mar. 10, 2004 (JP) 2004-068035
Mar. 10, 2004 (JP) 2004-068037
Mar. 24, 2004 (JP) 2004-087437
Mar. 31, 2005 (JP) 2005-024101
Mar. 31, 2005 (JP) 2005-024102

(51) Int. Cl. G03G 15/04

(52) U.S. Cl. 399/119

(57) ABSTRACT

An image forming system, etc., which provides a user or the like with great convenience is achieved. For example, an image forming apparatus is usable as a color image forming apparatus for forming color images and is usable as a monochrome image forming apparatus for forming monochrome images, and by moving one developing unit among attached developing units to an attach/detach position, a developing unit becomes replaceable. A timing for moving the predetermined developing unit to the attach/detach position when an event occurs in which development cannot be performed with the predetermined developing unit is different for when the image forming apparatus is being used as a color image forming apparatus and for when the image forming apparatus is being used as a monochrome image forming apparatus. See FIG. 12, for example.

### TECHNICAL FIELD

The present invention relates to image forming apparatuses, computer-readable media, image forming systems, and image forming methods.

### BACKGROUND ART

As regards image forming apparatuses, there are known, for example, image forming apparatuses which can form color images and which have a plurality of attach/detach sections to and from which can be attached and detached a plurality of developing units for developing latent images using a contained developer. Such an image forming apparatus can be used as a monochrome image forming apparatus for forming monochrome images when at least two developing units which contain developer of the same color are attached to the plurality of attach/detach sections. When used as a monochrome image forming apparatus, development is performed by changing the attached developing units which contain developer of the same color (hereafter, “same-color developing units”). When the developer contained in all the attached same-color developing units runs out, a message to this effect is displayed in a displaying section or the like and the image-forming operation stops.

However, when using the above-mentioned image forming apparatus as a monochrome image forming apparatus, if a message indicating that there is no more developer is displayed, then images can no longer be formed until a new developing unit is attached because the developer in all the attached developing units has run out. In other words, if the message indicating that the developer has run out is displayed in the middle of executing a print job for printing a plurality of pages, the print job being executed must be interrupted. Further, in order to finish the print job, the developing units must be replaced, creating the problem of reduced throughput.

On the other hand, when the image forming apparatus is used as a color image forming apparatus, formation of normal color images becomes impossible if even one of the developing units becomes unable to perform development, for example, if a developer of one of the colors runs out. In this case, the user runs the risk of wasting developer or print paper if the image-forming operation is continued in order to finish the print job.

In other words, when used as a monochrome image forming apparatus or when used as a color image forming apparatus, there arises the problem of inconvenience for the user. Additionally, there exists the problem that the timing, at which the message which indicates the predetermined developing unit's inability to perform development, might affect the convenience of the user.

Further, the above-mentioned image forming apparatus has, for example, a plurality of attach/detach sections to and from which can be attached and detached developing units containing developer of mutually differing colors, and can form color images. Such an image forming apparatus cannot print normal color images even if a developer of one of the colors runs out. Therefore, even if a printing instruction to print a plurality of pages is input, only several pages are developed for which development can be performed by the developing unit containing the least developer of all the attached developing units, and when the developer in that developing unit runs out, the developing unit which has run out of developer is moved to a removable position and stops.

Such an image forming apparatus can print monochrome images using the other developing units even if one of the developing units runs out of developer when forming monochrome images. However, there exists the problem of decreased throughput if the predetermined developing unit is moved to a removable position and stops when that developing unit runs out of developer, as with the above-mentioned image forming apparatus.

The present invention was arrived at in light of the foregoing issues, and it is an object thereof to achieve an image forming apparatus, computer-program, image forming system, and image forming method which are convenient for users. Another object is to achieve an image forming apparatus, a computer-readable medium, an image forming system, and an image forming method capable of suppressing a decrease in throughput when printing monochrome images.

### DISCLOSURE OF INVENTION

### Means for Solving the Problems

A main aspect of the invention is an image forming apparatus for forming images, including:

an image bearing member for bearing a latent image; and

a plurality of attach/detach sections to and from which developing units can be attached and detached, each developing unit containing a developer and being adapted to develop the latent image using the developer;

wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units;

wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units;

wherein by moving one of the developing units attached to the plurality of attach/detach sections to a predetermined attach/detach position, the moved developing unit is replaceable with another developing unit which has not been attached; and

wherein the timing for moving a predetermined developing unit to the attach/detach position when an event occurs in which development cannot be performed by the predetermined developing unit is different for when the image forming apparatus is being used as the color image forming apparatus and for when the image forming apparatus is being used as the monochrome image forming apparatus.

Another main aspect of the invention is an image forming apparatus for forming images, including:

an image bearing member for bearing a latent image;

a plurality of attach/detach sections to and from which developing units can be attached and detached, each developing unit containing a developer and being adapted to develop the latent image using the developer; and

an announcing section for announcing information indicating an event when an event requiring announcement occurs;

wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units;

wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units; and

wherein a timing for announcing, through the announcing section, information indicating an event when an event occurs in which development cannot be performed by the predetermined developing unit is different for when the image forming apparatus is being used as the color image forming apparatus and for when the image forming apparatus is being used as the monochrome image forming apparatus.

Another main aspect of the invention is an image forming apparatus for forming images, including:

an image bearing member for bearing a latent image; and

a plurality of attach/detach sections to and from which developing units can be attached and detached, each developing unit containing a developer and being adapted to develop the latent image using the developer;

wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units;

wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units;

wherein by moving one of the developing units attached to the plurality of attach/detach sections to a predetermined attach/detach position, the moved developing unit is replaceable with another developing unit which has not been attached; and

wherein an operation for moving a predetermined developing unit to the attach/detach position when an event occurs in which development cannot be performed by the predetermined developing unit is different for when the image forming apparatus is being used as the color image forming apparatus and for when the image forming apparatus is being used as the monochrome image forming apparatus.

Another main aspect of the invention is an image forming apparatus for forming images, including:

an image bearing member for bearing a latent image; and

a plurality of attach/detach sections to and from which developing units can be attached and detached, each developing unit containing a developer and being adapted to develop the latent image using the developer;

wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units;

wherein a predetermined operation is executed based on information indicating a state of the developing unit; and

wherein the predetermined operation is executed when an event in which all of the attached developing units have entered a predetermined state is detected based on the information, when the image forming apparatus is being used as the monochrome image forming apparatus.

Other features of the present invention will be made clear through the description of the present specification and the accompanying drawings.

### BRIEF DESCRIPTION OF DRAWINGS

FIG. 1 is a view showing major component elements which make up a printer when the printer is being used as a color printer.

FIG. 2 is a view showing major component elements which make up a printer when the printer is being used as a monochrome printer.

FIG. 3 is a schematic diagram of a developing device.

FIG. 4 is a cross-sectional view showing major component elements of the developing device.

FIG. 5A is a diagram showing a home position, which is a standby position when the printer is in standby mode and also the stop position which acts as a reference position for the rotational orientation of a developing device retaining unit 50.

FIG. 5B is a diagram showing a connector attach/detach position at which are opposed a developing-device-side connector for a black developing device attached to the developing device retaining unit and the apparatus-side connector provided to the apparatus body. FIG. 5C is a diagram showing the attach/detach position of the black developing device.

FIG. 6A is a view showing the separated positions of the developing-device-side connector and the apparatus-side connector on the black developing device 51.

FIG. 6B is a view showing the abutted position of the developing-device-side connector and the apparatus-side connector on the black developing device.

FIG. 7 is a block diagram showing a control unit of the printer.

FIG. 8 is a view explaining initial operations of the printer.

FIG. 9 is a view explaining processes and operation when executing color printing of one page in the case in which the printer is being used as a color printer.

FIG. 10 is a view explaining processes and operation when executing color printing of five pages in the case in which the printer is being used as a color printer.

FIG. 11 is a view explaining processes and operation of the printer when the remaining amount of toner in an M developing device falls equal to or below 5% when the printer is being used as a color printer.

FIG. 12 is a view explaining processes and operation of the printer when the rotation time of the developing roller on the M developing device has reached 1,000 seconds or more, when the printer is being used as a color printer.

FIG. 13 is a view explaining processes and operation of the printer when the remaining amount of toner in one K developing device falls equal to or below 5% when the printer is being used as a monochrome printer.

FIG. 14 is a view explaining processes and operation of the printer when the rotation time of a developing roller of one K developing device rises 1,000 seconds or more when the printer is being used as a monochrome printer.

FIG. 15 is a view explaining processes and operation of the printer when the rotation time of a developing roller of all the attached K developing devices rises 1,000 seconds or more when the printer is being used as a monochrome printer.

FIG. 16 is an explanatory diagram showing an external configuration of an image forming system.

FIG. 17 is a block diagram showing the configuration of the image forming system shown in FIG. 16.

FIG. 18 is a view showing major component elements which make up the printer when the printer is being used as a color printer.

FIG. 19 is a view showing major component elements which make up the printer when the printer is being used as a monochrome printer.

FIG. 20 is a schematic diagram of a developing device.

FIG. 21 is a cross-sectional view showing major component elements of the developing device.

FIG. 22A is a diagram showing a home position, which is a standby position when the printer is in standby mode and also the stop position which acts as a reference position for the rotational orientation of a developing device retaining unit 1050.

FIG. 22B is a diagram showing a connector attach/detach position at which are opposed a developing-device-side connector for a black developing device attached to the developing device retaining unit and the apparatus-side connector provided to the apparatus body. FIG. 22C is a diagram showing the attach/detach position of the black developing device.

FIG. 23A is a view showing the separated positions of a developing-device-side connector and the apparatus-side connector on the black developing device 1051.

FIG. 23B is a view showing the abutted position of the developing-device-side connector and the apparatus-side connector on the black developing device.

FIG. 24 is a block diagram showing a control unit of the printer.

FIG. 25 is a view explaining an initial operation of the printer.

FIG. 26 is a view explaining processes and operation when executing monochrome printing of five pages in the case in which the printer is being used as a monochrome printer.

FIG. 27 is a view explaining processes and operation of the printer when the remaining amount of toner in all the K developing devices falls equal to or below 5% when the printer is being used as a monochrome printer.

FIG. 28 is a view explaining processes and operation of the printer when the rotation time of developing rollers of all the K developing devices rises 1,000 seconds or more when the printer is being used as a monochrome printer.

FIG. 29 is an explanatory diagram showing an external configuration of an image forming system.

FIG. 30 is a block diagram showing the configuration of the image forming system shown in FIG. 29.

### LIST OF REFERENCE NUMERALS

10 Printer/20 Photoconductor/30 Charging unit/31 Home position detecting section/34 Apparatus-side connector/37 Attach/detach-dedicated opening/40 Exposing unit/50 Developing device retaining unit/50a, 50b, 50c, 50d Attach/detach sections/50e Rotating shaft/51 Black developing device/52 Cyan developing device/53 Magenta developing device/54 Yellow developing device/51a, 52a, 53a, 54a Developing-device-side memory/51b, 52b, 53b 54b Developing-device-side connector/55 Supporting frame/60 First transferring unit/70 Intermediate transferring member/75 Cleaning unit/76 Cleaning blade/80 Second transferring unit/90 Fixing unit/92 Paper supply tray/95 Display unit/100 Control unit/101 Controller section/102 Unit controller/103 Image-forming section/111 CPU/112 Interface/113 Image memory/114 Controller-section-side memory/114a EEPROM/114b RAM/116 Unit-controller-side memory/116a EEPROM/120 CPU/121 Serial interface (I/F)/122 Apparatus-side memory/123 I/O port/510 Developing roller/520 Seal member/524 Seal-urging member/530 Toner containing section/540 Housing/550 Toner supplying roller/560 Regulating blade/560a Rubber section/560b Rubber-supporting section/562 Blade-supporting metal plate/570 Blade-backing member/572 opening/700 Image forming system/701 Computer/702 Computer body/704 Display device/708 Input device/708A Keyboard/708B Mouse/710 Reading device/710A Flexible disk drive device/710B CD-ROM drive device/802 Internal memory/804 Hard disk drive unit/1010 Printer/1020 Photoconductor/1030 Charging unit/1031 Home position detecting section/1034 Apparatus-side connector/1037 Attach/detach-dedicated opening/1040 Exposing unit/1050 Developing device retaining unit/1050a, 1050b, 1050c, 1050d Attach/detach sections/1050e Rotating shaft/1051 Black developing device/1052 Cyan developing device/1053 Magenta developing device/1054 Yellow developing device/1051a, 1052a, 1053a, 1054a Developing-device-side memory/1051b, 1052b, 1053b, 1054b Developing-device-side connector/1055 Supporting frame/1060 First transferring unit/1070 Intermediate transferring member/1075 Cleaning unit/1076 Cleaning blade/1080 Second transferring unit/1090 Fixing unit/1092 Paper supply tray/1095 Display unit/1100 Control unit/1101 Controller section/1102 Unit controller/1103 Image-forming section/1111 CPU/1112 Interface/1113 Image memory/1114 Controller-section-side memory/1114a EEPROM/1114b RAM/1116 Unit-controller-side memory/1116a EEPROM, 1120 CPU/1121 Serial interface (I/F)/1122 Apparatus-side memory/1123 I/O port/1510 Developing roller/1520 Seal member/1524 Seal-urging member/1530 Toner containing section/1540 Housing/1550 Toner supplying roller/1560 Regulating blade/1560a Rubber section/1560b Rubber-supporting section/1562 Blade-supporting metal plate/1570 Blade-backing member/1572 Opening/1700 Image forming system/1701 Computer/1702 Computer body/1704 Display device/1708 Input device/1708A Keyboard/1708B Mouse/1710 Reading device/1710A Flexible disk drive device/1710B CD-ROM drive device/1802 Internal memory/1804 Hard disk drive unit/T Toner

### BEST MODE FOR CARRYING OUT THE INVENTION

At least the following matters will be made clear by the present specification and the accompanying drawings.

An image forming apparatus for forming images, includes: an image bearing member for bearing a latent image; and a plurality of attach/detach sections to and from which developing units can be attached and detached, each developing unit containing a developer and being adapted to develop the latent image using the developer; wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units; wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units; wherein by moving one of the developing units attached to the plurality of attach/detach sections to a predetermined attach/detach position, the moved developing unit is replaceable with another developing unit which has not been attached; and wherein the timing for moving a predetermined developing unit to the attach/detach position when an event occurs in which development cannot be performed by the predetermined developing unit is different for when the image forming apparatus is being used as the color image forming apparatus and for when the image forming apparatus is being used as the monochrome image forming apparatus.

With this kind of image forming apparatus, it is possible to move a predetermined developing unit to an attach/detach position in a timing suitable for a color image forming apparatus when an event occurs in which development cannot be performed by the predetermined developing unit, in the case in which the image forming apparatus is being used as a color image forming apparatus. When being used as a monochrome image forming apparatus, it is possible to move the predetermined developing unit to the attach/detach position with a timing suitable for a monochrome image forming apparatus, when an event occurs in which development cannot be performed by the predetermined developing unit. Since the developing unit with which development cannot be performed is moved to the attach/detach position, a user can replace the developing unit easily, without the hassle of checking and moving the unit with which development cannot be performed. For this reason, whether used as a color image forming apparatus or as a monochrome image forming apparatus, an image forming apparatus which is highly convenient for the user can be realized.

In this image forming apparatus, it is preferable that the image forming apparatus includes an image-forming section for forming an image on a medium by developing the latent image, and a controller for causing the image-forming section to form the image; a medium-unit job in which the image-forming section forms an image on a single medium is generated by the controller suitably outputting, to the image-forming section, a request for requesting formation of an image on a single medium, and the image-forming section outputting, to the controller, an acceptance response indicating that the request has been accepted, if image formation is possible; and the timing for moving the predetermined developing unit to the attach/detach position when the image forming apparatus is being used as the color image forming apparatus comes after forming the image according to the medium-unit job which has already been generated when an event occurs in which development cannot be performed by the predetermined developing unit.

With this kind of image forming apparatus, the operation of forming an image is not interrupted in the middle, since the predetermined developing unit is moved to the attach/detach position after the image has been formed based on the medium-unit job already generated when the event occurs in which development cannot be performed with the predetermined developing unit. In other words, since the image-forming operation is not interrupted with the image only partially formed based on the generated medium-unit job, it is possible to form an image without wasting developer or the medium used in the image-forming operation only partially executed. Since the image-forming operation based on the generated medium-unit job is completed and the image is formed based on a newly-generated medium-unit job after the developing unit which has been moved to the attach/detach position is replaced, control is easy.

In this image forming apparatus, it is preferable that formation of an image is started when the controller accepts an image-formation job that causes generation of at least one medium-unit job; and in a case where an other developing unit with which development can be performed and which contains developer of the same color as the developer contained in the predetermined developing unit is attached to any of the plurality of attach/detach sections when an event occurs in which development cannot be performed by the predetermined developing unit, the timing for moving the predetermined developing unit to the attach/detach position when the image forming apparatus is being used as a monochrome image forming apparatus comes after moving the other developing unit, with which development can be performed, to a developing position and forming images based on all the medium-unit jobs generated by the image-forming job using the moved developing unit.

With this kind of image forming apparatus, it is possible to perform development using the other developing unit even if an event occurs in which development cannot be performed with the predetermined developing unit, in the case in which the image forming apparatus is being used as a monochrome image forming apparatus and the other developing unit with which development can be performed and which contains developer of the same color is attached. For this reason, it is possible to form images based on all the medium-unit jobs in the image-forming job even if an event occurs in which development cannot be performed with the predetermined developing unit after images have been formed based on several medium-unit jobs in the image-forming job.

In this image forming apparatus, it is preferable that in a case where an event occurs in which development cannot be performed with any of the attached developing units when the image forming apparatus is being used as the monochrome image forming apparatus, the developing units in which the event of not being able to perform development has occurred are moved to the attach/detach position after forming images based on the medium-unit jobs already generated.

With such an image forming apparatus, when an event occurs in which development cannot be performed with any of the attached developing units, the developing units in which an event has occurred in which development is not possible are moved to the attach/detach position after forming images based on the medium-unit jobs already generated, so images are formed based on the medium-unit jobs already generated. The image-forming operation is therefore not interrupted halfway through forming images based on medium-unit jobs, so wasteful consumption of developer and the medium can be suppressed. Furthermore, since the developing units in which an event has occurred in which development is not possible are moved to the attach/detach position after forming images based on the medium-unit jobs already generated, the developing operation is not continued using developing units with which development cannot be performed. Accordingly, waste of developer and the medium through continued development can be prevented.

In this image forming apparatus, it is preferable that an event in which development cannot be performed by the predetermined developing unit means that a remaining amount of developer contained in the predetermined developing unit is equal to or below a predetermined amount; the controller acquires, from the image-forming section, remaining amount information indicating the remaining amount of developer contained in the attached developing units and is able to determine, based on the acquired remaining amount information, whether or not the remaining amount of developer contained in the developing units is equal to or below the predetermined amount; and in a case where the controller determines that the remaining amount of developer in any of the attached developing units is equal to or below the predetermined amount when the image forming apparatus is being used as a color image forming apparatus, the controller does not output the request to the image-forming section.

With this kind of image forming apparatus, no request is output when the controller determines that the remaining amount of developer in any of the attached developing units is equal to or below the predetermined amount. In other words, if development cannot be performed because the remaining amount of developer in any of the developing units is equal to or below the predetermined amount, the controller does not output a request. For this reason, if development cannot be performed with one of the developing units, no new medium-unit jobs are generated, and the developing operation using a developing unit with which development cannot be performed is not continued. With color images, there are cases in which, for example, images with different color tones are formed if the remaining amount of developer of any color becomes equal to or below the predetermined amount. Accordingly, when the image forming apparatus is being used as a color image forming apparatus, if the controller determines that the remaining amount of developer in any of the developing units is equal to or below the predetermined amount, no medium-unit jobs are generated thereafter, thereby making it possible to suppress formation of defective images, as with the image forming apparatus described above. Therefore, it is possible to prevent waste of developer and the medium due to continued development with development being impossible with one of the developing units.

In this image forming apparatus, it is preferable that in a case where the remaining amount of developer in the predetermined developing unit is equal to or below the predetermined amount and an other developing unit with which development can be performed and which contains developer of the same color as the developer contained in the predetermined developing unit is attached to any of the plurality of attach/detach sections when the image forming apparatus is being used as a monochrome image forming apparatus, the controller outputs the request to the image-forming section.

When the image forming apparatus is being used as a monochrome image forming apparatus, developer of only one color is used. For this reason, development can be performed with another developing unit if that other developing unit, with which development can be performed and which contains developer of the same color, is attached, even if the remaining amount of developer in the predetermined developing unit becomes equal to or below the predetermined amount and development cannot be performed. Therefore, even if the remaining amount of developer in the predetermined developing unit becomes equal to or below the predetermined amount, it is possible to generate a new medium-unit job and continue the developing process using the other developing unit, by the controller's outputting a request. In other words, throughput can be improved because an image-forming operation is not stopped in the middle of an image-forming job, even if the remaining amount of the developer in the predetermined developing unit becomes equal to or below the predetermined amount.

In this image forming apparatus, it is preferable that each of the developing units is provided with a rotatably-supported developer-bearing roller for bearing the developer; an event in which development cannot be performed by the predetermined developing unit means that a rotation time of the developer-bearing roller provided to the predetermined developing unit is equal to or longer than a predetermined time; the controller acquires rotation information which indicates the rotation time of the developer-bearing rollers of the attached developing units and is able to determine whether or not the rotation time of the developer-bearing rollers of the developing units is equal to or longer than the predetermined time based on the acquired rotation information; and in a case where the controller determines that the rotation time of the developer-bearing rollers of any of the attached developing units is equal to or longer than the predetermined time when the image forming apparatus is being used as a color image forming apparatus, the controller does not output the request to the image-forming section.

With this kind of image forming apparatus, no request is output when the controller determines that the rotation time of a developer-bearing roller of any of the attached developing units is a predetermined time or longer. In other words, if development cannot be performed because the rotation time of the developer-bearing rollers of any of the developing units is equal to or longer than the predetermined time, the controller does not output a request. Therefore, if development cannot be performed with one of the developing units, no new medium-unit jobs are generated, and the developing operation using a developing unit with which development cannot be performed is not continued. As regards color images, images may for example be formed with darkness nonuniformities if the rotation time of the developer-bearing rollers of any of the developing units is the predetermined time or longer. Accordingly, when the image forming apparatus is being used as a color image forming apparatus, if the controller determines that the rotation time of the developer-bearing rollers of any of the developing units is the predetermined time or longer, no medium-unit jobs are generated thereafter, thereby making it possible to suppress formation of defective images, as with the image forming apparatus described above. Therefore, it is possible to prevent waste of developer and the medium due to continued development with development being impossible with one of the developing units.

In this image forming apparatus, it is preferable that in a case where the rotation time of the developer-bearing roller of the predetermined developing unit is equal to or longer than the predetermined time and an other developing unit with which development can be performed and which contains developer of the same color as the developer contained in the predetermined developing unit is attached to any of the plurality of attach/detach sections when the image forming apparatus is being used as a monochrome image forming apparatus, the controller outputs the request to the image-forming section.

When the image forming apparatus is being used as a monochrome image forming apparatus, developer of only one color is used. Therefore, development can be performed with another developing unit if another developing unit, with which development can be performed and which contains developer of the same color, is attached, even if the rotation time of the developer-bearing roller of a predetermined developing unit is the predetermined time or longer and development cannot be performed. Therefore, even if the rotation time of the developer-bearing roller of a predetermined developing unit is the predetermined time or longer, it is possible to generate a new medium-unit job and continue the developing operation using the other developing unit, by the controller's outputting a request. In other words, throughput can be improved because an image-forming operation is not stopped in the middle of an image-forming job, even if the rotation time of the developer-bearing roller of a predetermined developing unit is the predetermined time or longer.

Further, an image forming apparatus for forming images, includes: an image bearing member for bearing a latent image; a plurality of attach/detach sections to and from which developing units can be attached and detached, each developing unit containing a developer and being adapted to develop the latent image using the developer; an image-forming section for forming an image on a medium by developing the latent image; and a controller for causing the image-forming section to form the image; wherein each of the developing units is provided with a rotatably-supported developer-bearing roller for bearing the developer; wherein the controller acquires rotation information which indicates a rotation time of the developer-bearing rollers of the attached developing units and is able to determine whether or not the rotation time of the developer-bearing rollers of the developing units is equal to or longer than a predetermined time based on the acquired rotation information; wherein the controller acquires, from the image-forming section, remaining amount information indicating a remaining amount of developer contained in the attached developing units and is able to determine, based on the acquired remaining amount information, whether or not the remaining amount of developer contained in the developing units is equal to or below a predetermined amount; wherein a medium-unit job in which the image-forming section forms an image on a single medium is generated by the controller suitably outputting, to the image-forming section, a request for requesting formation of an image on a single medium, and the image-forming section outputting, to the controller, an acceptance response indicating that the request has been accepted, if image formation is possible; wherein formation of an image is started when the controller accepts an image-formation job that causes generation of at least one medium-unit job; wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units; wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units; wherein by moving one of the developing units attached to the plurality of attach/detach sections to a predetermined attach/detach position, the moved developing unit is replaceable with another developing unit which has not been attached; wherein in a case where the image forming apparatus is being used as the color image forming apparatus, if the controller determines, as an event in which development cannot be performed by a predetermined developing unit, that the remaining amount of developer in any of the attached developing units is equal to or below the predetermined amount, and determines that the rotation time of the developer-bearing rollers of any of the attached developing units is equal to or longer than the predetermined time, then the controller does not output the request to the image-forming section, and when an event in which development cannot be performed by the predetermined developing unit occurs, the timing for moving the predetermined developing unit to the attach/detach position comes after forming an image according to the medium-unit job which has already been generated when the event has occurred; and wherein in a case where the image forming apparatus is being used as the monochrome image forming apparatus, if an other developing unit with which development can be performed and which contains developer of the same color as the developer contained in the predetermined developing unit is attached to any of the plurality of attach/detach sections when the controller determines, as the event in which development cannot be performed by the predetermined developing unit, that the remaining amount of developer in any of the attached developing units is equal to or below the predetermined amount, and determines that the rotation time of the developer-bearing rollers of any of the attached developing units is equal to or longer than the predetermined time, then the controller outputs the request to the image-forming section, when an event occurs in which development cannot be performed by the predetermined developing unit, the other developing unit, with which development can be performed, is moved to a position of the predetermined developing unit and images are formed according to all the medium-unit jobs generated by the image-forming job using the moved developing unit, and the timing for moving the predetermined developing unit to the attach/detach position is after forming images based on the medium-unit jobs which have already been generated when an event occurs in which development cannot be performed with any of the attached developing units.

With such an image forming apparatus, it is possible to attain all of the effects mentioned above, and thus the object of the present invention is most effectively achieved.

Further, provided is a computer-readable medium for making an image forming apparatus operate, the image forming apparatus including: an image bearing member for bearing a latent image; and a plurality of attach/detach sections to and from which developing units can be attached and detached, each developing unit containing a developer and being adapted to develop the latent image using the developer; wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units; wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units; and wherein by moving one of the developing units attached to the plurality of attach/detach sections to a predetermined attach/detach position, the moved developing unit is replaceable with another developing unit which has not been attached; the computer-readable medium including: a code for moving, in a case where the image forming apparatus is being used as the color image forming apparatus, a predetermined developing unit to the attach/detach position at a predetermined timing when an event occurs in which development cannot be performed by the predetermined developing unit; and a code for moving, in a case where the image forming apparatus is being used as the monochrome image forming apparatus, the predetermined developing unit to the attach/detach position at a timing different from the predetermined timing when an event occurs in which development cannot be performed by the predetermined developing unit. Such a computer-readable medium can also be realized.

Further, an image forming system includes: (a) a computer; and (b) an image forming apparatus for forming images and being connected to the computer, the image forming apparatus including: an image bearing member for bearing a latent image; and a plurality of attach/detach sections to and from which developing units can be attached and detached, each developing unit containing a developer and being adapted to develop the latent image using the developer; wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units; wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units; wherein by moving one of the developing units attached to the plurality of attach/detach sections to a predetermined attach/detach position, the moved developing unit is replaceable with another developing unit which has not been attached; and wherein the timing for moving a predetermined developing unit to the attach/detach position when an event occurs in which development cannot be performed by the predetermined developing unit is different for when the image forming apparatus is being used as the color image forming apparatus and for when the image forming apparatus is being used as the monochrome image forming apparatus. Such an image forming system can also be realized.

Further, an image forming method which uses an image forming apparatus for forming images, includes: (a) in a case where the image forming apparatus is being used as a color image forming apparatus for forming a color image by developing a latent image using developer contained in attached developing units in a state where a plurality of developing units for containing developer of mutually differing colors and developing the latent image borne by an image bearing member using the developer are respectively attached to a plurality of attach/detach sections to and from which the developing units can be attached and detached, a step of moving, at a predetermined timing, one developing unit from among the developing units which are attached to the plurality of attach/detach sections to a predetermined attach/detach position where the developing unit can be replaced with another developing unit which has not been attached, when an event occurs in which development cannot be performed by a predetermined developing unit; and (b) in a case where the image forming apparatus is being used as a monochrome image forming apparatus for forming a monochrome image by developing the latent image borne by the image bearing member using developer contained in the developing units in a state where the developing units containing developer of the same color are attached to at least two attach/detach sections of the plurality of attach/detach sections, a step of moving, at a timing different from that for when the image forming apparatus is being used as the color image forming apparatus, one developing unit from among the developing units which are attached to the plurality of attach/detach sections to the attach/detach position, when an event occurs in which development cannot be performed by the predetermined developing unit. Such an image forming method can also be realized.

Further, an image forming apparatus for forming images, includes: an image bearing member for bearing a latent image; a plurality of attach/detach sections to and from which developing units can be attached and detached, each developing unit containing a developer and being adapted to develop the latent image using the developer; and an announcing section for announcing information indicating an event when an event requiring announcement occurs; wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units; wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units; and wherein a timing for announcing, through the announcing section, information indicating an event when an event occurs in which development cannot be performed by the predetermined developing unit is different for when the image forming apparatus is being used as the color image forming apparatus and for when the image forming apparatus is being used as the monochrome image forming apparatus.

With this kind of image forming apparatus, in the case in which the image forming apparatus is used as a color image forming apparatus, it is possible to announce information indicating that an event has occurred in which development cannot be performed by the predetermined developing unit, at a timing suitable for a color image forming apparatus when an event in which development cannot be performed by a predetermined developing unit has occurred. Furthermore, in the case in which the image forming apparatus is being used as a monochrome image forming apparatus, it is possible to announce information indicating that an event has occurred in which development cannot be performed by the predetermined developing unit, at a timing suitable for a monochrome image forming apparatus when an event in which development cannot be performed by a predetermined developing unit has occurred. For this reason, whether used as a color image forming apparatus or as a monochrome image forming apparatus, an image forming apparatus which is highly convenient for the user can be realized.

In this image forming apparatus, it is preferable that the information indicating the event is information urging that the predetermined developing unit be replaced with another developing unit which has not been attached.

With such an image forming apparatus, not only does a user etc. simply find out about an event in which development cannot be performed by the predetermined developing apparatus, but it is also possible to let the user etc. know the measure for making development possible again. The user etc. is therefore able to respond more quickly and it is possible to use the image forming apparatus again.

In this image forming apparatus, it is preferable that the image forming apparatus further includes an image-forming section for forming an image on a medium by developing the latent image, and a controller for causing the image-forming section to form the image; a medium-unit job in which the image-forming section forms an image on a single medium is generated by the controller suitably outputting, to the image-forming section, a request for requesting formation of an image on a single medium, and the image-forming section outputting, to the controller, an acceptance response indicating that the request has been accepted, if image formation is possible; and the timing for announcing the information indicating the event through the announcing section when the image forming apparatus is being used as the color image forming apparatus comes after forming the image according to the medium-unit job which has already been generated when an event occurs in which development cannot be performed by the predetermined developing unit.

With such an image forming apparatus, when the event occurs in which development cannot be performed with the predetermined developing unit, the event is announced after an image has been formed based on a medium-unit job already generated. Therefore, the user etc. can find out that the event has occurred after the image-forming operation is finished. This means the user etc. cannot accidentally try to remove the developing unit, and the image-forming operation is not interrupted in the middle. In other words, since the image-forming operation is not interrupted with the image only partially formed based on the generated medium-unit job, it is possible to form an image without wasting developer or the medium used in the image-forming operation already been partially executed. Since the image-forming operation based on the generated medium-unit job is completed and the event is announced, the image is formed based on a newly-generated medium-unit job after the developing unit has been replaced based on the announcement, and control is easy.

In this image forming apparatus, it is preferable that formation of an image is started when the controller accepts an image-formation job that causes generation of at least one medium-unit job; and in a case where an other developing unit with which development can be performed and which contains developer of the same color as the developer contained in the predetermined developing unit is attached to any of the plurality of attach/detach sections when an event occurs in which development cannot be performed by the predetermined developing unit, the timing for announcing the information indicating the event through the announcing section when the image forming apparatus is being used as a monochrome image forming apparatus comes after moving the other developing unit, with which development can be performed, to a position of the predetermined developing unit and forming images based on all the medium-unit jobs generated by the image-forming job using the moved developing unit.

With such an image forming apparatus, the event is not announced until images are formed based on all the medium-unit jobs in the image-forming job even if an event occurs in which development cannot be performed with the predetermined developing unit after images have been formed based on several medium-unit jobs in the image-forming job. In other words, there is no need to announce the event in the middle of the image-forming operation since development is possible if another developing unit is used, even if development becomes impossible with the predetermined developing unit. The user etc. cannot therefore accidentally try to remove the developing unit until images are formed based on all the medium-unit jobs in the image-forming job. Furthermore, throughput can be improved because images are formed continuously based on all the medium-unit jobs generated in the image-forming job.

In this image forming apparatus, it is preferable that in a case where an event occurs in which development cannot be performed with any of the attached developing units when the image forming apparatus is being used as the monochrome image forming apparatus, the information indicating the event is announced through the announcing section after forming images based on the medium-unit jobs already generated.

With such an image forming apparatus, when an event occurs in which development cannot be performed with any of the attached developing units, the event is announced after forming images based on the medium-unit jobs already generated. Therefore, images based on the medium-unit jobs already generated are formed. This makes it possible to form more images which the image forming apparatus can form as a monochrome image forming apparatus.

In this image forming apparatus, it is preferable that an event in which development cannot be performed by the predetermined developing unit means that a remaining amount of developer contained in the predetermined developing unit is equal to or below a predetermined amount; the controller acquires, from the image-forming section, remaining amount information indicating the remaining amount of developer contained in the attached developing units and is able to determine, based on the acquired remaining amount information, whether or not the remaining amount of developer contained in the developing units is equal to or below the predetermined amount; and in a case where the controller determines that the remaining amount of developer in any of the attached developing units is equal to or below the predetermined amount when the image forming apparatus is being used as a color image forming apparatus, the controller does not output the request to the image-forming section.

With this kind of image forming apparatus, no request is output when the controller determines that the remaining amount of developer in any of the attached developing units is equal to or below the predetermined amount. In other words, if development cannot be performed because the remaining amount of developer in one of the developing units is equal to or below the predetermined amount, the controller does not output a request. For this reason, if development cannot be performed with one of the developing units, no new medium-unit jobs are generated, and the developing operation using a developing unit with which development cannot be performed is not continued. In other words, it is possible to announce to the user without delay that the remaining amount of developer in any of the developing units has become equal to or below the predetermined amount, by the controller determining that the remaining amount of developer in any of the developing units has become equal to or below the predetermined amount and no other medium-unit jobs being generated thereafter.

In this image forming apparatus, it is preferable that in a case where the remaining amount of developer in the predetermined developing unit is equal to or below the predetermined amount and an other developing unit with which development can be performed and which contains developer of the same color as the developer contained in the predetermined developing unit is attached to any of the plurality of attach/detach sections when the image forming apparatus is being used as a monochrome image forming apparatus, the controller outputs the request to the image-forming section.

When the image forming apparatus is being used as a monochrome image forming apparatus, developer of only one color is used. For this reason, development can be performed with another developing unit if another developing unit, with which development can be performed and which contains developer of the same color, is attached, even if the remaining amount of developer in the predetermined developing unit becomes equal to or below the predetermined amount and development cannot be performed. Therefore, even if the remaining amount of developer in the predetermined developing unit becomes equal to or below the predetermined amount, it is possible to generate a new medium-unit job and continue the developing process using the other developing unit, by the controller's outputting a request. In other words, even if the remaining amount of developer in the predetermined developing unit becomes equal to or below the predetermined amount, the image-forming operation is not stopped in the middle of an image-forming job, so throughput can be improved, and the fact that the remaining amount of developer of a development unit has become equal to or below the predetermined amount can be announced to the user after the image-forming job is finished.

In this image forming apparatus, it is preferable that each of the developing units is provided with a rotatably-supported developer-bearing roller for bearing the developer; an event in which development cannot be performed by the predetermined developing unit means that a rotation time of the developer-bearing roller provided to the predetermined developing unit is equal to or longer than a predetermined time; the controller acquires rotation information which indicates the rotation time of the developer-bearing rollers of the attached developing units and is able to determine whether or not the rotation time of the developer-bearing rollers of the developing units is equal to or longer than the predetermined time based on the acquired rotation information; and in a case where the controller determines that the rotation time of the developer-bearing rollers of any of the attached developing units is equal to or longer than the predetermined time when the image forming apparatus is being used as a color image forming apparatus, the controller does not output the request to the image-forming section.

With this kind of image forming apparatus, no request is output when the controller determines that the rotation time of a developer-bearing roller of any of the attached developing units is a predetermined time or longer. In other words, if development cannot be performed because the rotation time of the developer-bearing roller of any of the developing unit has become equal to or longer than the predetermined time, the controller does not output a request. Therefore, if development cannot be performed with one of the developing units, no new medium-unit jobs are generated, and the developing operation using a developing unit with which development cannot be performed is not continued. In other words, because no medium-unit jobs are generated, the fact that the rotation time of the developer-bearing roller of the predetermined developing unit is the predetermined time or longer can be notified to the user immediately.

In this image forming apparatus, it is preferable that in a case where the rotation time of the developer-bearing roller of the predetermined developing unit is equal to or longer than the predetermined time and an other developing unit with which development can be performed and which contains developer of the same color as the developer contained in the predetermined developing unit is attached to any of the plurality of attach/detach sections when the image forming apparatus is being used as a monochrome image forming apparatus, the controller outputs the request to the image-forming section.

When the image forming apparatus is being used as a monochrome image forming apparatus, developer of only one color is used. For this reason, development can be performed with another developing unit if another developing unit, with which development can be performed and which contains developer of the same color, is attached, even if the rotation time of the developer-bearing roller of a predetermined developing unit is the predetermined time or longer and development cannot be performed. Therefore, even if the rotation time of the developer-bearing roller of a predetermined developing unit is the predetermined time or longer, it is possible to generate a new medium-unit job and continue the developing process using the other developing unit, by the controller's outputting a request. In other words, even if the rotation time of the developer-bearing roller of the predetermined developing unit is the predetermined time or longer, the image-forming operation is not stopped in the middle of an image-forming job, so throughput can be improved and the fact that the rotation time of the developer-bearing roller of a developing unit is the predetermined time or longer can be announced to the user after the image-forming job is finished.

Further, an image forming apparatus for forming images, includes: an image bearing member for bearing a latent image; a plurality of attach/detach sections to and from which developing units can be attached and detached, each developing unit containing a developer and being adapted to develop the latent image using the developer; an image-forming section for forming an image on a medium by developing the latent image; a controller for causing the image-forming section to form the image; and an announcing section for announcing information indicating an event when an event requiring announcement occurs; wherein each of the developing units is provided with a rotatably-supported developer-bearing roller for bearing the developer; wherein the controller acquires, from the image-forming section, remaining amount information indicating a remaining amount of developer contained in the attached developing units and is able to determine, based on the acquired remaining amount information, whether or not the remaining amount of developer contained in the developing units is equal to or below a predetermined amount; wherein the controller acquires rotation information which indicates a rotation time of the developer-bearing rollers of the attached developing units and is able to determine whether or not the rotation time of the developer-bearing rollers of the developing units is equal to or longer than a predetermined time based on the acquired rotation information; wherein a medium-unit job in which the image-forming section forms an image on a single medium is generated by the controller suitably outputting, to the image-forming section, a request for requesting formation of an image on a single medium, and the image-forming section outputting, to the controller, an acceptance response indicating that the request has been accepted, if image formation is possible; wherein formation of an image is started when the controller accepts an image-formation job that causes generation of at least one medium-unit job; wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units; wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units; wherein in a case where the image forming apparatus is being used as the color image forming apparatus, if the controller determines, as an event in which development cannot be performed by a predetermined developing unit, that the remaining amount of developer in any of the attached developing units is equal to or below the predetermined amount, and the image-forming section determines that the rotation time of the developer-bearing rollers of any of the attached developing units is equal to or longer than the predetermined time, then the controller does not output the request to the image-forming section, and when an event in which development cannot be performed by the predetermined developing unit occurs, the information indicating the event is announced through the announcing section after forming an image according to the medium-unit job which has already been generated; and wherein in a case where the image forming apparatus is being used as a monochrome image forming apparatus, if an other developing unit with which development can be performed and which contains developer of the same color as the developer contained in the predetermined developing unit is attached to any of the plurality of attach/detach sections when the event in which development cannot be performed by the predetermined developing unit occurs due to the remaining amount of developer in the predetermined developing unit being equal to or below the predetermined amount, and when the event in which development cannot be performed by the predetermined developing unit occurs due to the rotation time of the developer-bearing roller of the predetermined developing unit being equal to or longer than the predetermined time, then the controller outputs the request to the image-forming section, and when an event occurs in which development cannot be performed by the predetermined developing unit, the information indicating the event is announced through the announcing section after moving the other developing unit, with which development can be performed, to a position of the predetermined developing unit and forming images according to all the medium-unit jobs generated by the image-forming job using the moved developing unit. Such an image forming apparatus can also be realized.

Further, provided is a computer-readable medium for making an image forming apparatus operate, the image forming apparatus including: an image bearing member for bearing a latent image; a plurality of attach/detach sections to and from which developing units can be attached and detached, each developing unit containing a developer and being adapted to develop the latent image using the developer; and an announcing section for announcing information indicating an event when an event requiring announcement occurs; wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units; and wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units; the computer-readable medium including: a code for announcing, when an event occurs in which development cannot be performed by a predetermined developing unit, information indicating the event through the announcing section at a predetermined timing in a case where the image forming apparatus is being used as the color image forming apparatus; and a code for announcing, when an event occurs in which development cannot be performed by the predetermined developing unit, information indicating the event through the announcing section at a timing different from the predetermined timing in a case where the image forming apparatus is being used as the monochrome image forming apparatus. Such a computer-readable medium can also be realized.

Further, an image forming system includes: (a) a computer body; and (b) an image forming apparatus for forming images and being connected to the computer, the image forming apparatus including: an image bearing member for bearing a latent image; a plurality of attach/detach sections to and from which developing units can be attached and detached, each developing unit containing a developer and being adapted to develop the latent image using the developer; and an announcing section for announcing information indicating an event when an event requiring announcement occurs; wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units; wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units; and wherein a timing for announcing, through the announcing section, information indicating an event when an event occurs in which development, cannot be performed by the predetermined developing unit is different for when the image forming apparatus is being used as the color image forming apparatus and for when the image forming apparatus is being used as the monochrome image forming apparatus. Such an image forming system can also be realized.

Further, an image forming method which uses an image forming apparatus for forming images, includes: (a) in a case where the image forming apparatus is being used as a color image forming apparatus for forming a color image by developing a latent image using developer contained in attached developing units in a state where a plurality of developing units for containing developer of mutually differing colors and developing the latent image borne by an image bearing member using the developer are respectively attached to a plurality of attach/detach sections to and from which the developing units can be attached and detached, a step of announcing, at a predetermined timing, information indicating an event through the announcing section, when an event occurs in which development cannot be performed by a predetermined developing unit; and (b) in a case where the image forming apparatus is being used as a monochrome image forming apparatus for forming a monochrome image by developing the latent image borne by the image bearing member using developer contained in the developing units in a state where the developing units containing developer of the same color are attached to at least two attach/detach sections of the plurality of attach/detach sections, a step of announcing, at a timing different from that for when the image forming apparatus is being used as the color image forming apparatus, information indicating an event through the announcing section, when an event occurs in which development cannot be performed by the predetermined developing unit. Such an image forming method can also be realized.

Further, an image forming apparatus for forming images, includes: an image bearing member for bearing a latent image; and a plurality of attach/detach sections to and from which developing units can be attached and detached, each developing unit containing a developer and being adapted to develop the latent image using the developer; wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units; wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units; wherein by moving one of the developing units attached to the plurality of attach/detach sections to a predetermined attach/detach position, the moved developing unit is replaceable with another developing unit which has not been attached; and wherein an operation for moving a predetermined developing unit to the attach/detach position when an event occurs in which development cannot be performed by the predetermined developing unit is different for when the image forming apparatus is being used as the color image forming apparatus and for when the image forming apparatus is being used as the monochrome image forming apparatus.

With this kind of image forming apparatus, it is possible to move a predetermined developing unit to an attach/detach position by executing an operation suitable for a color image forming apparatus when an event occurs in which development cannot be performed by the predetermined developing unit, in the case in which the image forming apparatus is used as a color image forming apparatus. When used as a monochrome image forming apparatus, it is possible to move the predetermined developing unit to the attach/detach position by executing an operation suitable for a monochrome image forming apparatus, when an event occurs in which development cannot be performed by the predetermined developing unit. For this reason, whether used as a color image forming apparatus or as a monochrome image forming apparatus, an image forming apparatus which is highly convenient for the user can be realized. Furthermore, since the developing unit with which development cannot be performed is moved to the attach/detach position, a user can replace the developing unit easily, without the hassle of checking and moving the unit with which development cannot be performed.

In this image forming apparatus, it is preferable that the image forming apparatus further includes an image-forming section for forming an image on a medium by developing the latent image, and a controller for causing the image-forming section to form the image; a medium-unit job in which the image-forming section forms an image on a single medium is generated by the controller suitably outputting, to the image-forming section, a request for requesting formation of an image on a single medium, and the image-forming section outputting, to the controller, an acceptance response indicating that the request has been accepted, if image formation is possible; and wherein, when the image forming apparatus is being used as the color image forming apparatus, the predetermined developing unit is moved to the attach/detach position after forming the image according to the medium-unit job which has already been generated when an event occurs in which development cannot be performed by the predetermined developing unit.

With this kind of image forming apparatus, the operation of forming an image is not interrupted in the middle, since the predetermined developing unit is moved to the attach/detach position after the image has been formed based on the medium-unit job already generated when the event occurs in which development cannot be performed with the predetermined developing unit. In other words, since the image-forming operation is not interrupted with the image only partially formed based on the generated medium-unit job, it is possible to form an image without wasting developer or the medium used in the image-forming operation only partially executed. Since the image-forming operation based on the generated medium-unit job is completed, and the image is formed based on a newly-generated medium-unit job after the developing unit which has been moved to the attach/detach position is replaced, control is easy.

In this image forming apparatus, it is preferable that formation of an image is started when the controller accepts an image-formation job that causes generation of at least one medium-unit job; and in a case where the image forming apparatus is being used as a monochrome image forming apparatus and an other developing unit with which development can be performed and which contains developer of the same color as the developer contained in the predetermined developing unit is attached to any of the plurality of attach/detach sections when an event occurs in which development cannot be performed by the predetermined developing unit, the predetermined developing unit is moved to the attach/detach position after moving the other developing unit, with which development can be performed, to a developing position and forming images based on all the medium-unit jobs generated by the image-forming job using the moved developing unit.

With such an image forming apparatus, it is possible to form images based on all the medium-unit jobs in the image-forming job even if an event occurs in which development cannot be performed with the predetermined developing unit after images have been formed based on several medium-unit jobs in the image-forming job.

In this image forming apparatus, it is preferable that in a case where an event occurs in which development cannot be performed with any of the attached developing units when the image forming apparatus is being used as the monochrome image forming apparatus, the developing units in which the event of not being able to perform development has occurred are moved to the attach/detach position after forming images based on the medium-unit jobs already generated.

With such an image forming apparatus, when an event occurs in which development cannot be performed with any of the attached developing units, the developing units in which an event of not being able to perform development has occurred are moved to the attach/detach position after forming images based on the medium-unit jobs already generated, so images are formed based on the medium-unit jobs already generated. The image-forming operation is therefore not interrupted halfway through forming images based on medium-unit jobs, so wasteful consumption of developer and the medium can be suppressed. Furthermore, since the developing units in which an event of not being able to perform development has occurred are moved to the attach/detach position after forming images based on the medium-unit jobs already generated, the developing operation is not continued using developing units with which development cannot be performed. Accordingly, waste of developer and the medium through continued development can be prevented.

In this image forming apparatus, it is preferable that an event in which development cannot be performed by the predetermined developing unit means that a remaining amount of developer contained in the predetermined developing unit is equal to or below a predetermined amount; the controller acquires, from the image-forming section, remaining amount information indicating the remaining amount of developer contained in the attached developing units and is able to determine, based on the acquired remaining amount information, whether or not the remaining amount of developer contained in the developing units is equal to or below the predetermined amount; and in a case where the controller determines that the remaining amount of developer in any of the attached developing units is equal to or below the predetermined amount when the image forming apparatus is being used as a color image forming apparatus, the controller does not output the request to the image-forming section.

With this kind of image forming apparatus, no request is output when the controller determines that the remaining amount of developer in one of the attached developing units is equal to or below the predetermined amount. In other words, if development cannot be performed because the remaining amount of developer in any of the developing units is equal to or below the predetermined amount, the controller does not output a request. For this reason, if development cannot be performed with one of the developing units, no new medium-unit jobs are generated, and the developing operation using a developing unit with which development cannot be performed is not continued. With color images, there are cases in which, for example, images with different color tones are formed if the remaining amount of developer of any color becomes equal to or below the predetermined amount. Accordingly, when the apparatus is being used as a color image forming apparatus, if the controller determines that the remaining amount of developer in any of the developing units is equal to or below the predetermined amount, no medium-unit jobs are generated thereafter, thereby making it possible to suppress formation of defective images, as with the image forming apparatus described above. Therefore, it is possible to prevent waste of developer and the medium due to continued development with development being impossible with one of the developing units.

In this image forming apparatus, it is preferable that in a case where the remaining amount of developer in the predetermined developing unit is equal to or below the predetermined amount and an other developing unit with which development can be performed and which contains developer of the same color as the developer contained in the predetermined developing unit is attached to any of the plurality of attach/detach sections when the image forming apparatus is being used as a monochrome image forming apparatus, the controller outputs the request to the image-forming section.

When the image forming apparatus is being used as a monochrome image forming apparatus, developer of only one color is used. For this reason, development can be performed with another developing unit if another developing unit, with which development can be performed and which contains developer of the same color, is attached, even if the remaining amount of developer in the predetermined developing unit becomes equal to or below the predetermined amount and development cannot be performed. Therefore, even if the remaining amount of developer in the predetermined developing unit becomes equal to or below the predetermined amount, it is possible to generate a new medium-unit job and continue the developing operation using the other developing unit, by the controller's outputting a request. That is, throughput can be improved because an image-forming operation is not stopped in the middle of an image-forming job, even if the remaining amount of the developer in the predetermined developing unit becomes equal to or below the predetermined amount.

In this image forming apparatus, it is preferable that each of the developing units is provided with a rotatably-supported developer-bearing roller for bearing the developer; an event in which development cannot be performed by the predetermined developing unit means that a rotation time of the developer-bearing roller provided to the predetermined developing unit is equal to or longer than a predetermined time; the controller acquires rotation information which indicates the rotation time of the developer-bearing rollers of the attached developing units and is able to determine whether or not the rotation time of the developer-bearing rollers of the developing units is equal to or longer than the predetermined time based on the acquired rotation information; and in a case where the controller determines that the rotation time of the developer-bearing rollers of any of the attached developing units is equal to or longer than the predetermined time when the image forming apparatus is being used as a color image forming apparatus, the controller does not output the request to the image-forming section.

With this kind of image forming apparatus, no request is output when the controller determines that the rotation time of a developer-bearing roller of any of the attached developing units is equal to or longer than a predetermined time. In other words, if development cannot be performed because the rotation time of the developer-bearing roller of one of the developing units is the predetermined time or longer, the controller does not output a request. For this reason, if development cannot be performed with any of the developing units, no new medium-unit jobs are generated, and the developing operation using a developing unit with which development cannot be performed is not continued. As regards color images, images may for example be formed with darkness nonuniformities if the rotation time of the developer-bearing roller of one of the developing units is the predetermined time or longer. Accordingly, when the image forming apparatus is being used as a color image forming apparatus, if the controller determines that the rotation time of the developer-bearing rollers of any of the developing units is the predetermined time or longer, no medium-unit jobs are generated thereafter, thereby making it possible to suppress formation of defective images, as with the image forming apparatus described above. Therefore, it is possible to prevent waste of developer and the medium due to continued development with development being impossible with one of the developing units.

In this image forming apparatus, it is preferable that in a case where the rotation time of the developer-bearing roller of the predetermined developing unit is equal to or longer than the predetermined time and an other developing unit with which development can be performed and which contains developer of the same color as the developer contained in the predetermined developing unit is attached to any of the plurality of attach/detach sections when the image forming apparatus is being used as a monochrome image forming apparatus, the controller outputs the request to the image-forming section.

When the image forming apparatus is being used as a monochrome image forming apparatus, developer of only one color is used. For this reason, development can be performed with another developing unit if another developing unit, with which development can be performed and which contains developer of the same color, is attached, even if the rotation time of the developer-bearing roller of a predetermined developing unit is the predetermined time or longer and development cannot be performed. Therefore, even if the rotation time of the developer-bearing roller of a predetermined developing unit is the predetermined time or longer, it is possible to generate a new medium-unit job and continue the developing process using the other developing unit, by the controller's outputting a request. In other words, throughput can be improved because an image-forming operation is not stopped in the middle of an image-forming job, even if the rotation time of the developer-bearing roller of a predetermined developing unit is the predetermined time or longer.

Further, an image forming apparatus for forming images, includes: an image bearing member for bearing a latent image; a plurality of attach/detach sections to and from which developing units can be attached and detached, each developing unit containing a developer and being adapted to develop the latent image using the developer; an image-forming section for forming an image on a medium by developing the latent image; and a controller for causing the image-forming section to form the image; wherein each of the developing units is provided with a rotatably-supported developer-bearing roller for bearing the developer; wherein the controller acquires, from the image-forming section, remaining amount information indicating a remaining amount of developer contained in the attached developing units and is able to determine, based on the acquired remaining amount information, whether or not the remaining amount of developer contained in the developing units is equal to or below a predetermined amount; wherein the controller acquires rotation information which indicates a rotation time of the developer-bearing rollers of the attached developing units and is able to determine whether or not the rotation time of the developer-bearing rollers of the developing units is equal to or longer than a predetermined time based on the acquired rotation information; wherein a medium-unit job in which the image-forming section forms an image on a single medium is generated by the controller suitably outputting, to the image-forming section, a request for requesting formation of an image on a single medium, and the image-forming section outputting, to the controller, an acceptance response indicating that the request has been accepted, if image formation is possible; wherein formation of an image is started when the controller accepts an image-formation job that causes generation of at least one medium-unit job; wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units; wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units; wherein by moving one of the developing units attached to the plurality of attach/detach sections to a predetermined attach/detach position, the moved developing unit is replaceable with another developing unit which has not been attached; wherein in a case where the image forming apparatus is being used as the color image forming apparatus, if the controller determines, as an event in which development cannot be performed by a predetermined developing unit, that the remaining amount of developer in any of the attached developing units is equal to or below the predetermined amount, and determines that the rotation time of the developer-bearing rollers of any of the attached developing units is equal to or longer than the predetermined time, then the controller does not output the request to the image-forming section, and when an event in which development cannot be performed by the predetermined developing unit occurs, the predetermined developing unit is moved to the attach/detach position after forming an image according to the medium-unit job which has already been generated; and wherein in a case where the image forming apparatus is being used as a monochrome image forming apparatus, if an other developing unit with which development can be performed and which contains developer of the same color as the developer contained in the predetermined developing unit is attached to any of the plurality of attach/detach sections when the event in which development cannot be performed by the predetermined developing unit occurs due to the remaining amount of developer in the predetermined developing unit being equal to or below the predetermined amount, and when the event in which development cannot be performed by the predetermined developing unit occurs due to the rotation time of the developer-bearing roller of the predetermined developing unit being equal to or longer than the predetermined time, then the controller outputs the request to the image-forming section, and when an event occurs in which development cannot be performed by the predetermined developing unit, the predetermined developing unit is moved to the attach/detach position after moving the other developing unit, with which development can be performed, to a position of the predetermined developing unit and forming images according to all the medium-unit jobs generated by the image-forming job using the moved developing unit. Such an image forming apparatus can be realized.

Further, provided is a computer-readable medium for making an image forming apparatus operate, the image forming apparatus including: an image bearing member for bearing a latent image; and a plurality of attach/detach sections to and from which developing units can be attached and detached, each developing unit containing a developer and being adapted to develop the latent image using the developer; wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units; wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units; and wherein by moving one of the developing units attached to the plurality of attach/detach sections to a predetermined attach/detach position, the moved developing unit is replaceable with another developing unit which has not been attached; the computer-readable medium including: a code for executing, in a case where the image forming apparatus is being used as the color image forming apparatus, an operation of moving a predetermined developing unit to the attach/detach position when an event occurs in which development cannot be performed by the predetermined developing unit; and a code for moving, in a case where the image forming apparatus is being used as the monochrome image forming apparatus, the predetermined developing unit to the attach/detach position according to an operation different from the above-mentioned operation of moving the predetermined developing unit to the attach/detach position when an event occurs in which development cannot be performed by the predetermined developing unit. Such a computer-readable medium can also be realized.

Further, an image forming system includes: (a) a computer; and (b) an image forming apparatus for forming images and being connected to the computer, the image forming apparatus including: an image bearing member for bearing a latent image; and a plurality of attach/detach sections to and from which developing units can be attached and detached, each developing unit containing a developer and being adapted to develop the latent image using the developer; wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units; wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units; wherein by moving one of the developing units attached to the plurality of attach/detach sections to a predetermined attach/detach position, the moved developing unit is replaceable with another developing unit which has not been attached; and wherein an operation for moving a predetermined developing unit to the attach/detach position when an event occurs in which development cannot be performed by the predetermined developing unit is different for when the image forming apparatus is being used as the color image forming apparatus and for when the image forming apparatus is being used as the monochrome image forming apparatus. Such an image forming system can also be realized.

Further, an image forming system includes: (a) a computer; and (b) an image forming apparatus for forming images and being connected to the computer, the image forming apparatus including: an image bearing member for bearing a latent image; and a plurality of attach/detach sections to and from which developing units can be attached and detached, each developing unit containing a developer and being adapted to develop the latent image using the developer; wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units; wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units; wherein by moving one of the developing units attached to the plurality of attach/detach sections to a predetermined attach/detach position, the moved developing unit is replaceable with another developing unit which has not been attached; and wherein an operation for moving a predetermined developing unit to the attach/detach position when an event occurs in which development cannot be performed by the predetermined developing unit is different for when the image forming apparatus is being used as the color image forming apparatus and for when the image forming apparatus is being used as the monochrome image forming apparatus. Such an image forming system can also be realized.

Further, an image forming apparatus for forming images, includes: an image bearing member for bearing a latent image; and a plurality of attach/detach sections to and from which developing units can be attached and detached, each developing unit containing a developer and being adapted to develop the latent image using the developer; wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units; wherein a predetermined operation is executed based on information indicating a state of the developing unit; and wherein the predetermined operation is executed when an event in which all of the attached developing units have entered a predetermined state is detected based on the information, when the image forming apparatus is being used as the monochrome image forming apparatus.

When such an image forming apparatus is being used as a monochrome image forming apparatus, a plurality of developing units which contain developer of the same color are attached. A predetermined operation is executed when an event is detected in which all of the attached developing units enter a predetermined state. In other words, the predetermined operation is not executed even if an event is detected in which one of the attached developing units enters a predetermined state. For this reason, even if one of the developing units enters the predetermined state in the middle of printing, the predetermined operation is not performed, thereby suppressing a drop in throughput.

In this image forming apparatus, it is preferable that the image forming apparatus further includes an image-forming section for forming an image on a medium by developing the latent image, and a controller for causing the image-forming section to form the image; a medium-unit job in which the image-forming section forms an image on a single medium is generated by the controller suitably outputting, to the image-forming section, a request for requesting formation of an image on a single medium, and the image-forming section outputting, to the controller, an acceptance response indicating that the request has been accepted, if image formation is possible; and the predetermined operation is executed after forming the image according to the medium-unit job which has already been generated at the time of detection of the event of entering the predetermined state.

With such an image forming apparatus, the predetermined operation is executed after an image is formed based on a medium-unit job already generated when an event of entering the predetermined state is detected, so an image-forming operation is not interrupted in the middle of a medium-unit job. In other words, since the image-forming operation is not interrupted with the image only partially formed based on the generated medium-unit job, it is possible to form an image without wasting developer or the medium used in the image-forming operation only partially executed. Since the image-forming operation based on the generated medium-unit job is completed, and the image is formed based on a newly-generated medium-unit job after the predetermined event is resolved, control is easy.

In this image forming apparatus, it is preferable that the predetermined state is a state of not being able to perform development with the developing unit.

With this kind of image forming apparatus, the predetermined operation is not executed even if an event occurs in which development cannot be performed by one of the developing units. In other words, the predetermined operation is executed when a state is entered in which development cannot be performed by all of the other attached developing units. Therefore, even if a state is entered in which development cannot be performed by one of the developing units, images are formed using other developing units, thereby making it possible to improve throughput, since a print job, which is a plurality of medium-unit jobs, is difficult to interrupt. Since development can be continued until a state is entered in which development cannot be performed by any of the developing units, the possibility of interruption is low even in the case in which printing is performed on a large volume of media at a single time, making this kind of image forming apparatus particularly effective in the case in which printing is performed on a large volume of media at a single time.

In this image forming apparatus, it is preferable that the state of not being able to perform development is when a remaining amount of developer contained in the developing unit is equal to or below a predetermined amount.

With such an image forming apparatus, it is possible to continuously print to a large volume of media while suppressing problems which occur when the remaining amount of developer in the developing units becomes equal to or below the predetermined amount, such as the formation of scratchy images or images with differing color tones, for example.

In this image forming apparatus, it is preferable that each of the developing units is provided with a rotatably-supported developer-bearing roller for bearing the developer; and the state of not being able to perform development is when a rotation time of the developer-bearing roller is equal to or longer than a predetermined time.

With such an image forming apparatus, it is possible to continuously print to a large volume of media while suppressing problems which occur when the rotation time of the developer-bearing rollers is a predetermined time or longer, such as the occurrence of darkness nonuniformities in an image, for example.

In this image forming apparatus, it is preferable that the image forming apparatus further includes an announcing section for announcing information for indicating an event when an event requiring announcement occurs; and the predetermined operation is an operation of announcing, with the announcing section, an event in which a state of not being able to perform development with the developing unit has been entered.

With such an image forming apparatus, an event in which development cannot be performed is announced to the announcing section when a state is entered in which development cannot be performed with any of the developing units, so the event is not announced if development cannot be performed by only some of the developing units. In other words, a user etc. cannot find out about an event in which development cannot be performed by one of the developing units until development cannot be performed by all of the developing units. For this reason, the user can use the image forming apparatus in the same way as in the case in which development is being performed with one development unit, until development cannot be performed with all the developing units.

In this image forming apparatus, it is preferable that by moving, to a predetermined attach/detach position, one developing unit from among the developing units attached to the plurality of attach/detach sections, the moved developing unit can be replaced with an other developing unit which has not been attached; and the predetermined operation is an operation of moving, to the attach/detach position, a developing unit which has entered a state of not being able to perform development.

With such an image forming apparatus, even when one developing unit from among the attached developing units enters a state in which development cannot be performed, the developing unit is not moved to the attach/detach position, but movement to the attach/detach position is performed when development cannot be performed with all the developing units. Throughput can therefore be improved because print jobs are difficult to interrupt, since an operation is not executed for moving to an attach/detach position every time development cannot be performed by one developing unit.

In this image forming apparatus, it is preferable that each of the developing units can perform development after being moved to a predetermined developing position; and in a case where a state of not being able to perform development with one of the attached developing units is entered when the image forming apparatus is being used as the monochrome image forming apparatus, an other developing unit with which development can be performed is moved to the developing position.

With such an image forming apparatus, development can be continued using the other developing unit, even if one of the attached developing units cannot be used to perform development.

In this image forming apparatus, it is preferable that in a case where a plurality of the other developing units with which development can be performed are attached, the developing unit with the shortest moving distance to the developing position is moved to the developing position.

With such an image forming apparatus, the other developing unit with the shortest moving distance to the developing position is moved to the developing position when one of the developing units cannot perform development. That is, a developing unit able to perform development can be moved to the developing position with the shortest time when one of the developing units can no longer develop. A drop in throughput can therefore be suppressed because the time to move the developing unit is short.

In this image forming apparatus, it is preferable that the predetermined state is a state in which a state of not being able to perform development with the developing unit should be forewarned.

With such an image forming apparatus, a predetermined operation is executed when a state is entered in which a state of not being able to perform development should be forewarned. Therefore, a user etc. can find out that development will become impossible before the state of not being able to perform development is actually entered.

In this image forming apparatus, it is preferable that the image forming apparatus further includes an announcing section for announcing information for indicating an event when an event requiring announcement occurs; the predetermined operation is an operation of announcing with the announcing section an event in which the state, in which the state of not being able to perform development with the developing unit should be forewarned, has been entered.

With such an image forming apparatus, it is possible to announce using the announcing section to a user an event, when a state in which a state of not being able to perform development should be forewarned is entered. The user etc. can therefore find out in beforehand the fact that development will no longer be possible. Accordingly, the user etc. can make preparations to make development possible again before development can no longer be performed, thereby making it possible to provide a highly convenient image forming apparatus.

In this image forming apparatus, it is preferable that the state of not being able to perform development is when a remaining amount of developer contained in the developing unit is equal to or below a predetermined amount.

With such an image forming apparatus, the user etc. can find out about the event before development can no longer be performed due to the remaining amount of the developer becoming equal to or below the predetermined amount. For this reason, the user etc. can prepare a new developing unit while development is being performed provided with sufficient developer. The developing operation can therefore be continued by changing the prepared developing unit immediately when the remaining amount of developer contained in a developing unit becomes equal to or below the predetermined amount.

Further, an image forming apparatus for forming images, includes: an image bearing member for bearing a latent image; a plurality of attach/detach sections to and from which developing units can be attached and detached, each developing unit containing a developer and being adapted to develop the latent image using the developer; an image-forming section for forming an image on a medium by developing the latent image; a controller for causing the image-forming section to form the image; and an announcing section for announcing information for indicating an event when an event requiring announcement occurs; wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units; wherein each of the developing units can perform development after being moved to a predetermined developing position; wherein by moving, to a predetermined attach/detach position, one developing unit from among the developing units attached to the plurality of attach/detach sections, the moved developing unit can be replaced with an other developing unit which has not been attached; wherein a medium-unit job in which the image-forming section forms an image on a single medium is generated by the controller suitably outputting, to the image-forming section, a request for requesting formation of an image on a single medium, and the image-forming section outputting, to the controller, an acceptance response indicating that the request has been accepted, if image formation is possible; wherein a predetermined operation is executed based on information indicating a state of the developing unit; and wherein, in a case where the image forming apparatus is being used as the monochrome image forming apparatus: when an event, in which a state is entered where a state that a remaining amount of developer contained in the developing units is equal to or below a predetermined amount should be forewarned, is detected, the event is announced with the announcing section, when an event, in which the remaining amount of developer contained in any of the attached developing units has become equal to or below the predetermined amount, is detected, the developing unit with the shortest moving distance to the developing position, among other attached developing units with which development can be performed, is moved to the developing position, and when an event in which the remaining amount of developer contained in all of the attached developing units has become equal to or below the predetermined amount is detected, the developing units in which the remaining amount of developer has become equal to or below the predetermined amount are moved to the attach/detach section after forming an image according to the medium-unit job which has already been generated, based on the above-mentioned information. Such an image forming apparatus can be realized.

Further, provided is a computer-readable medium for making an image forming apparatus operate, the image forming apparatus including: an image bearing member for bearing a latent image; and a plurality of attach/detach sections to and from which developing units can be attached and detached, each developing unit containing a developer and being adapted to develop the latent image using the developer; wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units; the computer-readable medium including: a code for executing, in a case where the image forming apparatus which executes a predetermined operation based on information indicating a state of the developing unit is being used as the monochrome image forming apparatus, the predetermined operation when an event in which all of the attached developing units have entered a predetermined state is detected based on the information. Such a computer-readable medium can also be realized.

Further, an image forming system includes: (a) a computer; and (b) an image forming apparatus for forming images and being connected to the computer, the image forming apparatus including: an image bearing member for bearing a latent image; and a plurality of attach/detach sections to and from which developing units can be attached and detached, each developing unit containing a developer and being adapted to develop the latent image using the developer; wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units; and wherein the image forming apparatus executes a predetermined operation based on information indicating a state of the developing unit; wherein the predetermined operation is executed when an event in which all of the attached developing units have entered a predetermined state is detected based on the information, when the image forming apparatus is being used as the monochrome image forming apparatus. Such an image forming system can also be realized.

Further, an image forming method which uses an image forming apparatus for forming images, includes: (a) in a case where the image forming apparatus is being used as a monochrome image forming apparatus for forming a monochrome image by developing a latent image borne by an image bearing member using developer contained in developing units, in a state in which the developing units which contain developer of the same color for developing the latent image borne by the image bearing member are attached to at least two attach/detach sections of a plurality of attach/detach sections to and from which the developing units for developing the latent image can be attached and detached, a step of detecting, based on information indicating a state of the developing unit, an event in which all the attached developing units have entered a predetermined state; and (b) a step of executing a predetermined operation when the event is detected. Such an image forming method can also be realized.

### FIRST EMBODIMENT

### ===Overall Configuration Example of Image Forming Apparatus===

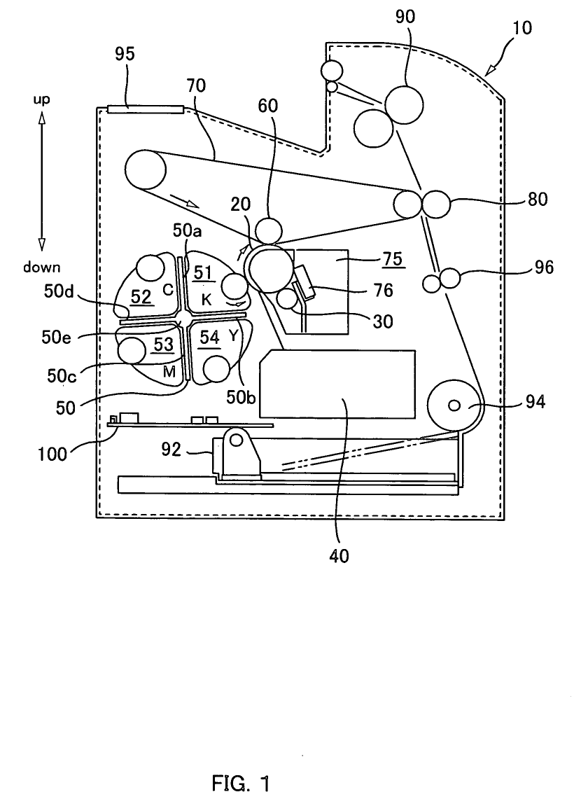

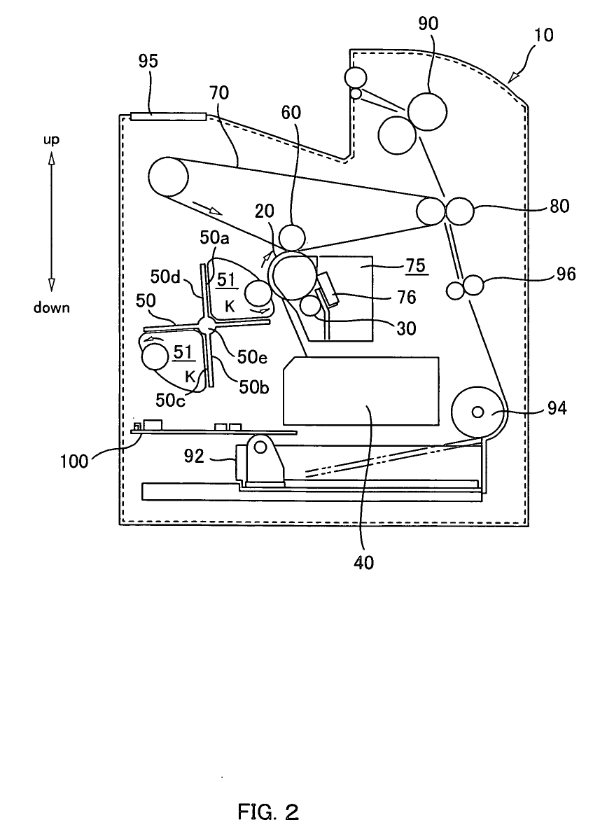

Next, using FIG. 1 and FIG. 2, an overview of a printer 10 as an example of the image forming apparatus according to a first embodiment is described. FIG. 1 and FIG. 2 are views showing major component elements making up the printer 10, FIG. 1 being a view showing the major component elements when the printer 10 is used as a color printer, and FIG. 2 being a view showing the major component elements when the printer 10 is used as a monochrome printer. A more detailed description is given later of the use of the printer 10 as a color printer and as a monochrome printer. Also, the up and down directions are shown by an arrow in FIG. 1 and FIG. 2, a paper supply tray 92 being disposed at a lower portion of the printer 10 and a fixing unit 90 being disposed at an upper portion of the printer 10, for example.

As shown in FIG. 1 and FIG. 2, the printer 10 is provided with a charging unit 30, an exposing unit 40, a developing device retaining unit 50, a first transferring unit 60, an intermediate transferring member 70, and a cleaning unit 75 along a rotation direction of a photoconductor 20 as an image bearing member for bearing images, and is further provided with a second transferring unit 80, a fixing unit 90, a display unit 95 made up of a liquid crystal panel and serving as a displaying section or as an announcing section to a user etc., and a control unit 100 for controlling the whole printer 10.

The photoconductor 20 is provided with a cylindrical conductive substrate and a photoreceptive layer formed on the outer circumference surface of this substrate, and can rotate about a central axis, and in the present embodiment, rotates in the clockwise direction as shown by arrows in FIG. 1 and FIG. 2.

The charging unit 30 is a device for charging the photoconductor 20, and the exposing unit 40 is a device for forming a latent image on the charged photoconductor 20 by irradiating a laser. The exposing unit 40 is provided with, for example, a semiconductor laser, a polygon mirror, and an F-θ lens, and irradiates a modulated laser onto the charged photoconductor 20 based on image information input from an external computer (not shown).

The developing device retaining unit 50 is provided with a plurality of attach/detach sections 50a, 50b, 50c, and 50d to and from which the developing devices, which serves as developing units for containing developer and developing latent images formed on the photoconductor 20, can be attached and detached. The latent images formed on the photoconductor 20 are developed using a toner T as an example of a developer contained in the developing devices attached to these attach/detach sections.

Incidentally, the printer 10 according to the present embodiment can be used as a color printer (color image forming apparatus) for forming color images by developing the latent images borne on the photoconductor 20 using the toner T contained in the developing devices, in a state where the developing devices are attached to the plurality of attach/detach sections 50a, 50b, 50c, and 50d. Furthermore, the printer 10 can be used as a monochrome printer (monochrome image forming apparatus) for forming monochrome images by developing the latent images borne by the photoconductor 20 using the developer contained in the developing devices, in a state where developing devices containing developer of the same color are attached to at least two of the plurality of attach/detach sections 50a, 50b, 50c, and 50d.

In the case in which the printer 10 is used as a color printer, as shown in FIG. 1, four developing devices—black developing device 51, magenta developing device 53, cyan developing device 52, and yellow developing device 54—are attached to the four attach/detach sections 50a, 50b, 50c, and 50d of the developing device retaining unit 50. The latent images formed on the photoconductor 20 are developed by the toner T contained in the developing devices 51, 52, 53, and 54.

By rotating, the developing device retaining unit 50 can move the four developing devices 51, 52, 53, and 54. In other words, the developing device retaining unit 50 is rotatably disposed around a rotating shaft 50e, and the four attach/detach sections are disposed in a manner surrounding the rotating shaft 50e. When the developing device retaining unit 50 rotates around the rotating shaft 50e with the four developing devices 51, 52, 53, and 54 attached to the attach/detach sections, the four attached developing devices 51, 52, 53, and 54 are moved, maintaining their relative positions to each other. The developing devices 51, 52, 53, and 54 are moved to a position opposite the photoconductor 20 when developing the latent images formed on the photoconductor 20 using the toner T contained in the developing devices 51, 52, 53, and 54. When one page's worth of latent images has been developed using a certain developing device, the developing device retaining unit 50 rotates 90°, sequentially moving the adjacent developing device to the position opposite the photoconductor 20.

On the other hand, as shown in FIG. 2, in the case in which the printer 10 is being used as a monochrome printer, developing devices containing developer of the same color are attached to at least two of the plurality of attach/detach sections on the developing device retaining unit 50. The latent images formed on the photoconductor 20 are developed using the toner T contained in the attached developing devices which contain developer of the same color. According to the present embodiment, the black developing devices 51 are attached to the two attach/detach sections 50a and 50c of the four attach/detach sections 50a, 50b, 50c, and 50d. By rotating the developing device retaining unit 50, one or the other of the two attached black developing devices 51 is moved to the position opposite the photoconductor 20. The latent images formed on the photoconductor 20 are developed by the black toner T contained in the developing device moved to the position opposite the photoconductor 20, by suitably moving the position of the two attached black developing devices 51. The developing devices are described in greater detail below.

The first transferring unit 60 is a device for transferring a toner image formed on the photoconductor 20 to the intermediate transferring member 70.

The intermediate transferring member 70 is an endless belt formed of layers of semiconductive coating material on a surface layer of an aluminum evaporation layer on the surface of a polyethylene terephthalate (PET) film, and is rotationally driven at approximately the same circumferential speed as the photoconductor 20.

The second transferring unit 80 is a device for transferring a toner image formed on the intermediate transferring member 70 to a medium such as paper, film, or cloth.

The fixing unit 90 is a device for fusing to the medium the toner image transferred onto the medium, and making the fused image permanent.

The cleaning unit 75 is disposed between the first transferring unit 60 and the charging unit 30, and is provided with a cleaning blade 76 made of rubber and abutting the surface of the photoconductor 20. The cleaning unit 75 uses the cleaning blade 76 to wipe away and thereby remove any toner T remaining on the photoreceptor 20, after the toner image has been transferred to the intermediate transferring member 70 by the first transferring unit 60.

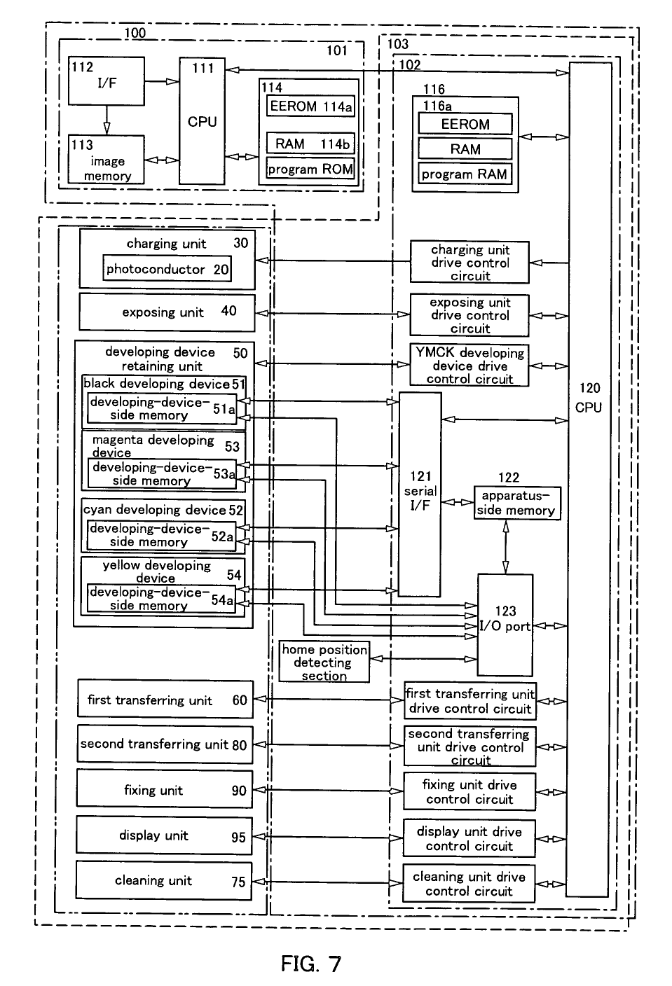

The control unit 100 is provided with a controller section 101 and a unit controller 102 (FIG. 7). The controller section 101 communicates with the external computer, and the unit controller 102 forms images by controlling the various units. The controller section 101 and the unit controller 102 are connected via an interface. The controller section 101 is equivalent to a “controller,” the various units and the unit controller 102, described above, are equivalent to an “image-forming section.”

### ===Configuration Example of Developing Device===

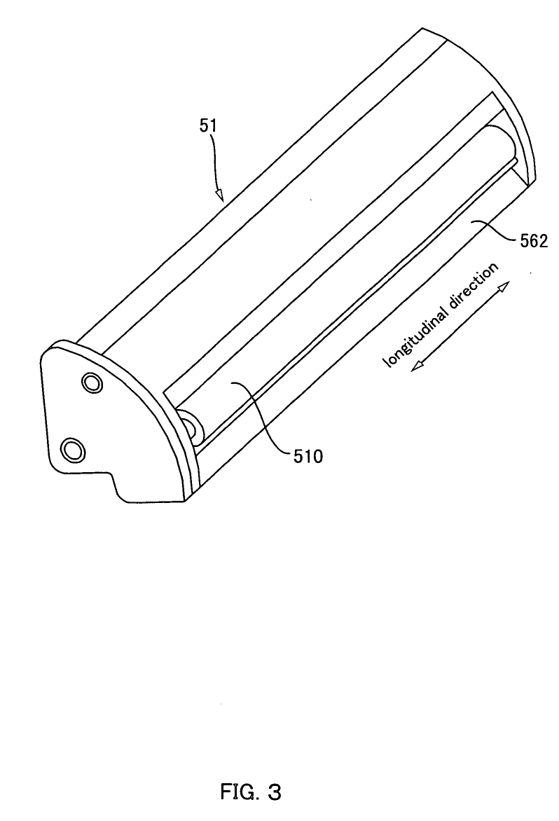

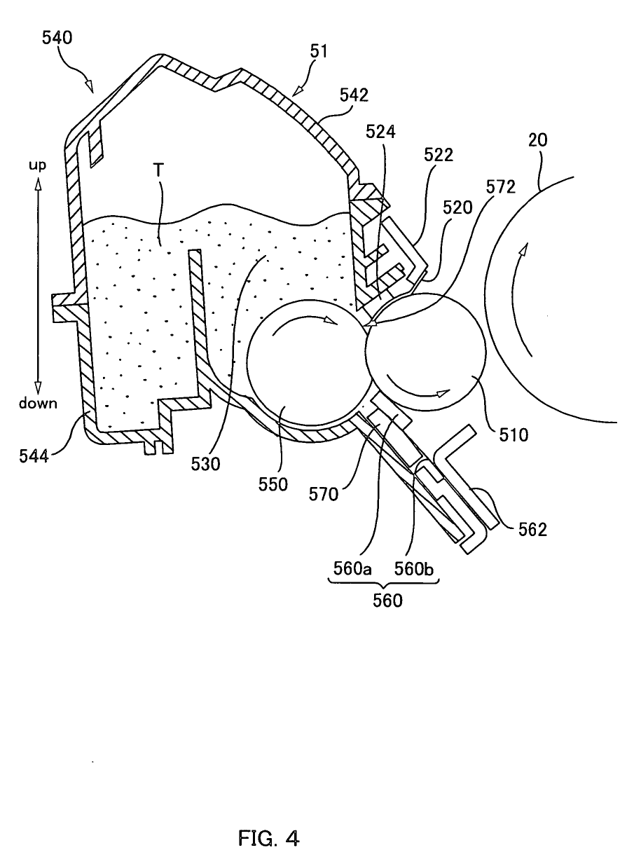

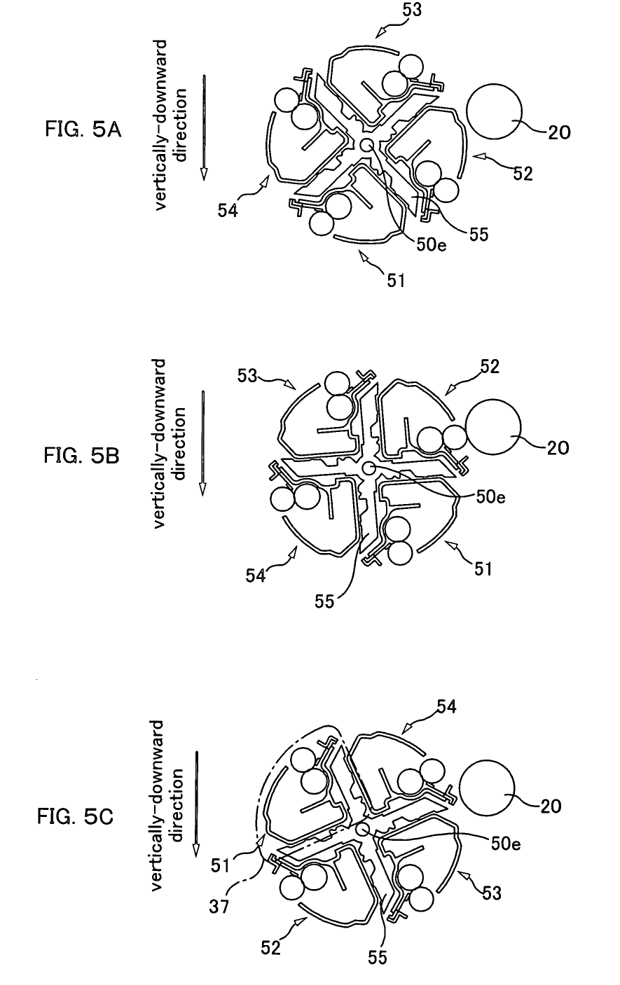

Next, a configuration example of the developing devices is described using FIG. 3 and FIG. 4. FIG. 3 is a conceptual diagram of the developing device, and FIG. 5 is a cross-sectional view showing the major component elements of the developing device. The cross-sectional view shown in FIG. 5 shows a cross-section cutting the developing device along a plane vertical to the longitudinal direction shown in FIG. 3. In FIG. 4, as in FIG. 1, the up and down directions are shown by an arrow, and a state is shown in which the black developing device 51 is located at a developing position opposite the photoconductor 20.

The black developing device 51 which contains black (K) toner, the magenta developing device 53 which contains magenta (M) toner, the cyan developing device 52 which contains cyan (C) toner, and the yellow developing device 54 which contains yellow (Y) toner can be attached to the developing device retaining unit 50, but since the configuration of each developing device is the same, a description will be given of only the black developing device 51.

The black developing device 51 is provided with a developing roller 510 as a developer-bearing roller, a seal member 520, a toner containing section 530, a housing 540, a toner supplying roller 550, a regulating blade 560, and so on.

The developing roller 510 bears the toner T and moves the toner T to a developing position opposite the photoconductor 20. As shown in FIG. 3, the developing roller 510 is supported lengthwise on both side portions and is rotatable around a central shaft. As shown in FIG. 4, the developing roller 510 rotates in a direction (counter-clockwise in FIG. 4) which is opposite to the direction of rotation of the photoconductor 20 (clockwise in FIG. 4). As shown in FIG. 4, the developing roller 510 of the black developing device 51 and the photoconductor 20 are opposed across an interval. That is, the black developing device 51 develops the latent image formed on the photoconductor 20 without being in contact therewith. It should be noted that when developing the latent image formed on the photoconductor 20, an alternating electric field is formed between the developing roller 510 and the photoconductor 20.

The seal member 520 prevents the toner T in the black developing device 51 from leaking outside the device, and also collects the toner T on the developing roller 510, after the developing roller 510 has passed the developing position, into the developing device without wiping it away. The seal member 520 is a seal made of polyethylene film or the like, and is pushed against the developing roller 510 by the elastic force of the seal-urging member 524 which is disposed opposite the developing roller 510 and is made of Moltoprene, etc.

The housing 540 is formed by adhering a plurality of cast housing portions. As shown in FIG. 4, the housing 540 is provided with an opening 572 which connects to the exterior of the housing 540, and the developing roller 510, described above, is disposed in a state partially exposed, with its circumference surface facing the opening 572 from the outside of the housing 540. The regulating blade 560, which is described below, is also disposed in a state partially facing the opening 572 from the outside of the housing 540.

The housing 540 forms a toner containing section 530 capable of containing the toner T.

The toner supplying roller 550 is disposed on the toner containing section 530, described above, and supplies the toner T contained in the toner containing section 530 to the developing roller 510. The toner supplying roller 550 is made of polyurethane foam, for example, and abuts the developing roller 510 in a state of elastic deformation. The toner supplying roller 550 is disposed on the lower portion of the toner containing section 530, while the toner T contained in the toner containing section 530 is supplied to the developing roller 510 by the toner supplying roller 550 at the bottom portion of the toner containing section 530. The toner supplying roller 550 rotates in a direction (in FIG. 4, the clockwise direction) that is opposite the direction of rotation of the developing roller 510 (in FIG. 4, the counterclockwise direction), around a central shaft. It should be noted that the toner supplying roller 550 has the function of supplying the toner T that is contained in the toner containing section 530 to the developing roller 510 as well as the function of wiping away from the developing roller 510 toner T that remains on the developing roller 510 after developing.

The regulating blade 560 regulates the thickness of the toner T layer borne by the developing roller 510, and adds a charge to the toner T borne by the developing roller 510. The regulating blade 560 is provided with a rubber section 560a and a rubber-supporting section 560b. The rubber section 560a is made of silicon rubber or urethane rubber, for example, and the rubber-supporting section 560b is a thin plate of phosphor bronze or stainless steel, for example, and has spring properties. The rubber section 560a is supported by the rubber section 560b, and the rubber-supporting section 560b is attached to the housing 540 via a blade-supporting metal plate 562, with one end portion supported by being sandwiched between a pair of blade-supporting metal plates 562. A blade-backing member 570, made of Moltoprene or the like, is disposed on the opposite side of the developing roller 510 on the regulating blade 560.

Here, the rubber section 560a is pushed against the developing roller 510 by the elastic force created by the flexure of the rubber-supporting section 560b. The blade-backing member 570 prevents the toner T from entering in between the rubber supporting section 560b and the housing 540, stabilizing the elastic force created by the flexure of the rubber supporting section 560b, and, by biasing the rubber section 560a toward the developing roller 510 from directly behind the rubber section 560a, pushes the rubber section 560a against the developing roller 510. Accordingly, the blade-backing member 570 improves the uniform abutting property of the rubber section 560a against the developing roller 510.

In the black developing device 51 thus configured, the toner supplying roller 550 supplies the toner T contained in the toner containing section 530 to the developing roller 510. The toner T that is supplied to the developing roller 510 is brought to the abutting position of the regulating blade 560 as the developing roller 510 rotates, and when the toner T passes the abutting position, the thickness of its layer is regulated, and a charge is added. The toner T on the developing roller 510, whose layer thickness has been regulated, is brought to the developing position opposite the photoconductor 20 by further rotation of the developing roller 510, and is supplied for developing the latent image formed on the photoconductor 20 in an alternating electric field at the developing position. The toner T on the developing roller 510 that has passed the developing position by further rotation of the developing roller 510 passes the seal member 520 and is collected in the developing device without being wiped away by the seal member 520.

The developing devices 51, 52, 53, and 54 are provided with memory storing elements for storing information related to color information of the toner contained in the developing devices, the amount of toner remaining, the rotation time of the developing roller 510, and so on, such as serial EEPROM or other types of non-volatile storage memory (hereafter also referred to as developing-device-side memory) 51a, 52a, 53a, and 54a.

This developing-device-side memory 51a, 52a, 53a, and 54a is connected electrically to the unit controller 102 of the main unit controller section 101 when developing-device-side connectors 51b, 52b, 53b, and 54b disposed on one end side surface of the developing device abut an apparatus-side connector 34 disposed on the main apparatus unit (printer) when needed.

### ===Overview of Developing Device Retaining Unit===

An overview of the developing device retaining unit 50 is given next, with reference to FIG. 5A through FIG. 5C. Note also that in this section, for convenience's sake, a description is given of an example of a case in which the developing devices 51, 52, 53, and 54 are attached to the four attach/detach sections 50a, 50b, 50c, and 50d, but the description is also applicable to a case in which the developing devices containing developer of the same color are attached to at least two of the four attach/detach sections 50a, 50b, 50c, and 50d.

The developing device retaining unit 50 is provided with a rotating shaft 50e located in the center thereof. A supporting frame 55 for holding the developing devices is fixed to the rotating shaft 50e. The rotating shaft 50e is provided across two frame-side plates (not shown) which form the body of the printer 10, supported at each end. The shaft direction of the rotating shaft 50e intersects with the vertical direction.

The supporting frame 55 is provided at 90° intervals in the circumferential direction with the four attach/detach sections 50a, 50b, 50c, and 50d to which are removably attached the developing devices 51, 52, 53, and 53 of four different colors described above around the rotating shaft 50e.

A pulse motor (not shown) is attached to the rotating shaft 50e. Driving the pulse motor rotates the supporting frame 55, thereby enabling positioning of the four developing devices 51, 52, 53, and 54 at a predetermined position.

FIG. 5A through FIG. 5C show three stopped positions of the rotating developing device retaining unit 50. FIG. 5A shows the standby position when waiting for execution of image formation, which is also the “home position,” or the stopped position which acts as the reference position for the rotation direction of the developing device retaining unit 50. FIG. 5B shows the connector attach/detach position where the developing-device-side connector 51b on the black developing device 51 attached to the developing device retaining unit 50 opposes the apparatus-side connector 34, which is provided to the apparatus body side. FIG. 5C shows the attach/detach position of the black developing device 51.

In FIG. 5B and FIG. 5C, the connector attach/detach position and the developing device attach/detach position are shown for the black developing device 51, but the positions achieved by rotating the developing device retaining unit 50 90° at a time are the connector attach/detach positions and developing device attach/detach positions for each developing device.

First, the home position shown in FIG. 5A is described. A home position detecting section 31 (FIG. 7) is provided to one end of the rotating shaft 50e on the developing device retaining unit 50 for detecting the home position. The home position detecting section 31 is made up of a disc for generating signals which is fixed to one end of the rotating shaft 50e, a home position sensor provided with a photo interrupter made up of a light-emitting portion and a light-receiving portion, and so on. The surrounding edge portion of the disc is disposed in a manner positioned between the light-emitting portion and the light-receiving portion of the home position sensor, and when a slit portion formed in the disc moves into a detecting position of the home position sensor, the output signal from the home position sensor changes from low to high. The home position of the developing device retaining unit 50 is detected based on this change in the signal level and the number of pulses from the pulse motor. The apparatus is configured to enable positioning the developing and other positions of each developing device using this home position as a reference.

FIG. 5B is the connector attach/detach position of the black developing device 51 after the pulse motor has been rotated a predetermined number of pulses from the home position. At this connector attach/detach position, the developing-device-side connector 51b on the black developing device 51 attached to the developing device retaining unit 50 opposes the apparatus-side connector 34 provided to the main apparatus unit, thus making it possible to abut or separate the connectors.

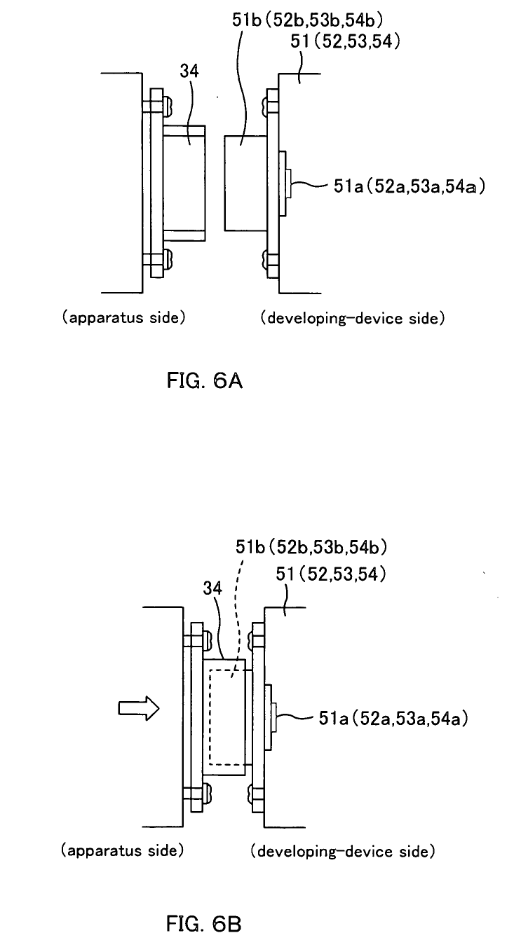

The description is further enlarged, with reference to FIG. 6A and FIG. 6B. FIG. 6A relates to a separated position and FIG. 6B relates to an abutted position.

FIG. 6A shows a state in which the apparatus-side connector 34 and the developing-device-side connector 51b on the black developing device 51 are separated. The apparatus-side connector 34 is separably and movably configured with respect to the black developing device 51, and moves as needed in a direction toward the black developing device 51 as needed (the direction of the arrow shown in FIG. 6B). As shown in FIG. 6B, the apparatus-side connector 34 thus abuts the developing-device-side connector 51b on the black developing device 51, the developing-device-side memory 51a which is attached to the black developing device 51 is electrically connected to the unit controller 102 on the control unit 100, and communication is performed between the developing-device-side memory 51a and the apparatus body.

Conversely, the apparatus-side connector 34 moves in a direction away from the black developing device 51 (the opposite direction from the direction shown by the arrow in FIG. 6B), from a state shown in FIG. 6B in which the apparatus-side connector 34 and developing-device-side connector 51b on the black developing device 51 are abutting. As shown in FIG. 6A, the apparatus-side connector 34 thus separates from the developing-device-side connector 51b on the black developing device 51.

The movement of the apparatus-side connector 34 is realized, for example, by a mechanism (not shown) made up of a pulse motor, a plurality of gears connected to the pulse motor, and an eccentric cam connected to the gears. In other words, rotating the pulse motor by a predetermined number of pulses causes the mechanism to move the apparatus-side connector 34 by a distance corresponding to the number of pulses from a predetermined separated position, thus positioning the apparatus-side connector 34 at a predetermined abutting position. Conversely, rotating the pulse motor in reverse by a predetermined number of pulses causes the mechanism to move the apparatus-side connector 34 by a distance corresponding to the number of pulses from the predetermined abutting position, thus positioning the apparatus-side connector 34 at the predetermined separated position.

The connector attach/detach position with respect to the black developing device 51 is the developing position of the cyan developing device 52 at which the developing roller 510 of the cyan developing device 52 opposes the photoconductor 20. In other words, the connector attach/detach position of the developing device retaining unit 50 as relates to the black developing device 51 is the developing position of the developing device retaining unit 50 as relates to the cyan developing device 52. When the pulse motor rotates the developing device retaining unit 50 90° counter-clockwise, the connector attach/detach position of the yellow developing device 54 and the developing position of the black developing device 51 are achieved, while rotating the developing device retaining unit 50 90° at a time clockwise sequentially achieves the connector attach/detach positions and the developing positions for each developing device.

An attach/detach-dedicated opening 37 through which one developing device can pass and an interior cover (not shown) which can openably and closably covers the attach/detach-dedicated opening are provided to one of the two frame-side plates which support the developing device retaining unit 50 and constitute the body of the printer 10. As shown in FIG. 5C, the attach/detach-dedicated opening 37 is formed at a position such that when the developing device retaining unit 50 is rotated and a developing device is stopped at a set developing device attach/detach position, only that developing device (here, the black developing device 51) can be pulled out and removed in the direction along the rotating shaft 50e. The attach/detach-dedicated opening 37 is formed slightly larger than the outer shape of the developing device, so not only can a developing device be removed at the developing device attach/detach position, but a new developing device can also be attached to the supporting frame 55 by inserting the developing device in a direction along the rotating shaft 50e through the attach/detach-dedicated opening 37. While the developing device retaining unit 50 is positioned anywhere other than the developing device attach/detach position, attachment or removal of the developing device is restricted by the frame-side plates.

A locking mechanism (not shown) is provided for securely fixing the positioning of the developing device retaining unit 50 at the above position.

### ===Overview of Control Unit===

The configuration of the control unit 100 is described next with reference to FIG. 7. FIG. 7 is a block diagram showing the control unit 100 of the printer 10.

The controller section 101 is provided with a CPU 111, an interface 112 for connecting to a computer (not shown), an image memory 113 for storing image signals and so on input from the computer, and a controller-section-side memory 114 which is made up of an electrically rewritable EEPROM 114a, a RAM 114b, a program ROM provided with various control programs, and so on. Various types of information such as image signals are sent from the computer, which is connected to the printer 10, to the controller section 101.

The controller section 101 is provided with a function for converting red, green, and blue RGB data sent as an image signal from the computer, for example, into yellow, magenta, cyan, and black YMCK image data, and storing the converted YMCK image data in the image memory 113. When the printer 10 is being used as a monochrome printer, the RGB data is converted to black image data and the converted black image data is stored in the image memory 113. The controller section 101 is provided with a function for sending various types of information to the connected computer.

The controller section 101 is further provided with a function for counting a number of pixels to be developed when forming toner images of various colors based on the converted YMCK image data, calculating the consumption amount of the toner forecast to be consumed when forming the image based on the YMCK image data, and output this information to the unit controller 102. In the case in which the printer is being used as a monochrome printer, the forecast consumption amount of toner is calculated by counting the number of pixels to be developed when forming the black toner image based on the converted black image data, and this information is output to the unit controller 102.

Model information is stored in the EEPROM 114a as information on the apparatus, indicating whether the printer 10 is being used as a color printer or as a monochrome printer. A more detailed discussion is provided below, but the CPU 111 receives from the unit controller 102 in a predetermined timing attachment information on which of the above-mentioned four attach/detach positions the developing devices are attached to and information on the developing devices, etc. Based on this attachment information, the model information in the EEPROM 114a is rewritten as needed. The model information is written in the EEPROM 114a as a single bit of data, a value of 0 indicating that the printer 10 is being used as a color printer and a value of 1 indicating that the printer 10 is being used as a monochrome printer. This model information is rewritten in the RAM 114b information based on the EEPROM 114a when the power is turned on to the printer 10.

The information on the developing devices includes the remaining amount of developer contained in each of the developing devices and rotation time of the developing rollers provided to the developing devices, for example. For the remaining amount of developer, a ratio in which the amount of developer contained in the unused developing device is assumed to be 100% is stored in a predetermined region of the EEPROM 114a. For the number of rotations of the developing rollers, the rotation time from the moment the developing device was started to be used is stored in a predetermined region of the EEPROM 114a. This information on the developing devices is rewritten when the information stored in the memory is output to the controller section 101 as a response from the unit controller 102 to a request output from the controller section 101.

The unit controller 102 is, for example, provided with a CPU 120, a unit-controller-side memory 116 which is made up of an electrically rewritable EEPROM 116a, a RAM, a program ROM provided with various control programs, and so on, and drive control circuits for driving various apparatus units (the charging unit 30, the exposing unit 40, the first transferring unit 60, the cleaning unit 75, the second transferring unit 80, the fixing unit 90, and the display unit 95) and the developing device retaining unit 50.

The CPU 120 is connected to a serial EEPROM or other non-volatile storing element (hereafter referred to as the apparatus-side memory) 122 via a serial interface 121. The apparatus-side memory 122 stored data needed for apparatus control. Not only the apparatus-side memory 122, but also the developing device-side memories 51a, 52a, 53a, and 54a provided to the developing devices 51, 52, 53, and 54 are connected to the CPU 120 via the serial interface 121, making data transfer between the apparatus-side memory 122 and the developing-device-side memory 51a, 52a, 53a, and 54a possible, as well as making input of a chip select signal CS possible to the developing device-side memories 51a, 52a, 53a, and 54a via an I/O port 123. The CPU 120 is also connected to the home position detecting section 31 via the I/O port 123.

The CPU 120 in the unit controller 102 is electrically connected to the drive control circuits and controls the drive control circuits based on control signals from the CPU 111 in the controller section 101. In other words, the unit controller 102 controls the various units and the developing device retaining unit 50 based on signals input from the controller section 101 while detecting the state of the units and the developing device retaining unit 50 by receiving signals from the sensors and so on provided to each unit.

The CPU 120 controls the drive control circuits based on the model information described above. That is, when the model information value is 0, the CPU 120 controls the units and the developing device retaining unit 50 of the printer 10 as a color printer, and when the model information value is 1, the CPU 120 controls the units and the developing device retaining unit 50 of the printer 10 as a monochrome printer.

The CPU 120 can communicate with the developing device-side memories 51a, 52a, 53a, and 54a when one of the developing device connectors located at the connector attach/detach position is connected to the apparatus-side connector 34. The CPU 120 acquires various information on the developing device from the developing device-side memories 51a, 52a, 53a, and 54a in the developing device connected to the apparatus-side connector 34. The developing device information includes, for example, attachment information on which of the four attach/detach sections provided to the developing device retaining unit 50 the developing device is attached, color information on the toner contained in the attached developing device, remaining amount information on the contained toner, rotation time information on the developing roller, and so on, the acquired information being stored in a predetermined region in the apparatus-side memory 122 in the unit controller 102 in correspondence with each developing device.

For example, if the printer 10 is being used as a color printer, four developing devices containing developers of four mutually different colors (black developing device 51, magenta developing device 53, cyan developing device 52, and yellow developing device 54) being attached to the four attach/detach sections, the CPU 120 detects that these developing devices are attached to the four attach/detach sections by accessing the developing device-side memories of each developing device. A “1” is stored in the predetermined region of the apparatus-side memory 122 indicating that those developing devices are attached. At this time, the CPU 120 also acquires information from each developing device, and stores this information to regions in the apparatus-side memory 122 corresponding to each attach/detach section as binary information indicating the color and the remaining amount of toner contained in the attached developing devices and the rotation time of the developing rollers. If, of the four attach/detach sections, developing devices containing black toner are attached to the two attach/detach sections 50a and 50c and the printer 10 is thus being used as a monochrome printer, the CPU 120 detects that those developing devices are attached to those two attach/detach sections by accessing the developing device-side memories of the two developing devices. The CPU 120 then stores a 1, indicating that the developing devices are attached, to the predetermined regions in the apparatus-side memory 122, and stores a 0, indicating that the developing devices are attached, to the regions corresponding to the other attach/detach sections 50b and 50d. At this time, the CPU 120 also acquires information from each developing device, and stores this information to regions in the apparatus-side memory 122 corresponding to each attach/detach position as binary information indicating the color (black) and the remaining amount of toner contained in the attached developing devices and the rotation time of the developing rollers.

Then the CPU 120 detects the information indicating the toner consumption amount output from the controller section 101, subtracts the toner consumption amount from the remaining amount of toner stored in the apparatus-side memory 122, and stores to the apparatus-side memory 122 the calculated remaining amount of toner. The CPU 120 is provided with a function for outputting to the controller section 101 the information indicating the remaining amount of toner stored in the apparatus-side memory 122 in response to a request for toner remaining amount information from the controller section 101.

The CPU 120 calculates the rotation time of the developing roller from the information indicating the printing size and the number of sheets printed, included in the print requests from the controller section 101, and stores this in the apparatus-side memory 122. The CPU 120 is provided with a function for outputting to the controller section 101 the information indicating the rotation time of the developing rollers stored in the apparatus-side memory 122 in response to a request for rotation time information of the developing rollers from the controller section 101.

The CPU 120 rotates the developing device retaining unit 50 based on information on the developing devices and so on. For example, in the case in which a plurality of sheets is printed continuously using only a black developing device, the developing device retaining unit 50 is rotated once every time printing of the set number of sheets is complete, in order to shake the contained toner. In the case in which two or more black developing devices are attached, if, for example, the remaining amount of toner in a certain developing device becomes equal to or below a predetermined remaining amount, another developing device which is attached is moved to the developing position by rotating the developing device retaining unit 50. Furthermore, when the rotation time of a developing roller of one of the attached developing devices is equal to or longer than a set predetermined rotation time, another attached developing device is moved to the developing position or the developing device whose rotation time has become equal to or longer than the predetermined time is moved to the attach/detach position by rotating the developing device retaining unit 50. This control for rotating the developing device retaining unit 50 is executed by control of the unit controller 102 based on the various acquired information.

### ===Printer Operation ===

Next is given a description of operation of the printer 10, in the case in which it is being used as a color printer for forming color images, and in the case in which it is being used as a monochrome printer for forming black-and-white images as monochrome images. The present embodiment is described separated into an example in which an event has occurred in which development cannot be performed with a predetermined developing device, and an example in which such an event does not occur, in the middle of an printing operation based on a print command input from the external computer. Incidentally, the event in which development cannot be performed with a predetermined developing device is either a case in which the remaining amount of toner contained in a developing device becomes equal to or below a predetermined amount or the rotation time of a developing roller provided to a developing device is a predetermined time or longer, for example. Here, descriptions are given of the case in which the remaining amount of toner becomes equal to or below a predetermined amount and the case in which the rotation time of the developing roller becomes equal to or longer than a predetermined time.

The remaining amount of toner is arrived at by subtracting the amount of toner consumed by printing operations, thereby indicating a forecast remaining amount. As described above, the amount of developer contained in an unused developing device (the initial amount) is set as 100%, and the remaining amount of toner is indicated as a ratio to that initial amount, and stored in the apparatus-side memory 122. In the present embodiment, the controller section 101 designates a designated developing device and announces to a user etc. by displaying a warning to the effect that “The toner is running low.” to the display unit 95 when the remaining amount is determined to be 10% or less. When the remaining amount of toner falls equal to or below 5%, the developing device enters a state in which development can no longer be performed, and the controller section 101 is set to announce to the user etc. through a display to the effect that “The toner has run out.” or “Replace the developing device.”

The rotation time of the developing roller is stored by adding the predetermined rotation time every time an image is formed on a single medium. That is, the rotation time of the developing roller is indicated as a cumulative rotation time from a developing roller rotation time of 0 for an unused developing device. The predetermined rotation time is set in correspondence with the size of the medium on which the image is formed. For example, in the case in which the developing roller rotates for five seconds when developing an A4 sized image, the controller section 101 is set such that 5 is added to the corresponding developing device information stored in the apparatus-side memory 122 every time a single medium is developed. If, as a result of this addition, the rotation time passes 1,000 seconds, the unit controller 102 determines that the relevant developing device is in a state in which development cannot be performed. When the controller section 101 detects this event, it is set to announce to the user etc. by displaying “Replace the developing device,” etc. to the display unit 95.

### <Initial Operations of Printer>

First, a description is given of the initial operations of the printer 10 from turning on the power to entering standby mode for waiting for a print command. During these initial operations, the controller section 101 of the printer 10 communicates with the unit controller 102 and acquires information on the attached developing devices. Based on the acquired information, the printer 10 begins operation either as a color printer or as a monochrome printer.

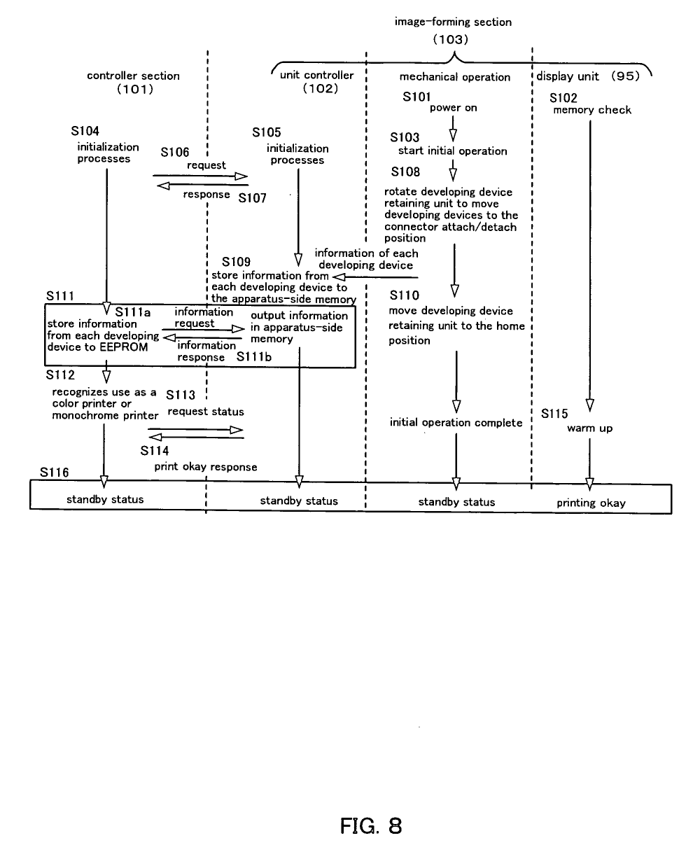

FIG. 8 is a view explaining the initial operations of the printer. When the power is turned on (S101), the printer 10 displays “Checking memory . . . ” for example, to the display unit 95 (S102) and the controller section 101 initializes the image memory 113, the EEPROM 114a, and so on (S104), while the unit controller 102 initializes the apparatus-side memory 122 and so on (S105). The controller section 101 sends a request to the unit controller 102 for verifying whether the predetermined communication is possible or not (S106). Once the unit controller 102 receives this request, a response indicating that communication is possible is sent to the controller section 101 (S107), and communication between the controller section 101 and the unit controller 102 begins.

When the power is turned on (S101), the unit controller 102 rotates the developing device retaining unit 50, thereby moving the four attach/detach sections to the connector attach/detach position in sequence (S108). In the case in which the apparatus-side connector 34 is moved and a developing device is attached to the attach/detach section located at the connector attach/detach position, information is acquired which stored in the developing-device-side memory in that developing device (S109). The information that is read from the developing devices includes color information on the contained toner, remaining amount information on the contained toner, information indicating rotation time of the developing rollers, and so on, and is stored for each developing device in a predetermined region of the apparatus-side memory 122. Once the information is acquired from each developing device, the unit controller 102 moves the developing device retaining unit 50 to the home position based on the output of the home position detecting section 31 (S110). At this time, the unit controller 102 concurrently executes predetermined warm-up operations (S103). The warm-up operations include all operations needed for executing printing, such as, for example, emitting light from the light source of the exposing unit 40, turning on the heater of the fixing unit 90, rotating and thereby cleaning the photoconductor 20 and the intermediate transferring member 70, and so on.

During the warm-up operations of the image-forming section 103, the controller section 101 acquires the information on the developing devices stored in the apparatus-side memory 122 for storage in the EEPROM 114a of the controller section 101 (S111). At this time, the controller section 101 outputs to the unit controller 102 an information request requesting information indicating the remaining amounts of toner for each color, the rotation times of the developing rollers, and so on (S111a). The unit controller 102 outputs an information response to the controller section 101 indicating the remaining amounts of toner for each color, the rotation time of the developing rollers, and so on (S111b). After receiving the information response, the controller section 101 operates the printer 10 as a color printer, for example, if Y, M, C, and K developing devices are detected as being attached to the four attach/detach sections based on the information in the apparatus-side memory 122, or as a monochrome printer, if two or more developing devices of the same color, for example black developing devices, are detected as being attached (S112).

While the unit controller 102 is executing the initial operations, the controller section 101 outputs at suitable intervals status requests for requesting status information indicating the state of the image-forming section 103 (S113). Upon receiving this request, the unit controller 102 detects the output from sensors and the like provided to each unit, and if the warm-up operations are finished, outputs to the controller section 101 a response indicating that printing is possible, and if the warm-up operations are not finished, outputs to the controller section 101 a response indicating that printing is not possible (S114). If the response from the unit controller 102 indicates that printing is not possible, the controller section 101 displays “Warming up . . . ” for example, to the display unit 95 (S115).

When status information regarding the status of the image-forming section 103 is received indicating that printing is possible, “Ready to print” for example, is displayed to the display unit 95, and the printer 10 enters standby status (S116).

<One-Page Color Printing Processes and Operations when the Printer is Being Used as a Color Printer>

First, a description is given of basic processes and operations for color printing in the case in which the printer 10 is being used as a color printer, using as an example a case in which one page of color printing is executed. In this example, information is acquired during the initial operations indicating that yellow, magenta, cyan, and black developing devices are attached to the attach/detach sections, information indicating that the remaining amount of toner in the developing devices is at least 10% is taken as being stored in the EEPROM 114a, while information indicating that the rotation times of the developing rollers in the developing devices are all 30 is taken as being stored in the apparatus-side memory 122.

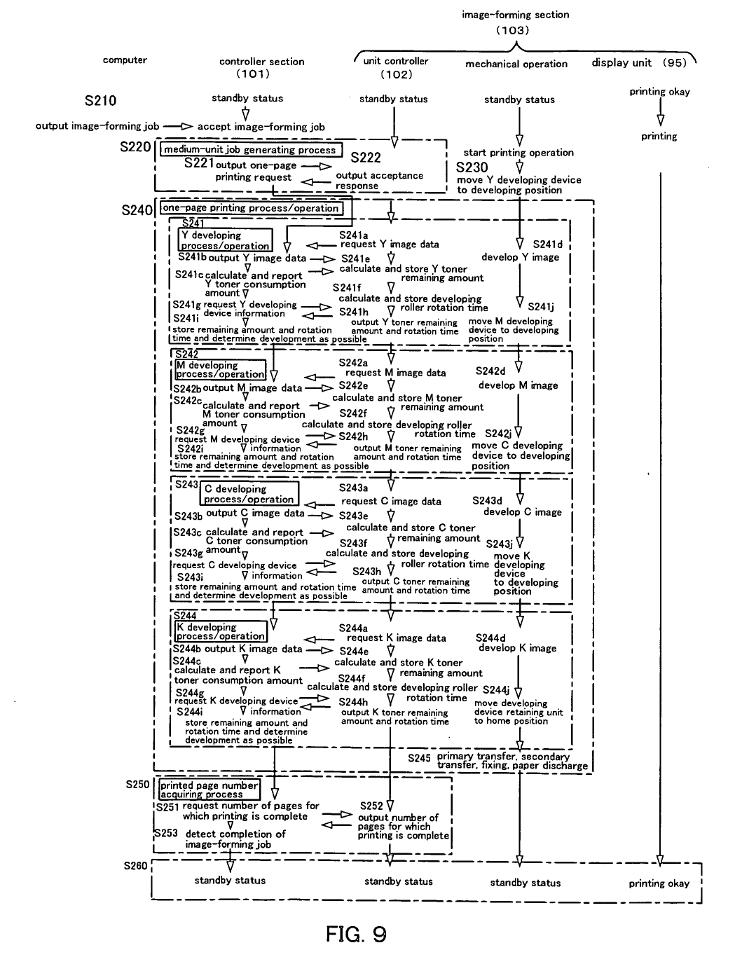

FIG. 9 is a view explaining processes and operations when executing color printing of one page in the case in which the printer 10 is being used as a color printer. As shown, the printing process begins when image signals and control signals—that is, a print command and image data for executing color printing of one sheet (one page) on A4 sized paper as a medium—from the computer (not shown), connected in a manner allowing two-way communication, are input to the printer 10 in standby status via the interface 112 (S210). The number of sheets (number of pages) to print is thus designated and the printing process to be executed, which is generated by the print command and image data for executing printing which are input to the printer, is equivalent to the “image-forming job” according to the claims. Based on this image-forming job, a medium-unit job, which is the printing process executed on one sheet of the medium, is generated for the designated number of sheets. That is, the medium-unit job is generated for the designated number of sheets, and printing of one page is executed based on the generated medium-unit job, thereby completing the image-forming job.

Based on the image-forming job, the controller section 101 outputs to the unit controller 102 in a suitable timing a one-page print request for requesting execution of a color printing process for one page, or in other words of a medium-unit job (S221). Upon receiving the one-page print request, the unit controller 102 detects the status of each unit in the image-forming section 103, and if the status allows printing, outputs to the controller section 101 an acceptance response for accepting the one-page print request (S222). A single medium-unit job is thereby generated and the printing process begins. Hereafter, the process by which a single medium-unit job is generated in this way is referred to as a medium-unit job generating process (S220). As regards the one-page print request, the controller section 101 and the unit controller 102 communicate while the unit controller 102 is controlling the various units, so no medium-unit job is generated during a set interval.

The unit controller 102 rotates the developing device retaining unit 50 from the home position thereby moving the yellow developing device (Y developing device) 54 to the developing position (S230). Once the Y developing device 54 has been moved to the developing position, the unit controller 102 outputs a request to the controller section 101 requesting Y image data (S241a). Upon receiving this request, the controller section 101 outputs the Y image data to the unit controller 102 (S241b) while also calculating and then outputting to the unit controller 102 the toner consumption amount consumed when performing development based on the Y image data (S241c). The unit controller 102 executes the developing operation (S241d), while also subtracting the received consumption amount from the remaining amount of the toner in the Y developing device 54 stored in the apparatus-side memory 122, calculating the remaining amount of the toner after development, and rewriting the information in the apparatus-side memory 122 (S241e). The unit controller 102 adds 5 to the rotation time of the developing roller of the Y developing device 54 stored in the apparatus-side memory 122, calculates the rotation time of the developing roller after development (the cumulative rotation time), and rewrites the information in the apparatus-side memory 122 (S241f). At this time, the unit controller 102 detects that the rotation time of the developing roller of the Y developing device 54 has not reached 1,000 seconds. The controller section 101 outputs to the unit controller 102 in a suitable timing an information request requesting information indicating the remaining amount of the toner after development and information indicating the rotation time of the developing roller after development due to the medium-unit job (S241g). The unit controller 102 outputs to the controller section 101 the information indicating the remaining amount of the Y toner and the information indicating the rotation time of the developing roller, which are stored in the apparatus-side memory 122 (S241h). The controller section 101 rewrites the information in the EEPROM 114a based on the acquired information indicating the remaining amount of the Y toner and the information indicating the rotation time of the developing roller (S241i). At this time, the controller section 101 determines whether or not the acquired information indicating the remaining amount of the Y toner is information indicating 10% or lower or 5% or lower, and whether or not the acquired information indicating the rotation time of the developing roller of the Y developing device is information indicating 1,000 seconds or more. Here, it is taken to be that the information indicating the remaining amount of the Y toner is greater than 10%, and that the information indicating the rotation time of the developing roller of the Y developing device 54 is less than 1,000 seconds. The controller section 101 determines that development is possible and continues the printing process.

When development of the Y image is finished, the unit controller 102 rotates the developing device retaining unit 50, thereby moving the magenta developing device (M developing device) 53 to the developing position (S241j). The processes from the unit controller 102 requesting the controller section 101 for the Y image data until moving the M developing device 53 to the developing position in this way is hereafter referred to as the Y developing process/operation (S241).

Once the Y developing process/operation is complete, the unit controller 102 outputs a request to the controller section 101 requesting magenta image (M image) data (S242a). Upon receiving this request, the controller section 101 outputs the M image data to the unit controller 102 (S242b) while also calculating and then outputting to the unit controller 102 the toner consumption amount consumed when performing development based on the M image data (S242c). The unit controller 102 executes the developing operation (S242d), while also subtracting the received consumption amount from the remaining amount of the toner in the M developing device 53 stored in the apparatus-side memory 122, calculating the remaining amount of the toner after development, and rewriting the information in the apparatus-side memory 122 (S242e). The unit controller 102 adds 5 to the rotation time of the developing roller of the M developing device 53 stored in the apparatus-side memory 122, calculates the rotation time of the developing roller after development (the cumulative rotation time), and rewrites the information in the apparatus-side memory 122 (S242f). At this time, the unit controller 102 detects that the rotation time of the developing roller of the M developing device 53 has not reached 1,000 seconds. The controller section 101 outputs to the unit controller 102 in a suitable timing an information request requesting information indicating the remaining amount of the toner after development and information indicating the rotation time of the developing roller after development due to the medium-unit job (S242g). The unit controller 102 outputs to the controller section 101 the information indicating the remaining amount of the M toner and the information indicating the rotation time of the developing roller, which are stored in the apparatus-side memory 122 (S242h). The controller section 101 rewrites the information in the EEPROM 114a based on the acquired information indicating the remaining amount of the M toner and the information indicating the rotation time of the developing roller (S242i). At this time, the controller section 101 determines whether or not the acquired information indicating the remaining amount of the M toner is information indicating 10% or lower or 5% or lower, and whether or not the acquired information indicating the rotation time of the developing roller of the M developing device 53 is information indicating 1,000 seconds or more. Here, it is taken to be that the information indicating the remaining amount of the M toner is greater than 10%, and that the information indicating the rotation time of the developing roller of the M developing device 53 is less than 1,000 seconds, so the controller section 101 determines that developing is possible, and continues the printing process.

When development of the M image is finished, the unit controller 102 rotates the developing device retaining unit 50, thereby moving the cyan developing device (C developing device) 52 to the developing position (S242j). The processes from the unit controller 102 requesting the controller section 101 for the M image data until moving the C developing device 52 to the developing position in this way is hereafter referred to as the M developing process/operation (S242).

Once development of the M image is complete, the unit controller 102 outputs a request to the controller section 101 requesting the cyan image (C image) data (S243a). Upon receiving this request, the controller section 101 outputs the C image data to the unit controller 102 (S243b) while also calculating and then outputting to the unit controller 102 the toner consumption amount consumed when performing development based on the C image data (S243c). The unit controller 102 executes the developing operation (S243d), while also subtracting the received consumption amount from the remaining amount of the toner in the C developing device 52 stored in the apparatus-side memory 122, calculating the remaining amount of the toner after development, and rewriting the information in the apparatus-side memory 122 (S243e). The unit controller 102 adds 5 to the rotation time of the developing roller of the C developing device 52 stored in the apparatus-side memory 122, calculates the rotation time of the developing roller after development (the cumulative rotation time), and rewrites the information in the apparatus-side memory 122 (S243f). At this time, the unit controller 102 detects that the rotation time of the developing roller of the C developing device 52 has not reached 1,000 seconds. The controller section 101 outputs to the unit controller 102 in a suitable timing an information request requesting information indicating the remaining amount of the C toner after development and information indicating the rotation time of the developing roller after development due to the medium-unit job (S243g). The unit controller 102 outputs to the controller section 101 the information indicating the remaining amount of the C toner and the information indicating the rotation time of the developing roller, which are stored in the apparatus-side memory 122 (S243h). The controller section 101 rewrites the information in the EEPROM 114a based on the acquired information indicating the remaining amount of the C toner and the information indicating the rotation time of the developing roller on the C developing device 52 (S242i). At this time, the controller section 101 determines whether or not the acquired information indicating the remaining amount of the C toner is information indicating 10% or lower or 5% or lower, and whether or not the acquired information indicating the rotation time of the developing roller of the C developing device 52 is information indicating 1,000 seconds or more. Here, it is taken to be that the information indicating the remaining amount of the C toner is greater than 10%, and that the information indicating the rotation time of the developing roller of the C developing device 52 is less than 1,000 seconds, so the controller section 101 determines that developing is possible, and continues the printing process.

When development of the C image is finished, the unit controller 102 rotates the developing device retaining unit 50, thereby moving the black developing device (K developing device) 51 to the developing position (S243j). The processes from the unit controller 102 requesting the controller section 101 for the C image data until moving the K developing device 51 to the developing position in this way is hereafter referred to as the C developing process/operation (S243).

Once development of the C image is complete, the unit controller 102 outputs a request to the controller section 101 requesting the black image (K image) data (S244a). Upon receiving this request, the controller section 101 outputs the K image data to the unit controller 102 (S244b) while also calculating and then outputting to the unit controller 102 the toner consumption amount consumed when performing development based on the K image data (S244c). The unit controller 102 executes the developing operation (S244d), while also subtracting the received consumption amount from the remaining amount of the toner in the K developing device 51 stored in the apparatus-side memory 122, calculating the remaining amount of the toner after development, and rewriting the information in the apparatus-side memory 122 (S244e). The unit controller 102 adds 5 to the rotation time of the developing roller of the K developing device 51 stored in the apparatus-side memory 122, calculates the rotation time of the developing roller after development (the cumulative rotation time), and rewrites the information in the apparatus-side memory 122 (S244f). At this time, the unit controller 102 detects that the rotation time of the developing roller of the K developing device 51 has not reached 1,000 seconds. The controller section 101 outputs to the unit controller 102 in a suitable timing an information request requesting information indicating the remaining amount of the K toner after development and information indicating the rotation time of the developing roller after development due to the medium-unit job (S243g). The unit controller 102 outputs to the controller section 101 the information indicating the remaining amount of the K toner and the information indicating the rotation time of the developing roller, which are stored in the apparatus-side memory 122 (S244h). The controller section 101 rewrites the information in the EEPROM 114a based on the acquired information indicating the remaining amount of the K toner and the information indicating the rotation time of the developing roller on the K developing device 51 (S243i). At this time, the controller section 101 determines whether or not the acquired information indicating the remaining amount of the K toner is information indicating 10% or lower or 5% or lower, and whether or not the acquired information indicating the rotation time of the developing roller of the K developing device 51 is information indicating 1,000 seconds or more. Here, it is taken to be that the information indicating the remaining amount of the K toner is greater than 10%, and that the information indicating the rotation time of the developing roller of the K developing device 51 is less than 1,000 seconds, so the controller section 101 determines that developing is possible, and continues the printing process.

When development of the K image is finished, the unit controller 102 rotates the developing device retaining unit 50, thereby moving developing device retaining unit 50 to the developing position (S244j). The processes from the unit controller 102 requesting the controller section 101 for the K image data until moving the developing device retaining unit 50 to the developing position in this way is hereafter referred to as the K developing process/operation (S244). In the example described here, the image-forming job was a print command for executing printing of one page, so the developing device retaining unit 50 was moved to the home position after the K image was developed. However, in the case in which there is an image to continue developing, the Y developing device 54 is moved to the developing position after developing the K image. In this case, the processes from the unit controller 102 requesting the controller section 101 for the K image data until moving Y developing device 54 to the developing position is referred to as the K developing process/operation.

Once development using the toners of all four colors is complete, a color toner image is formed by overlapping the four colors of toner images. This color toner image is transferred to the paper, which is supplied by the supply tray, by the second transferring unit 80, made into a permanent image by the fixing unit 90, and ejected (S245). In this way, in the printing process for one page through a single medium-unit job, the Y developing process/operation (S241), the M developing process/operation (S242), the C developing process/operation (S243), the K developing process/operation (S244), primary transfer, secondary transfer, fixing, and ejection (S245) are executed. The processes and operations from the Y developing process/operation (S241) until the ejection (S245) are hereafter referred to as a one-page printing process/operation (S240).

The controller section 101 outputs to the unit controller 102 in a suitable timing a request for acquiring the number of pages for which printing is complete (S251). Once a printing operation for one page is finished, the unit controller 102 outputs a response to the controller section 101 indicating that the printing operation for one page has finished (S252). If, at this time, the number of pages to print as designated by the image-forming job is output as the response, the controller section 101 detects that the image-forming job is finished (S253). The process of checking the number of pages for which printing is finished every time printing of one page finishes is hereafter referred to as the printed page number verification process (S250).

The printer 10 enters standby status and the controller section 101 displays “Ready to print,” for example, to the display unit 95 (S260).

<Multi-Page Color Printing Processes and Operations when the Printer is Being Used as a Color Printer>

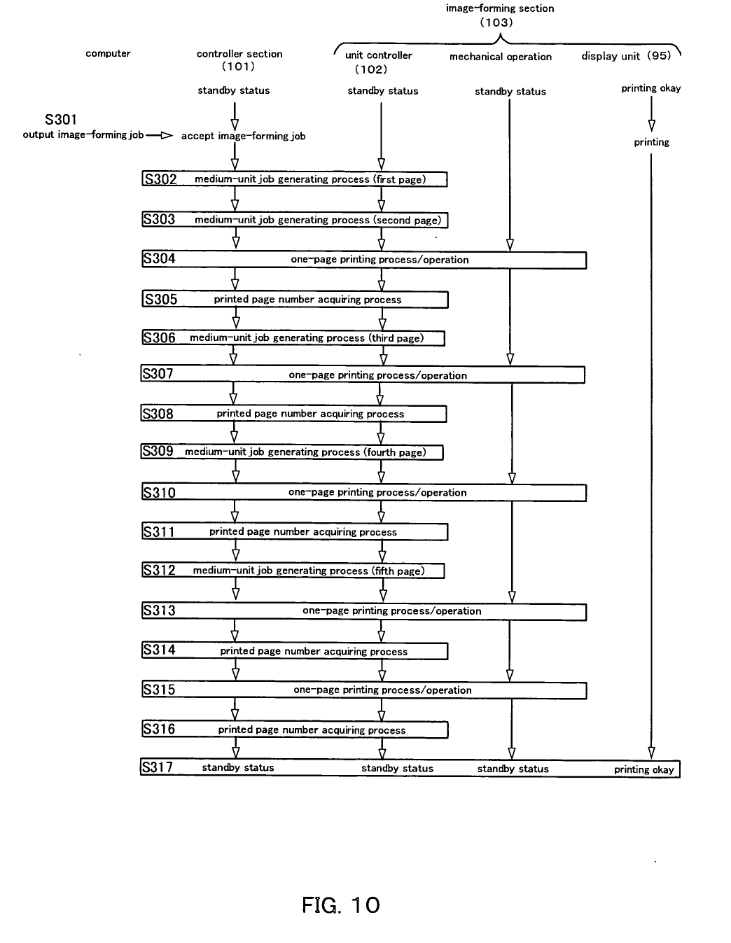

Next the processes and operations are described when performing color printing of multiple pages continuously. FIG. 10 is a view explaining processes and operations when executing color printing of five pages in the case in which the printer 10 is being used as a color printer. In the following description, detailed descriptions of processes and operations similar to the processes and operations for printing one page described above are omitted.

As with printing one page, the printing process begins when image signals and control signals—that is, a print command for executing color printing of five sheets (five pages) on A4 sized paper—from the computer (not shown) are input to the printer 10 in standby status via the interface 112 (S301).

It is taken that two medium-unit jobs have been generated between the controller section 101 and the unit controller 102 before two medium-unit job generating processes are executed and development of the Y image in the printing operation of the first page is begun (S302, S303).

The unit controller 102 rotates the developing device retaining unit 50 from the home position, and executes the one-page printing process/operation for the first page (S304). The remaining amounts of toner in each developing device calculated during this one-page printing process/operation are taken to be more than 10% and the rotation time of the developing rollers on each developing device to be less than 1,000 seconds.

When the one-page printing process/operation for the first page is finished, a printed page number acquiring process is executed (S305). In this process, the unit controller 102 outputs to the controller section 101 a response indicating that the printing operation for the first page is finished.

Between the controller section 101 and the unit controller 102, the medium-unit job generating process is executed for generating the medium-unit job for the third page, and the third medium-unit job is generated (S306).

Once the developing process for the first page from the first medium-unit job is complete, the unit controller 102 moves the Y developing device 54 to the developing position and executes the one-page printing process/operation for the second page (S307). The remaining amounts of toner in each developing device calculated during this one-page printing process/operation are taken to be more than 10% and the rotation time of the developing rollers on each developing device to be less than 1,000 seconds.

When the one-page printing process/operation for the second page is finished, the printed page number acquiring process is executed (S308). In this process, the unit controller 102 outputs to the controller section 101 a response indicating that the printing operation for the second page is finished.

Between the controller section 101 and the unit controller 102, the medium-unit job generating process is executed for generating the medium-unit job for the fourth page, and the fourth medium-unit job is generated (S309).

Once the developing process for the second page from the first medium-unit job is complete, the unit controller 102 moves the Y developing device 54 to the developing position and executes the one-page printing process/operation for the third page (S310). The remaining amounts of toner in each developing device calculated during this one-page printing process/operation are taken to be more than 10% and the rotation time of the developing rollers on each developing device to be less than 1,000 seconds.

When the one-page printing process/operation for the third page is finished, a printed page number acquiring process is executed (S311). In this process, the unit controller 102 outputs to the controller section 101 a response indicating that the printing operation for the third page is finished.

Between the controller section 101 and the unit controller 102, the medium-unit job generating process is executed for generating the medium-unit job for the fifth page, and the fifth medium-unit job is generated (S312).

Once the developing process for the third page from the first medium-unit job is complete, the unit controller 102 moves the Y developing device 54 to the developing position and executes the one-page printing process/operation for the fourth page (S313). The remaining amounts of toner in each developing device calculated during this one-page printing process/operation are taken to be more than 10% and the rotation time of the developing rollers on each developing device to be less than 1,000 seconds.

When the one-page printing process/operation for the fourth page is finished, a printed page number acquiring process is executed (S314). In this process, the unit controller 102 outputs to the controller section 101 a response indicating that the printing operation for the fourth page is finished.

Once the developing process for the fourth page from the first medium-unit job is complete, the unit controller 102 moves the Y developing device 54 to the developing position and executes the one-page printing process/operation for the fifth page (S315). The remaining amounts of toner in each developing device calculated during this one-page printing process/operation are taken to be more than 10% and the rotation time of the developing rollers on each developing device to be less than 1,000 seconds.

When the one-page printing process/operation for the fifth page is finished, a printed page number acquiring process is executed (S316). In this process, the unit controller 102 outputs to the controller section 101 a response indicating that the printing operation for the fifth page is finished. With this response, the controller section 101 detects that the image-forming job is complete, the printer 10 enters a standby status, and the controller section 101 displays “Ready to print,” for example, to the display unit 95 (S317).

<Color Printer Operation when the Remaining Amount of Toner in the Developing Devices is Equal to or Lower than a Predetermined Amount>

Next follows a description of processes and operations of the printer 10 in the case in which the remaining amount of toner in the M developing device is equal to or below 5%, when the printer 10 is being used as a color printer. In this example, the focus is on the remaining amount of toner, so descriptions of the process for calculating the rotation time of the developing rollers and the determination of whether or not the rotation time is equal to or greater than 1,000 seconds are omitted. It is assumed that the information indicating the remaining amount of toner in the M developing device is 8% when the information for each developing device stored in the apparatus-side memory 122 during the initial operations is acquired.

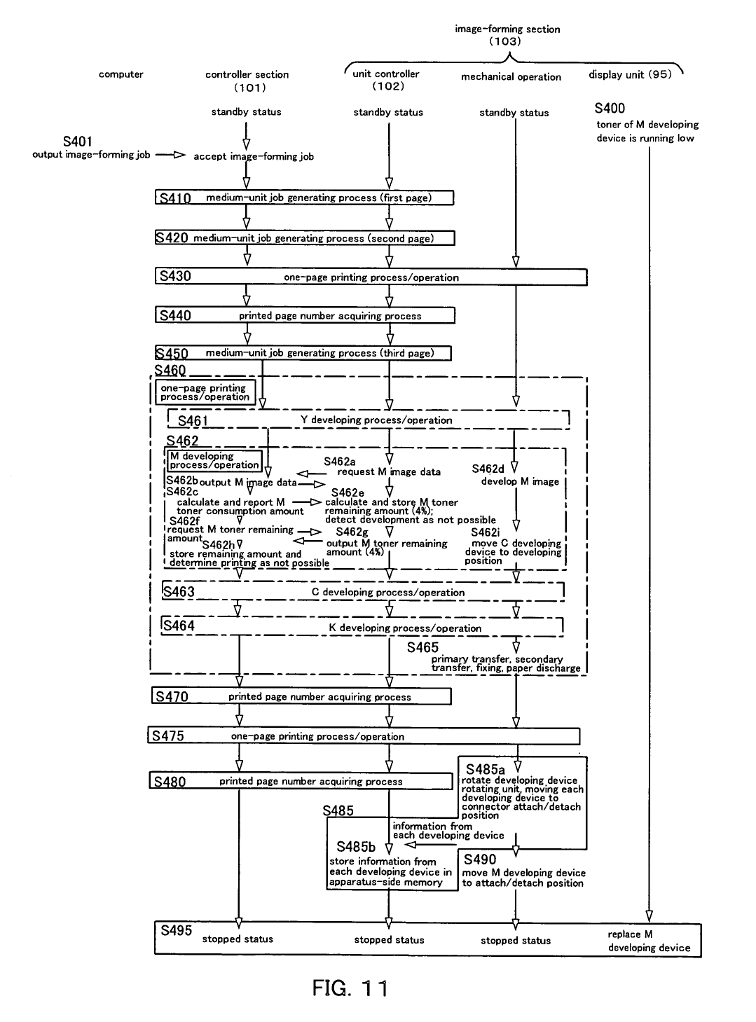

FIG. 11 is a view explaining processes and operations of the printer 10 when the remaining amount of toner in the M developing device falls equal to or below 5% when the printer 10 is being used as a color printer.

The controller section 101 detects that the remaining amount of M toner is less than 10% during the initial operations, displays “M toner running low,” for example, to the display unit 95, announces to the user etc. of the event, and puts the printer 10 in standby status (S400). As when executing five-page color printing, the printing process begins when an image-forming job is input to the printer 10 from the computer (not shown) for executing color printing of five pages (S401). Again, it is taken that two medium-unit jobs have been generated between the controller section 101 and the unit controller 102 before two medium-unit job generating processes are executed and development of the Y image in the first medium-unit job is begun (S410, S420).

The unit controller 102 rotates the developing device retaining unit 50 from the home position, and executes the one-page printing process/operation for the first page (S430). It is assumed that the remaining amount of M toner calculated during this one-page printing process/operation is 6%, while the remaining amount of the other toners is above 10%.

When the one-page printing process/operation for the first page is finished, a printed page number acquiring process is executed (S440). In this process, the unit controller 102 outputs to the controller section 101 a response indicating that the printing operation for the first page is finished.

Between the controller section 101 and the unit controller 102, the medium-unit job generating process is executed for generating the medium-unit job for the third page, and the third medium-unit job is generated (S450).

The controller section 101 continues the developing operation, because the remaining amount of toner in all the developing devices is above 5%.

As with the one-page printing process/operation for the first page, the unit controller 102 moves the Y developing device 54 to the developing position and executes the Y developing process/operation (S461) in the one-page printing process/operation for the second page (S460), based on the second medium-unit job. Assuming that the remaining amount of the Y toner calculated during the Y developing process/operation is greater than 10%, the controller section 101 determines that developing is possible and continues the printing process.

Once the development of the Y image is complete, the unit controller 102 executes the M developing process/operation (S462). That is, the unit controller 102 outputs a request to the controller section 101 requesting the M image data (S462a). Upon receiving this request, the controller section 101 outputs the M image data to the unit controller 102 (S462b) while also calculating and then outputting to the unit controller 102 the toner consumption amount consumed when performing development based on the M image data (S462c). The unit controller 102 executes the developing operation (S462d), while also subtracting the received consumption amount from the remaining amount of the toner in the M developing device 53 stored in the apparatus-side memory 122, calculating the remaining amount of the toner after development, and rewriting the information in the apparatus-side memory 122 (S462e). The unit controller 102 at this time detects that the remaining amount of toner in the M developing device 53 is equal to or less than 5%, and determines that the M developing device 53 is in a state in which development cannot be performed.

The controller section 101 outputs to the unit controller 102 in a suitable timing an information request requesting information indicating the remaining amount of the M toner after development and after development due to the medium-unit job (S462f). The unit controller 102 outputs to the controller section 101 information indicating the remaining amount of the M toner stored in the apparatus-side memory 122 (S462g). The controller section 101 rewrites the information in the EEPROM 114a based on the acquired information indicating the remaining amount of the M toner (S462h). At this time, the acquired remaining amount of the M toner is 4%, and the controller section 101 detects that the remaining amount of toner in the M developing device 53 is equal to or less than 5%, and determines that the M developing device 53 is in a state in which development cannot be performed. The controller section 101 thereafter stops the process for outputting one-page printing requests. On the other hand, the unit controller 102 moves the C developing device to the developing position in a continuation of the developing operation of the M image, and then stops (S462i).

Thereafter, as with the printing process of the first page, the C developing process/operation (S463), the K developing process/operation (S464), primary transfer, secondary transfer, fixing, and ejection (S465) are executed, and the one-page printing process/operation through the second medium-unit job is completed. At this time, during the C developing process/operation (S463) and the K developing process/operation (S464), the calculated remaining amounts of the toner in the C developing device and the K developing device are assumed to be greater than 10%.

When the one-page printing process/operation for the second page is finished, a printed page number acquiring process is executed (S470). In this process, the unit controller 102 outputs to the controller section 101 a response indicating that the printing operation for the second page is finished. That is, at this point, three medium-unit jobs have been generated, and the developing operation based on the second medium-unit job has finished. The printer 10 executes the one-page printing process/operation for the third page based on the remaining one medium-unit job (S475).

When the one-page printing process/operation for the third page is finished, the printed page number acquiring process is executed (S480). As a result of printed page number acquiring process, the controller section 101 detects that the printing based on the three medium-unit jobs already generated has finished.

The unit controller 102 then moves each of the attached developing devices to the connector attach/detach position in sequence by rotating the developing device retaining unit 50 (S485a). The apparatus-body side connector 34 is moved and the information such as the information on the remaining amount of toner stored in the apparatus-side memory 122 is stored in the developing-device-side memory of each developing device (S485b). The process of acquiring information stored in the apparatus-side memory 122 and storing it in the developing-device-side memory of each developing device is hereafter referred to as the memory information acquiring process (S485).

Furthermore, the developing device retaining unit 50 is rotated, thereby moving the M developing device 53, with which developing can no longer be performed, to the developing device attach/detach position (S490). The controller 101 displays “Replace the M developing device,” for example, to the display unit 95, announces to the user etc. of the event, and stops operation of the printer 10 (S495).

<Color Printer Operation when the Rotation Time of a Developing Roller is Equal to or Longer than a Predetermined Time>

A description is given of a case in which the rotation time of a developing roller becomes equal to or longer than a predetermined time, omitting detailed descriptions of processes and operations similar to a case in which the remaining amount of toner in a developing device becomes equal to or below a predetermined amount. In this example, the focus is on the rotation time of a developing roller, so descriptions of the process for calculating the remaining amount of toner and determining whether or not the remaining amount of toner is equal to or below 5% are omitted. The information of the developing devices stored in the apparatus-side memory 122 acquired during the initial processes is assumed to be information indicating that the rotation times for the developing rollers in the Y developing device, the C developing device, and the K developing device has already reached 900 seconds, while the rotation time for the developing roller on the M developing device has already reached 990 seconds.

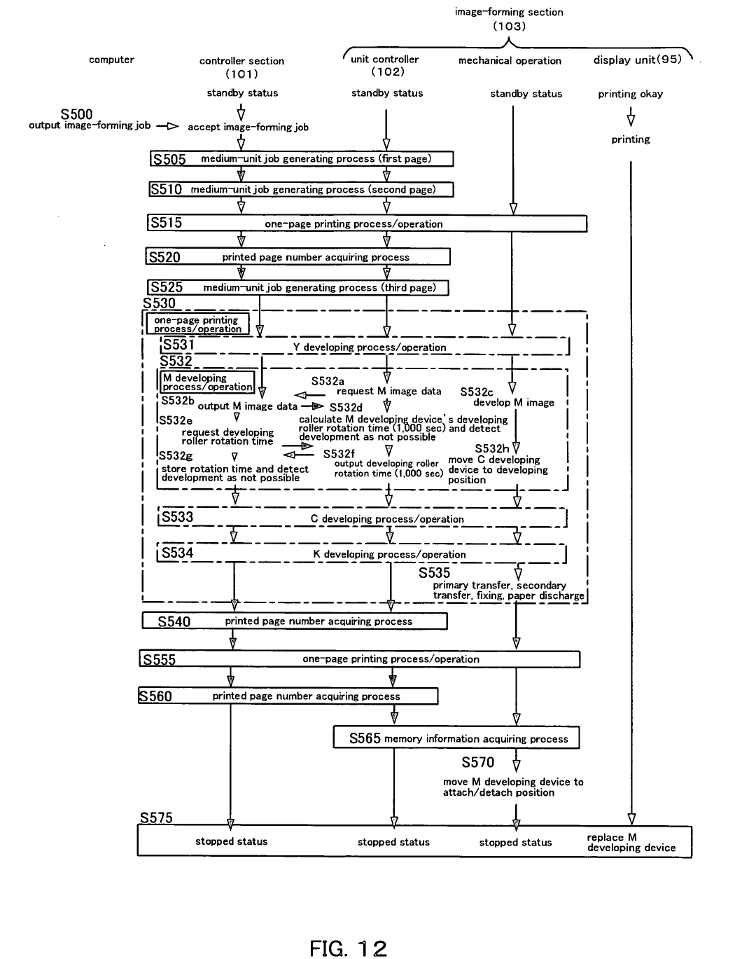

FIG. 12 is a view explaining processes and operations of the printer 10 when the rotation time of the developing roller on the M developing device has reached 1,000 seconds or more, when the printer is being used as a color printer.

As when executing five-page color printing, the printing process begins when an image-forming job is input to the printer 10 from the computer (not shown) for executing color printing of five pages (S500). Again, it is taken that two medium-unit jobs have been generated between the controller section 101 and the unit controller 102 before two medium-unit job generating processes are executed and development of the Y image in the first medium-unit job is begun (S505, S510).

The unit controller 102 rotates the developing device retaining unit 50 from the home position, and executes the one-page printing process/operation for the first page (S515). The rotation time of the developing roller on the M developing device calculated during this one-page printing process/operation is 995 seconds, while the rotation times of the developing rollers on the other developing devices is 905 seconds.

When the one-page printing process/operation for the first page is finished, a printed page number acquiring process is executed (S520). In this process, the unit controller 102 outputs to the controller section 101 a response indicating that the printing operation for the first page is finished.

At this time, the medium-unit job generating process for generating the third medium-unit job is executed between the controller section 101 and the unit controller 102 (S545). At this time, the unit controller 102 detects that the rotation times of the developing rollers on all the developing devices is lower than 1,000 seconds, and therefore outputs an acceptance response to the one-page printing request from the controller section 101 requesting the third medium-unit job. The third medium-unit job is therefore generated.

As with the one-page printing process/operation for the first page, the unit controller 102 moves the Y developing device 54 to the developing position and executes the Y developing process/operation (S531) in the one-page printing process/operation for the second page (S530), based on the second medium-unit job. The rotation time of the developing roller on the Y developing device 54 calculated during the Y developing process/operation is detected as not reaching 1,000 seconds.

Once the development of the Y image is complete, the unit controller 102 executes the M developing process/operation (S532). That is, the unit controller 102 outputs a request to the controller section 101 requesting the M image data (S532a). Upon receiving this request, the controller section 101 outputs the M image data to the unit controller 102 (S532b). The unit controller 102 executes the developing process (S532c). The unit controller 102 adds 5 to the rotation time of the developing roller of the M developing device 53 stored in the apparatus-side memory 122, calculates the rotation time of the developing roller after development (the cumulative rotation time), and rewrites the information in the apparatus-side memory 122 (S532d). At this time, the calculated rotation time of the developing roller on the M developing device 53 reaches 1,000 seconds, and the unit controller 102 detects that the rotation time of the developing roller on the M developing device 53 is 1,000 or more seconds.

The controller section 101 outputs to the unit controller 102 in a suitable timing an information request requesting information indicating the rotation time of the developing roller on the M developing device 53 after development due to the medium-unit job (S532e). The unit controller 102 outputs to the controller section 101 information indicating the rotation time of the developing roller on the M developing device stored in the apparatus-side memory 122 (S532f). The controller section 101 rewrites the information in the EEPROM 114a based on the acquired information indicating the rotation time of the developing roller on the M developing device 53 (S532g). At this time, the acquired rotation time of the developing roller on the M developing device 53 is 1,000 seconds, and the controller section 101 detects that the rotation time of the developing roller on the M developing device 53 is 1,000 or more seconds, and determines that the M developing device 53 is in a state in which development cannot be performed. The controller section 101 thereafter stops the process for outputting one-page printing requests. On the other hand, the unit controller 102 moves the C developing device to the developing position in a continuation of the developing operation of the M image, and then stops (S532h).

Thereafter, as with the printing process of the first page, the C developing process/operation (S533), the K developing process/operation (S534), primary transfer, secondary transfer, fixing, and ejection (S535) are executed, and the one-page printing process/operation through the second medium-unit job is completed. At this time, the rotation times of the developing rollers on the C developing device and the K developing device are less than 1,000 seconds.

When the one-page printing process/operation for the second page is finished, a printed page number acquiring process is executed (S540).

At this point, three medium-unit jobs have been generated, and the developing operation based on the two medium-unit jobs has finished. The printer 10 executes the one-page printing process/operation for the third page based on the remaining one medium-unit job (S555).

When the one-page printing process/operation for the third page is finished, a printed page number acquiring process is executed (S560). As a result of printed page number acquiring process, the controller section 101 detects that the printing based on the three medium-unit jobs already generated has finished.

The unit controller 102 executes a memory information acquiring process (S565) and stores in the developing-device-side memory of each developing device information such as information indicating the rotation time of the developing rollers stored in the apparatus-side memory 122. Furthermore, the developing device retaining unit 50 is rotated, thereby moving the M developing device 53, with which developing can no longer be performed, to the developing device attach/detach position (S570). The controller 101 displays “Replace the M developing device,” for example, to the display unit 95, announces to the user etc. of the event, and stops operation of the printer 10 (S575).

<Operation when the Printer is Being Used as a Monochrome Printer>

In the present embodiment, a case is described in which the printer 10 is being used as a monochrome printer, with K developing devices being attached to the two attach/detach sections 50a and 50c of the four attach/detach sections 50a, 50b, 50c, and 50d provided to the developing device retaining unit 50. In the following description, the K developing device attached to the attach/detach section 50a is called the first K developing device and the K developing device attached to the attach/detach section 50c is called the second K developing device.

The processes and operations in the case in which one page is printed when the printer 10 is being used as a monochrome printer differ from the one-page printing process/operation (S240) of the processes and operations of the color printer shown in FIG. 9. Specifically, when the printer 10 is being used as a monochrome printer, the points that differ are that the Y image developing process/operation (S241), the M image developing process/operation (S242), and the C image developing process/operation (S243) are not executed during the one-page printing process/operation (S240), and that the developing devices are not moved for every developing operation by a developing device. The processes and operations in the case in which multiple pages are printed when the printer 10 is being used as a monochrome printer differ from the one-page printing process/operation (S304, S307, S310, S313, and S315) of the processes and operations of the color printer shown. Specifically, when the printer 10 is being used as a monochrome printer, the one-page printing process/operation for printing multiple pages differ. For this reason, when the printer 10 is being used as a monochrome printer, descriptions are omitted of the processes and operations when printing one page and the processes and operations when printing multiple pages. In order to differentiate between the one-page printing process/operation when the printer 10 is being used as a color printer and the one-page printing process/operation when the printer 10 is being used as a monochrome printer, the monochrome printer one-page printing process/operation is hereafter referred to as the monochrome one-page printing process/operation.

<Monochrome Printer Operation when the Remaining Amount of Toner in the Developing Devices is Equal to or Lower than a Predetermined Amount>

Next follows a description of processes and operations of the printer 10 in the case in which the remaining amount of toner in the K developing device is equal to or below 5%, when the printer 10 is being used as a monochrome printer. In this example, the focus is on the remaining amount of toner, so descriptions of the process for calculating the rotation time of the developing rollers and the determination of whether or not the rotation time is equal to or greater than 1,000 seconds are omitted. Here, the controller section 101 acquires the information for the two developing devices stored in the apparatus-side memory 122 during the initial operations. The acquired information is assumed to be information indicating that the remaining amount of toner in the first K developing device 51 is 8% and information indicating that the remaining amount of toner in the second K developing device 51 is 50%. At this time, the controller section 101 detects that the first and second K developing devices are attached and that the remaining amount of toner in the second K developing device is greater than 10%, and determines that development can be performed with the first and second K developing devices.

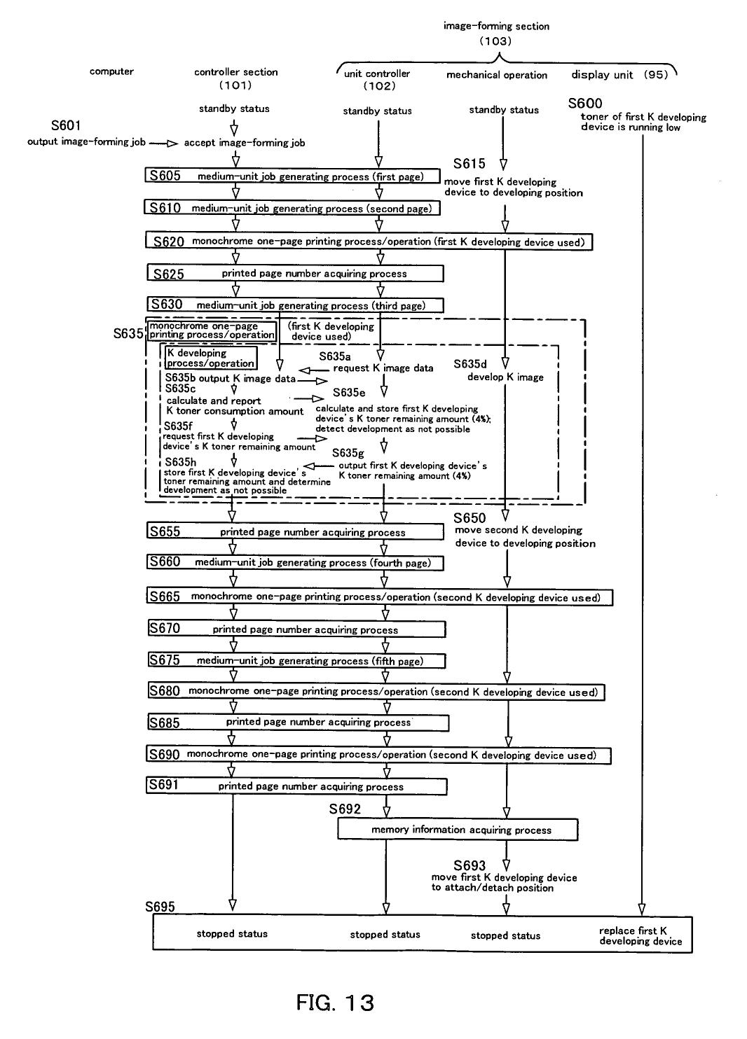

FIG. 13 is a view explaining processes and operations of the printer 10 when the remaining amount of toner in one K developing device falls equal to or below 5% when the printer 10 is being used as a monochrome printer.

The controller section 101 detects that the remaining amount of K toner in the first K developing device is less than 10%, displays “Toner in the first K developing device is running low,” for example, to the display unit 95, announces to the user etc. of the event, and puts the printer 10 in standby status (S600).

The printing process begins when an image-forming job is input from a computer (not shown), connected in a manner allowing two-way communication, to the printer 10 for executing monochrome printing of five pages (S601). Again, it is taken that two medium-unit jobs have been generated between the controller section 101 and the unit controller 102 before two medium-unit job generating processes are executed and development of the K image in the first medium-unit job is begun (S605, S610).

The unit controller 102 rotates the developing device retaining unit 50 from the home position, thereby moving the first K developing device 51 to the developing position (S615), and executes a monochrome one-page printing process/operation for the first page based on the first medium-unit job (S620). The remaining amount of toner in the first K developing device calculated during the monochrome one-page printing process/operation is 6%.

When the monochrome one-page printing process/operation for the first page is finished, a printed page number acquiring process is executed (S625). In this process, the unit controller 102 outputs to the controller section 101 a response indicating that the printing operation for the first page is finished.

Between the controller section 101 and the unit controller 102, the medium-unit job generating process is executed for generating the medium-unit job for the third page, and the third medium-unit job is generated (S630).

The controller section 101 continues the developing operation, because the remaining amount of toner in the first K developing device is above 5%.

The unit controller 102 executes the monochrome one-page printing process/operation for the second page based on the second medium-unit job, in the same way as the monochrome one-page printing process/operation for the first page (S635). That is, the unit controller 102 outputs a request to the controller section 101 requesting the K image data (S635a). Upon receiving this request, the controller section 101 outputs the K image data to the unit controller 102 (S635b) while also calculating and then outputting to the unit controller 102 the toner consumption amount consumed when performing development based on the K image data (S635c). The unit controller 102 executes the developing operation (S635d), while also subtracting the received consumption amount from the remaining amount of the toner in the first K developing device 51 stored in the apparatus-side memory 122, calculating the remaining amount of the toner after development, and rewriting the information in the apparatus-side memory 122 (S244e). At this time, the calculated remaining amount of toner in the first K developing device 51 is 4%, and the unit controller 102 detects that the remaining amount of toner in the first K developing device 51 is equal to or less than 5%, and determines that the first K developing device is in a state in which development cannot be performed.

The controller section 101 outputs to the unit controller 102 in a suitable timing an information request requesting information indicating the remaining amount of the K toner of the first K developing device 51 after development and after development due to the medium-unit job (S635f). The unit controller 102 outputs to the controller section 101 information indicating the remaining amount of the K toner of the first K developing device 51 stored in the apparatus-side memory 122 (S635g). The controller section 101 rewrites the information in the EEPROM 114a based on the acquired information indicating the remaining amount of the K toner in the first K developing device 51 (S462h). At this time, the acquired remaining amount of toner in the first K developing device 51 is 4%, and the controller section 101 detects that the remaining amount of toner in the first K developing device 51 is equal to or less than 5%, and determines that the first K developing device is in a state in which development cannot be performed.

On the other hand, the unit controller 102 continues and then stops the monochrome one-page printing process/operation of the second page. At this time, the unit controller 102 has already detected that the second K developing device, which contains toner of the same color as the toner in the first K developing device, is attached to attach/detach section 50c. For this reason, the unit controller 102 rotates the developing device retaining unit 50 and moves the second K developing device 51 to the developing position (S650).

When the monochrome one-page printing process/operation for the second page is finished, a printed page number acquiring process is executed (S655). In this process, the unit controller 102 outputs to the controller section 101 a response indicating that the printing operation for the second page is finished.

Between the controller section 101 and the unit controller 102, the medium-unit job generating process is executed for generating the medium-unit job for the fourth page, and the fourth medium-unit job is generated (S660).

The unit controller 102 executes the monochrome one-page printing process/operation for the third page, based on the third medium-unit job (S665). Through the monochrome one-page printing process/operation for the third page, information that the remaining amount of toner in the second K developing device is 48%, for example, is stored in the EEPROM 114a. The controller section 101 continues the developing operation, because the remaining amount of toner in the second K developing device is also above 5%.

When the monochrome one-page printing process/operation for the third page is finished, a printed page number acquiring process is executed (S670). In this process, the unit controller 102 outputs to the controller section 101 a response indicating that the printing operation for the third page is finished.

Between the controller section 101 and the unit controller 102, the medium-unit job generating process is executed for generating the medium-unit job for the fifth page, and the fifth medium-unit job is generated (S675).

The unit controller 102 executes the monochrome one-page printing process/operation for the fourth page, based on the fourth medium-unit job (S680). Through the monochrome one-page printing process/operation for the fourth page, information that the remaining amount of toner in the first K developing device is 46%, for example, is stored in the EEPROM 114a. The controller section 101 continues the developing operation, because the remaining amount of toner in the second K developing device is also above 5%.

When the monochrome one-page printing process/operation for the fourth page is finished, a printed page number acquiring process is executed (S685). In this process, the unit controller 102 outputs to the controller section 101 a response indicating that the printing operation for the fourth page is finished.

The unit controller 102 executes the monochrome one-page printing process/operation for the fifth page, based on the fifth medium-unit job (S690). Through the monochrome one-page printing process/operation for the fifth page, information that the remaining amount of toner in the first K developing device is 44%, for example, is stored in the EEPROM 114a. The controller section 101 continues the developing operation, because the remaining amount of toner in the second K developing device is also above 5%.

When the monochrome one-page printing process/operation for the fifth page is finished, a printed page number acquiring process is executed (S691). In this process, the unit controller 102 outputs to the controller section 101 a response indicating that the printing operation for the fifth page is finished. Through the printed page acquiring process, the controller section 101 detects that the printing based on the image-forming job is finished.

The unit controller 102 executes a memory information acquiring process (S692) and stores in the developing-device-side memory of the two developing devices information such as information indicating the remaining amount of toner in the two developing devices stored in the apparatus-side memory 122. Furthermore, the developing device retaining unit 50 is rotated, thereby moving the first K developing device 51, with which developing can no longer be performed, to the developing device attach/detach position (S693). The controller section 101 then displays “Replace the first K developing device,” for example, to the display unit 95 and the printer 10 enters a state in which operation is stopped (S695). At this time, the controller section 101 may also be made to display “The first K developing device has run out of toner” or “Ready to print,” for example, to the display unit 95 and the printer 10 may enter a standby state.

In the present embodiment, a case has been described in which the remaining amount of toner in the attached second K developing device is 50%, but for example in a case in which the remaining amount of toner in the second K developing device is 8%, the remaining amount of toner in both of the developing devices falls equal to or below 5% before the image-forming job is complete. In this case, first the remaining amount of toner in the first K developing device falls equal to or below 5% if printing is performed using the first K developing device based on the first two medium-unit jobs, and the second K developing device is moved to the developing position. Using the second K developing device to print based on the third and fourth medium-unit jobs causes the remaining amount of toner in the second K developing device to fall equal to or below 5%, so both developing devices enter a state in which development cannot be performed. Detecting that the remaining amount of toner in the developing devices has fallen equal to or below 5%, the controller section 101 does not output a one-page print request, so no medium-unit job is generated. At this time, if for example the fifth medium-unit job has already been generated, the unit controller 102 moves either of the K developing devices to the developing device attach/detach position after executing everything up to the printing operation based on the fifth medium-unit job using the second K developing device. The controller section 101 detects that the developing device that has been moved to the developing device attach/detach position and announces to the user etc. by displaying to the display unit 95 a message urging replacement of the corresponding K developing device.

<Monochrome Printer Operation when the Rotation Time of a Developing Roller is Equal to or Longer than a Predetermined Time>

Next follows a description of processes and operations of the printer 10 in the case in which the rotation time of the developing roller on the K developing device is 1,000 seconds or more, when the printer 10 is being used as a monochrome printer. In this example, the focus is on the rotation time of a developing roller, so descriptions of the process for calculating the remaining amount of toner and determining whether or not the remaining amount of toner is equal to or below 5% are omitted. Here, the controller section 101 acquires the information for the two developing devices stored in the apparatus-side memory 122 during the initial operations. It is assumed that the acquired information is information indicating that the rotation time of the developing roller of the first K developing device 51 is 999 seconds, and that the rotation time of the developing roller of the second K developing device 51 is 500 seconds. At this time, the unit controller 102 determines that development can be performed with both the first and second K developing devices as the rotation time of the developing rollers of both the first and second K developing devices is less than 1,000 seconds.

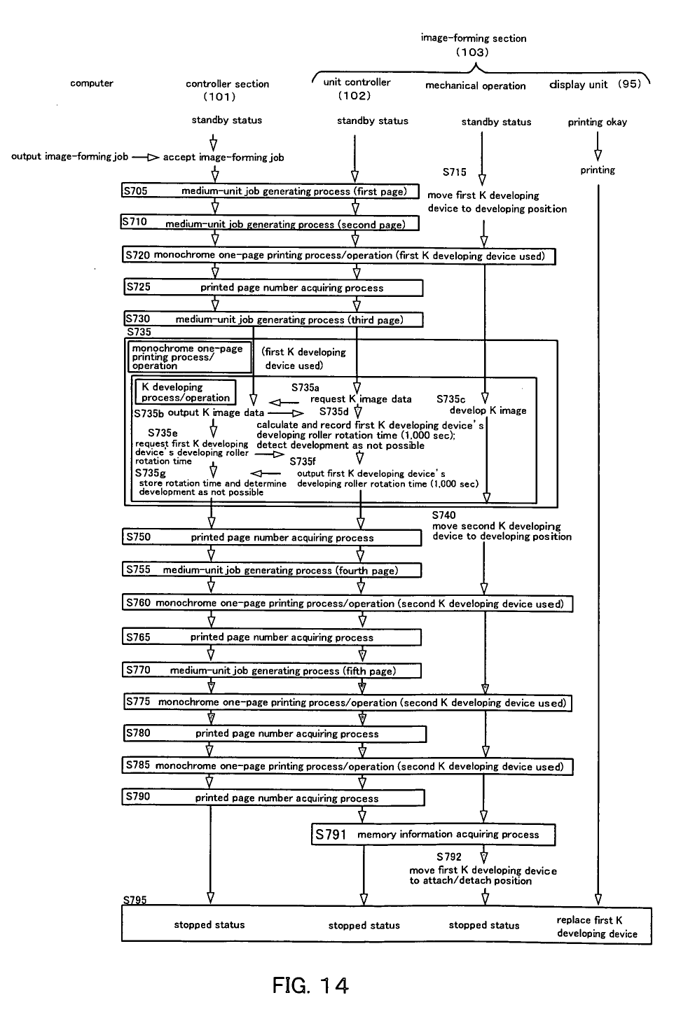

FIG. 14 is a view explaining processes and operation of the printer 10 when the rotation time of a developing roller of one K developing device rises 1,000 seconds or more when the printer 10 is being used as a monochrome printer.

The printing process begins when an image-forming job is input from a computer (not shown), connected in a manner allowing two-way communication, to the printer 10 for executing monochrome printing of five pages of A4 size (S700). Again, it is taken that two medium-unit jobs have been generated between the controller section 101 and the unit controller 102 before two medium-unit job generating processes are executed and development of the K image in the first medium-unit job is begun (S705, S710).

The unit controller 102 rotates the developing device retaining unit 50 from the home position, thereby moving the first K developing device 51 to the developing position (S715), and executes a monochrome one-page printing process/operation for the first page based on the first medium-unit job (S720). The rotation time of the developing roller on the first K developing device calculated during the monochrome one-page printing process/operation is 995 seconds. The unit controller 102 detects that the rotation time of the developing roller of the first K developing device is less than 1,000 seconds.

When the monochrome one-page printing process/operation for the first page is finished, a printed page number acquiring process is executed (S725). In this process, the unit controller 102 outputs to the controller section 101 a response indicating that the printing operation for the first page is finished.

Between the controller section 101 and the unit controller 102, the medium-unit job generating process is executed for generating the medium-unit job for the third page, and the third medium-unit job is generated (S730).

The unit controller 102 executes the monochrome one-page printing process/operation for the second page based on the second medium-unit job, in the same way as the monochrome one-page printing process/operation for the second page (S735). That is, the unit controller 102 outputs a request to the controller section 101 requesting the K image data (S735a). Upon receiving this request, the controller section 101 outputs the K image data to the unit controller 102 (S735b). The unit controller 102 executes the developing process (S735c). The unit controller 102 adds 5 to the rotation time of the developing roller of the first K developing device 51 stored in the apparatus-side memory 122, calculates the rotation time of the developing roller after development (the cumulative rotation time), and rewrites the information in the apparatus-side memory 122 (S735d). At this time, the calculated rotation time of the developing roller on the K developing device 51 reaches 1,000 seconds, and the unit controller 102 detects that the rotation time of the developing roller on the K developing device 51 is 1,000 or more seconds (S735e).

The controller section 101 outputs to the unit controller 102 in a suitable timing an information request requesting information indicating the rotation time of the developing roller on the first K developing device 51 after development due to the medium-unit job (S532e). The unit controller 102 outputs to the controller section 101 information indicating rotation time of the developing roller on the first K developing device 51 stored in the apparatus-side memory 122 (S735g). The controller section 101 rewrites the information in the EEPROM 114a based on the acquired information indicating the rotation time of the developing roller on the first K developing device 51 (S735g). At this time, the acquired rotation time of the developing roller on the first K developing device 51 is 1,000 seconds, and the controller section 101 detects that the rotation time of the developing roller on the first K developing device 51 is 1,000 or more seconds, and determines that the first K developing device 51 is in a state in which development cannot be performed.

The unit controller 102 continues the developing operation of the K image and stops the monochrome one-page printing process/operation for the second medium-unit job. At this time, the unit controller 102 has already detected that the second K developing device, which contains toner of the same color as the toner in the first K developing device which is attached to attach/detach section 50c. For this reason, the unit controller 102 rotates the developing device retaining unit 50 and moves the second K developing device 51 to the position of the first K developing device, or in other words, the developing position (S740).

When the monochrome one-page printing process/operation for the second page is finished, a printed page number acquiring process is executed (S750). In this process, the unit controller 102 outputs to the controller section 101 a response indicating that the printing operation for the second page is finished.

Between the controller section 101 and the unit controller 102, the medium-unit job generating process is executed for generating the medium-unit job for the fourth page, and the fourth medium-unit job is generated (S755).

The unit controller 102 executes the monochrome one-page printing process/operation for the third page, based on the third medium-unit job (S760). The apparatus-side memory 122 stores information that the rotation time of the developing roller on the second K developing device has reached 505 seconds, during the monochrome one-page printing process/operation for the third page. The unit controller 102 detects that the rotation time of the developing roller of the second K developing device is less than 1,000 seconds.

When the monochrome one-page printing process/operation for the third page is finished, a printed page number acquiring process is executed (S765). In this process, the unit controller 102 outputs to the controller section 101 a response indicating that the printing operation for the third page is finished.

Between the controller section 101 and the unit controller 102, the medium-unit job generating process is executed for generating the medium-unit job for the fifth page, and the fifth medium-unit job is generated (S770).

The unit controller 102 executes the monochrome one-page printing process/operation for the fourth page, based on the fourth medium-unit job (S775). The apparatus-side memory 122 stores information that the rotation time of the developing roller on the second K developing device has reached 510 seconds, during the monochrome one-page printing process/operation for the fourth page. The unit controller 102 detects that the rotation time of the developing roller of the second K developing device is less than 1,000 seconds.

When the monochrome one-page printing process/operation for the fourth page is finished, a printed page number acquiring process is executed (S780). In this process, the unit controller 102 outputs to the controller section 101 a response indicating that the printing operation for the fourth page is finished.

The unit controller 102 executes the monochrome one-page printing process/operation for the fifth page, based on the fifth medium-unit job (S785). The apparatus-side memory 122 stores information that the rotation time of the developing roller on the second K developing device has reached 515 seconds, during the monochrome one-page printing process/operation for the fifth page. The unit controller 102 detects that the rotation time of the developing roller of the second K developing device is less than 1,000 seconds.

When the monochrome one-page printing process/operation for the fifth page is finished, a printed page number acquiring process is executed (S790). In this process, the unit controller 102 outputs to the controller section 101 a response indicating that the printing operation for the fifth page is finished. Through the printed page acquiring process, the controller section 101 detects that the printing based on the image-forming job is finished.

The unit controller 102 executes a memory information acquiring process (S791) and stores in the developing-device-side memory of the two developing devices information such as information indicating the rotation time of the developing roller in the two developing devices stored in the apparatus-side memory 122. Furthermore, the developing device retaining unit 50 is rotated, thereby moving the first K developing device 51, with which developing can no longer be performed, to the developing device attach/detach position (S792). The controller 101 displays “Replace the first K developing device,” for example, to the display unit 95, announces to the user etc. of the event, and stops operation of the printer 10 (S795). At this time, the controller section 101 may also be made to display “Replace the first K developing device” or “Ready to print,” for example, to the display unit 95 and the printer 10 may enter a standby state.

In the present embodiment, a case has been described in which the rotation time of the developing roller on the second K developing device reaches 500 seconds before execution of the image-forming job, but if the rotation time of the developing roller of the second K developing device is 995, then the rotation time of the developing rollers of both developing devices reaches 1,000 or more seconds before completing the image-forming job.

In this case, the process up until the fourth medium-unit job generating process is performed is the same as the case in which the rotation time of the developing roller of one K developing device reaches 1,000 or more seconds as described above, but the process thereafter differs. In other words, the process is the same up until the medium-unit job generating process (S755) for the fourth page in FIG. 14. Therefore, a description is given of what follows the monochrome one-page printing process/operation for the third page (S760).

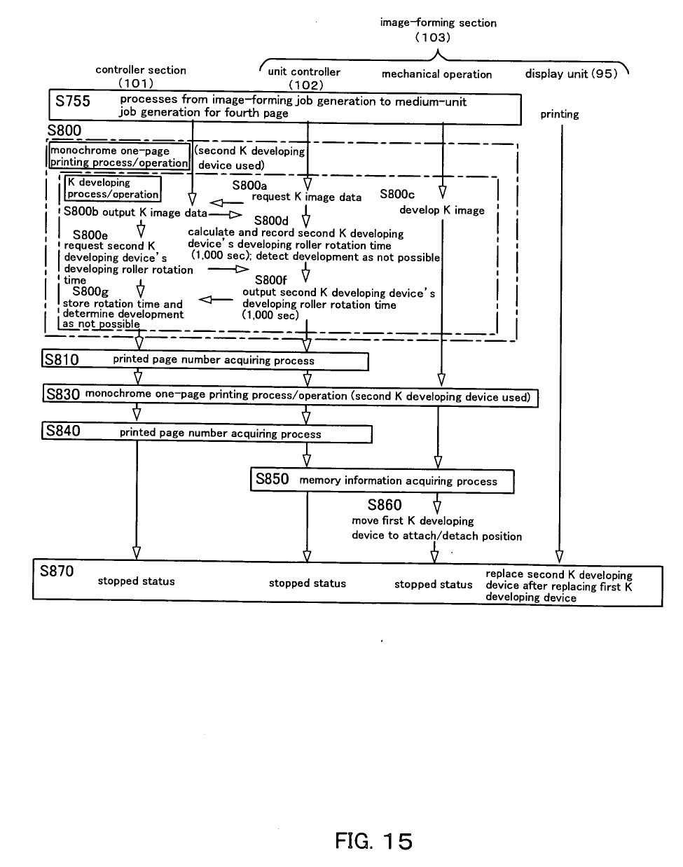

FIG. 15 is a view explaining processes and operations of the printer 10 when the rotation time of a developing roller of all the attached K developing devices rises 1,000 or more seconds when the printer 10 is being used as a monochrome printer.

The unit controller 102 executes the monochrome one-page printing process/operation for the third page, based on the third medium-unit job (S800). That is, the unit controller 102 outputs a request to the controller section 101 requesting the K image data (S800a). Upon receiving this request, the controller section 101 outputs the K image data to the unit controller 102 (S800b). The unit controller 102 executes the developing process (S800c). The unit controller 102 adds 5 to the rotation time of the developing roller of the second K developing device 51 stored in the apparatus-side memory 122, calculates the rotation time of the developing roller after development (the cumulative rotation time), and rewrites the information in the apparatus-side memory 122 (S800d). At this time, the calculated rotation time of the developing roller on the second K developing device 51 reaches 1,000 seconds, and the unit controller 102 detects that the rotation time of the developing roller on the second K developing device 51 is 1,000 or more seconds.

The controller section 101 outputs to the unit controller 102 in a suitable timing an information request requesting information indicating the rotation time of the developing roller on the second K developing device 51 after development due to the medium-unit job (S800e). The unit controller 102 outputs to the controller section 101 information indicating rotation time of the developing roller on the second K developing device 51 stored in the apparatus-side memory 122 (S800g). The controller section 101 rewrites the information in the EEPROM 114a based on the acquired information indicating the rotation time of the developing roller on the second K developing device 51 (S800g). At this time, the acquired rotation time of the developing roller on the second K developing device 51 is 1,000 seconds, and the controller section 101 detects that the rotation time of the developing roller on the second K developing device 51 is 1,000 or more seconds, and determines that the second K developing device 51 is in a state in which development cannot be performed. The controller section 101 thereafter stops the process for outputting one-page printing requests. The unit controller 102 continues the developing operation of the K image and stops the monochrome one-page printing process/operation for the second medium-unit job.

When the monochrome one-page printing process/operation for the third page is finished, a printed page number acquiring process is executed (S810). At this point, four medium-unit jobs have been generated, and the developing operation based on the three medium-unit jobs has finished. The printer 10 executes the monochrome one-page printing process/operation for the fourth page based on the remaining one medium-unit job (S830).

When the monochrome one-page printing process/operation for the fourth page is finished, a printed page number acquiring process is executed (S840). As a result of printed page number acquiring process, the controller section 101 detects that the printing based on the four medium-unit jobs already generated has finished.

The unit controller 102 executes a memory information acquiring process (S850) and stores in the developing-device-side memory of the two developing devices information such as information indicating the rotation time of the developing roller in the two developing devices stored in the apparatus-side memory 122. Furthermore, the developing device retaining unit 50 is rotated, thereby moving the first K developing device 51, with which developing can no longer be performed, to the developing device attach/detach position (S860). The controller 101 displays “Replace the first developing device and then replace the second developing device,” for example, to the display unit 95, announces to the user etc. of the event, and stops operation of the printer 10 (S870).

### <First Characteristic of the Printer According to the First Embodiment>

With the printer 10 of the first embodiment, any developing device which has entered a state in which development cannot be performed is moved to the developing device attach/detach section when a one-page printing process/operation is completed which is based on a medium-unit job already generated at that point, in the case in which any of the attached developing devices enters a state in which development cannot be performed when the printer 10 is being used as a color printer. On the other hand, even if any of the attached developing devices enters a state in which development cannot be performed when the printer 10 is being used as a monochrome printer, printer processes/operations using other developing devices are continued, and when the image-forming job is complete or when all of the attached developing devices enter a state in which development cannot be performed, the developing devices which have entered a state in which development cannot be performed are moved to the developing device attach/detach position.

In other words, when the printer 10 is being used as a color printer, toner of differing colors is contained in the various attached developing devices, so there exists a risk that a favorable image may not be able to be printed, if development becomes impossible with even only one of the developing devices. For this reason, when the printer 10 is being used as a color printer, if development becomes impossible with any of the developing devices, the developing device with which development can no longer be performed is moved to the developing device attach/detach position after completing the one-page printing process/operation based on the generated medium-unit job. Thus, when development can no longer be performed with one of the developing devices, the printing processes/operations are not continued until the image-forming job is complete, so no unfavorable images are printed, making it possible to prevent wasting toner and paper. Accordingly, when the printer 10 is being used as a color printer, if development becomes impossible with any of the developing devices, the suitable timing for moving the developing device with which development can no longer be performed to the developing device attach/detach position is after completing the one-page printing process/operation based on the generated medium-unit job.

On the other hand, when the printer 10 is being used as a monochrome printer, a plurality of developing devices is attached which contain toner of the same color, so even if development becomes impossible with one of the attached developing devices, it is still possible to continue the printing processes/operations using the other developing devices. Therefore, if development becomes impossible with a certain developing device, another developing device is moved to the developing position and the printing processes/operations are continued, as with the monochrome printer of the first embodiment above, making it possible to continue the printing processes/operations and complete the image-forming job. In other words, even if development becomes impossible with one of the attached developing devices, the image-forming job is not interrupted, so throughput can be improved. Furthermore, when development can no longer be performed with one of the attached developing devices, the printing processes/operations are not continued until the image-forming job is complete, so no unfavorable images are printed, making it possible to prevent wasting toner and paper. Accordingly, when the color printer 10 is being used as a monochrome printer, the suitable timing for moving the developing device with which development can no longer be performed to the developing device attach/detach position is after continuing the printing processes/operations and completing the image-forming job by moving another developing device, different from the developing device with which development can no longer be performed, to the developing device attach/detach position.

As described above, when one of the developing devices has entered a state in which development can no longer be performed, it becomes possible to realize a printer that is highly convenient for the user by differentiating the timing for moving the developing device with which development can no longer be performed when the printer 10 is being used as a color printer on the one hand and when the printer 10 is being used as a monochrome printer on the other, regardless of whether the printer 10 is being used as a color printer or as a monochrome printer.

Furthermore, whether the printer 10 is being used as a color printer or as monochrome printer, the one-page printing process/operation based on a medium-unit job already generated at the point when development becomes impossible with one of the developing devices is executed, so printing processes and operations are not interrupted in the middle of a medium-unit job. Therefore, after a developing device has been replaced, printing is restarted by generating a new medium-unit job, making it possible to prevent generation of pages which are not printed, overlapping printing of the same page, and so on, making control of the printer easier.

### <Second Characteristic of the Printer According to the First Embodiment>

With the printer 10 of the first embodiment, when the printer 10 is being used as a color printer, if any of the attached developing devices enters a state in which development cannot be performed, it is announced that the predetermined developing device has entered a state in which development cannot be performed, once a one-page printing process/operation is completed which is based on a medium-unit job already generated at that point. On the other hand, even if any of the attached developing devices enters a state in which development cannot be performed when the printer 10 is being used as a monochrome printer, printer processes/operations using other developing devices are continued, and when the image-forming job is complete or when all of the attached developing devices enter a state in which development cannot be performed, it is announced that the predetermined developing device has entered a state in which development cannot be performed.

In other words, when the printer 10 is being used as a color printer, toner of differing colors is contained in the various attached developing devices, so there exists a risk that a favorable image may not be able to be printed, if development becomes impossible with even only one of the developing devices. For this reason, when the printer 10 is being used as a color printer, if development becomes impossible with any of the developing devices, it is announced that the predetermined developing device has entered a state in which development can no longer be performed, after completing the one-page printing process/operation based on the generated medium-unit job. In this way, in the case in which development cannot be performed with one of the developing devices, it is announced that development cannot be performed with the predetermined developing device, without continuing the printing processes/operations until the image-forming job is complete. Therefore, since the one-page printing process/operation is not continued with the developing device with which development cannot be performed still attached, waste of toner and paper can be prevented, since unfavorable images are not printed. Accordingly, when the printer 10 is being used as a color printer, if development becomes impossible with any of the developing devices, the suitable timing for announcing that development can no longer be performed with the predetermined developing device is after completing the one-page printing process/operation based on the generated medium-unit job.

On the other hand, when the printer 10 is being used as a monochrome printer, a plurality of developing devices is attached which contain toner of the same color, so even if development becomes impossible with one of the attached developing devices, it is still possible to continue the printing processes/operations using the other developing devices. Therefore, if development becomes impossible with a certain developing device, another developing device is moved to the developing position and the printing processes/operations are continued, as with the monochrome printer of the embodiment above, making it possible to continue the printing processes/operations and complete the image-forming job. In other words, even if development becomes impossible with one of the attached developing devices, the image-forming job is not interrupted, so throughput can be improved. Furthermore, when development can no longer be performed with one of the attached developing devices, the printing processes/operations are not continued until the image-forming job is complete, so no unfavorable images are printed, making it possible to prevent wasting toner and paper. Accordingly, when the color printer 10 is being used as a monochrome printer, the suitable timing for announcing that development can no longer be performed with the predetermined developing device is after continuing the printing processes/operations and completing the image-forming job by moving another developing device, different from the developing device with which development can no longer be performed, to the developing device attach/detach position.

As described above, when one of the developing devices has entered a state in which development can no longer be performed, it becomes possible to realize a printer that is highly convenient for the user by differentiating the timings for moving the developing device with which development can no longer be performed when the printer 10 is being used as a color printer on the one hand and when the printer 10 is being used as a monochrome printer on the other, regardless of whether the printer 10 is being used as a color printer or as a monochrome printer.

Furthermore, whether the printer 10 is being used as a color printer or as monochrome printer, the one-page printing process/operation based on a medium-unit job already generated at the point when development becomes impossible with one of the developing devices is executed, so printing processes and operations are not interrupted in the middle of a medium-unit job. Therefore, after a developing device has been replaced, printing is restarted by generating a new medium-unit job, making it possible to prevent generation of pages which are not printed, overlapping printing of the same page, and so on, making control of the printer easier. Furthermore, until the one-page printing process/operation is complete, the user etc. cannot find out that a developing device with which development cannot be performed has arisen, and therefore cannot accidentally remove the developing unit and cannot stop the image-forming operation in the middle. In other words, since the image-forming operation is not interrupted with the image only partially formed based on the generated medium-unit job, it is possible to form an image without wasting developer or the medium used in the image-forming operation only partially executed.

In the first embodiment, an example was described in which an event in a developing device enters a state in which development cannot be performed was announced to the display unit 95 provided to the printer 10, but this may also be displayed to a computer or the like connected to the printer 10.

### <Third Characteristic of the Printer According to the First Embodiment>

With the printer 10 of the first embodiment, any developing device which has entered a state in which development cannot be performed is moved to the developing device attach/detach section when a one-page printing process/operation is completed which is based on a medium-unit job already generated at that point, in the case in which any of the attached developing devices enter a state in which development cannot be performed when the printer 10 is being used as a color printer. On the other hand, even if any of the attached developing devices enters a state in which development cannot be performed when the printer 10 is being used as a monochrome printer, printer processes/operations using other developing devices are continued, and when the image-forming job is complete or when all of the attached developing devices enter a state in which development cannot be performed, the developing devices which have entered a state in which development cannot be performed are moved to the developing device attach/detach position.

In other words, when the printer 10 is being used as a color printer, toner of differing colors is contained in the various attached developing devices, so there exists a risk that a favorable image may not be able to be printed, if development becomes impossible with even only one of the developing devices. For this reason, when the printer 10 is being used as a color printer, if development becomes impossible with any of the developing devices, the developing device with which development can no longer be performed is moved to the developing device attach/detach position after completing the one-page printing process/operation based on the generated medium-unit job. Thus, when development can no longer be performed with one of the developing devices, the printing processes/operations are not continued until the image-forming job is complete, so no unfavorable images are printed, making it possible to prevent wasting toner and paper. Accordingly, when the printer 10 is being used as a color printer, the preferable operation if development becomes impossible with any of the developing devices is an operation to move the developing device with which development can no longer be performed to the developing device attach/detach position after completing the one-page printing process/operation based on the generated medium-unit job.

On the other hand, when the printer 10 is being used as a monochrome printer, a plurality of developing devices is attached which contain toner of the same color, so even if development becomes impossible with one of the attached developing devices, it is still possible to continue the printing processes/operations using the other developing devices. Therefore, if development becomes impossible with a certain developing device, another developing device is moved to the developing position and the printing processes/operations are continued, as with the monochrome printer of the embodiment above, making it possible to continue the printing processes/operations and complete the image-forming job. In other words, even if development becomes impossible with one of the attached developing devices, the image-forming job is not interrupted, so throughput can be improved. Furthermore, when development can no longer be performed with one of the attached developing devices, the printing processes/operations are not continued until the image-forming job is complete, so no unfavorable images are printed, making it possible to prevent wasting toner and paper. Accordingly, the preferable operation when the color printer 10 is being used as a monochrome printer is an operation for moving the developing device with which development can no longer be performed to the developing device attach/detach position after continuing the printing processes/operations and completing the image-forming job by moving another developing device, different from the developing device with which development can no longer be performed, to the developing device attach/detach position.

As described above, when one of the developing devices has entered a state in which development can no longer be performed, it becomes possible to realize a printer that is highly convenient for the user by differentiating the operations for moving the developing device with which development can no longer be performed when the printer 10 is being used as a color printer on the one hand and when the printer 10 is being used as a monochrome printer on the other, regardless of whether the printer 10 is being used as a color printer or as a monochrome printer.

Furthermore, whether the printer 10 is being used as a color printer or as monochrome printer, the one-page printing process/operation based on a medium-unit job already generated at the point when development becomes impossible with one of the developing devices is executed, so printing processes and operations are not interrupted in the middle of a medium-unit job. Therefore, after a developing device has been replaced, printing is restarted by generating a new medium-unit job, making it possible to prevent generation of pages which are not printed, overlapping printing of the same page, and so on, making control of the printer easier.

### <Other Characteristics of the Printer According to the First Embodiment>

In the first embodiment, a case in which a remaining amount of toner becomes equal to or below a predetermined amount and a case in which a rotation time of a developing roller becomes equal to or longer than a predetermined time were described as examples of a state in which development cannot be performed with a developing device, but it is also possible to move the developing device with which development can no longer be performed to the developing position or announce the event after an image is formed based on a medium-unit job already generated when either of those two cases arises.

In the first embodiment, the rotation time of a developing roller was calculated using the amount of time the roller rotated, but it is also possible to count the number of rotations of the developing roller or the number of sheets printed and to convert the counted results to the rotation time of the developing roller.

Further, in the first embodiment, an example was described in which two developing devices are attached to the developing device retaining unit 50 in the case in which the printer 10 is used as a monochrome printer, but it is also possible for developing devices containing toner of the same color to be attached to at least two of the attach/detach sections. If, for example, three or four developing devices are attached, printing can be performed without changing any developing device for even longer periods of time.

Whether the printer 10 is being used as a color printer or as a monochrome printer, the developing device with development can no longer be performed is moved to the attach/detach position, so the developing device can easily be replaced without the user having to check, move, or otherwise engage in any bothersome operations regarding the developing device which can no longer perform development.

### ===Other Examples According to First Embodiment===

An image forming apparatus, for example, according to the present invention in the first embodiment is described above, but the foregoing embodiment of the invention is for the purpose of elucidating the present invention and is not to be interpreted as limiting the present invention. The invention can of course be altered and improved without departing from the gist thereof and includes functional equivalents.

In the first embodiment, an intermediate image transfer type laser beam printer was described as an example of the image forming apparatus, but the present invention can also be adopted for various other types of image forming apparatuses, such as laser beam printers that are not of the intermediate image transfer type, copying machines, and facsimiles.

Furthermore, in the first embodiment, a description was given using as an example an image forming apparatus provided with rotary-type developing apparatuses, but the present invention may, without being limited to this, be adopted for image forming apparatuses provided with tandem-type developing apparatuses.

Furthermore, in the first embodiment, communication was performed between the developing-device-side memory and the apparatus body by abutting the apparatus-side connectors against the developing-device-side connectors, but without being limited to this, the communication may be performed, for example, without causing a developing device-side member to come in contact with an apparatus-side member.

The photoconductor, too, may not be limited to a so-called photodetection roller, configured by providing a photosensitive layer to an outer circumference surface on a cylindrical conductive material, but may be configured by providing a photosensitive layer to an outer circumference surface on a belt-type conductive material.

Furthermore, in the first embodiment, an example was described in which the K developing devices are attached when the printer 10 is being used as a monochrome printer, but the attached developing devices are not limited to the K developing devices as long as they are developing devices that contain toner of the same color.

### <Configuration of Image Forming System>

An image forming system serving as an example of the first embodiment of the present invention is described with reference to the drawings.

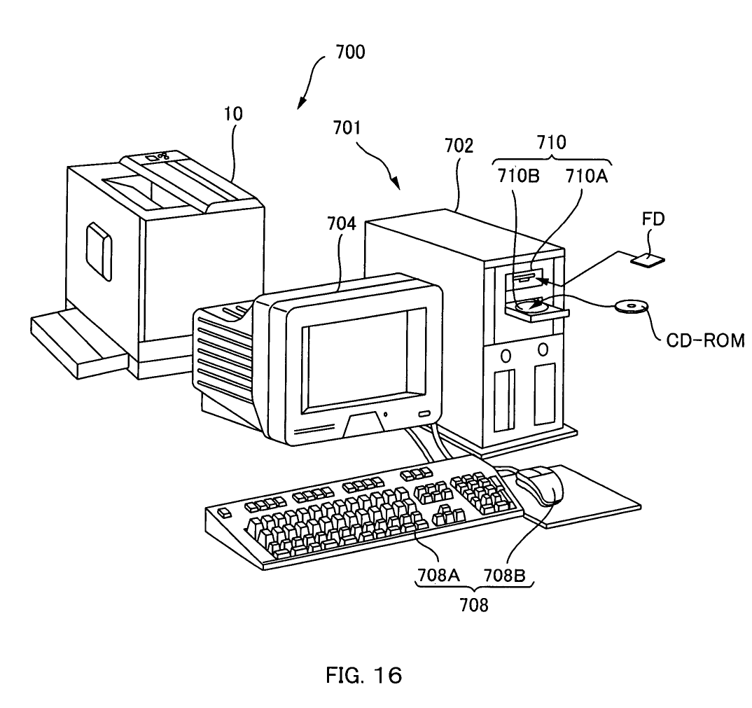

FIG. 16 is an explanatory drawing showing the external configuration of an image forming system. An image forming system 700 is made up of a computer 701 and a laser-beam printer (hereafter also referred to as a printer) 10, acting as an image forming apparatus, being connected to allow two-way communication therebetween.

The computer 701 is provided with a main computer unit 702, a display device 704 as a displaying section, an input device 708, and a reading device 710. In this example, the main computer unit 702 is accommodated within a mini-tower type housing; however, this is not a limitation. A CRT (cathode ray tube), plasma display, or liquid crystal display device, for example, is generally used as the display device 704, but this is not a limitation. In this embodiment, the input device 708 is a keyboard 708A and a mouse 708B, but there is no limitation to these. In this embodiment, a flexible disk drive device 710a and a CD-ROM drive device 710B are used as the reading device 710, but there is no limitation to these, and the reading device 710 may also be a MO (magnet optical) disk drive device or a DVD (digital versatile disk), for example.

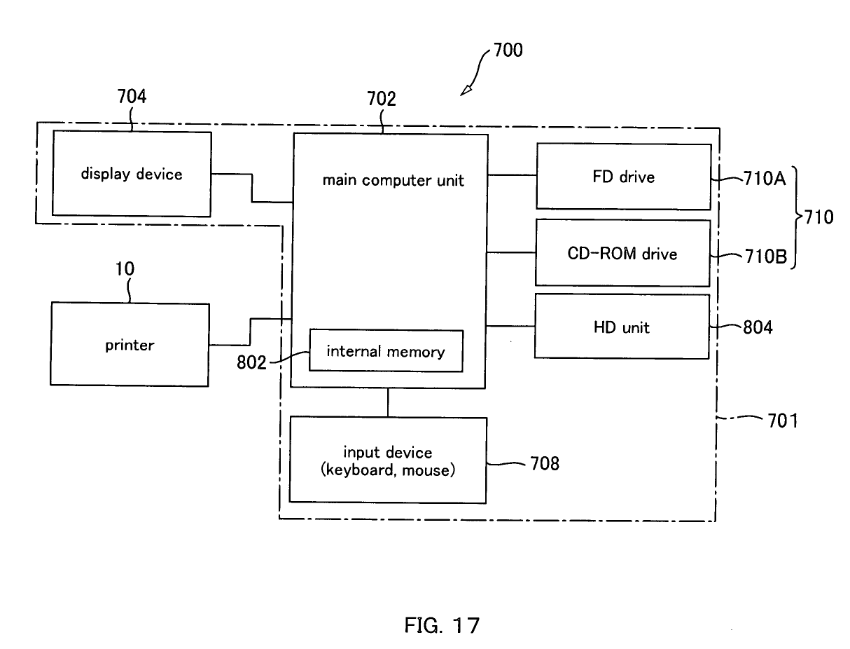

FIG. 17 is a block diagram showing the configuration of the image forming system shown in FIG. 16. An internal memory 802 such as a RAM is provided within the housing accommodating the main computer unit 702, and also an external memory such as a hard disk drive unit 804 are provided.

In the above description, an example was described in which the computer 701 is provided with the main computer unit 702, the display device 704, the input device 708, and the reading device 710; however, this is not a limitation. For example, the computer 701 may be provided with either the input device 708 or the reading device 710, or configured with the main computer body 702 and the display device 704, in which a touch panel is provided to the screen.

### SECOND EMBODIMENT

### ===Overall Configuration Example of Image Forming Apparatus===

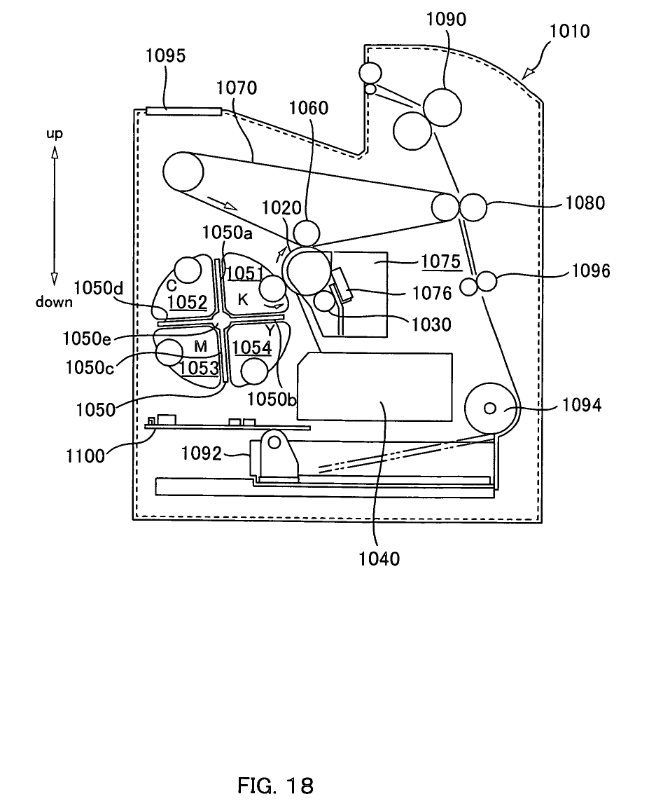

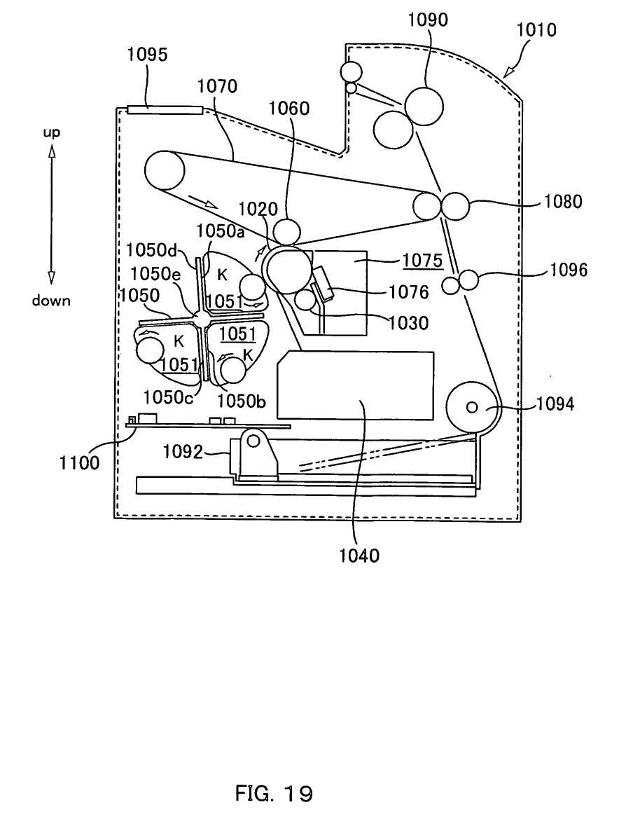

Next, using FIG. 18 and FIG. 19, an overview of a printer 1010 as an example of the image forming apparatus according to a second embodiment is described. FIG. 18 and FIG. 19 are views showing major component elements making up the printer 1010, FIG. 18 being a view showing the major component elements when the printer 1010 is used as a color printer, and FIG. 19 being a view showing the major component elements when the printer 1010 is used as a monochrome printer. Also, the up and down directions are shown by an arrow in FIG. 18 and FIG. 19, a paper supply tray 1092 being disposed at a lower portion of the printer 1010 and a fixing unit 1090 being disposed at an upper portion of the printer 1010, for example.

As shown in FIG. 18 and FIG. 19, the printer 1010 is provided with a charging unit 1030, an exposing unit 1040, a developing device retaining unit 1050, a primary transferring unit 1060, an intermediate transferring body 1070, and a cleaning unit 1075 along a rotation direction of a photoconductor 1020 as an image bearing member for bearing images, and is further provided with a second transferring unit 1080, a fixing unit 1090, a display unit 1095 made up of a liquid crystal panel, as a displaying section to a user etc., and a control unit 1100 for controlling the whole printer 1010.

The photoconductor 1020 is provided with a cylindrical conductive substrate and a photoreceptive layer formed on the outer circumference surface of this substrate, and can rotate about a central axis, and in the present embodiment, rotates in the clockwise direction as shown by arrows in FIG. 18 and FIG. 19.

The charging unit 1030 is a device for charging the photoconductor 1020, and the exposing unit 1040 is a device for forming a latent image on the charged photoconductor 1020 by irradiating a laser. The exposing unit 1040 is provided with, for example, a semiconductor laser, a polygon mirror, and an F-θ lens, and irradiates a modulated laser onto the charged photoconductor 1020 based on image information input from an external computer (not shown).

The developing device retaining unit 1050 is provided with a plurality of attach/detach sections 1050a, 1050b, 1050c, and 1050d to and from which the developing devices, which serve as developing units for containing developer and developing latent images formed on the photoconductor 1020, can be attached and detached. The latent images formed on the photoconductor 1020 are developed using a toner T as an example of a developer contained in the developing devices attached to these attach/detach sections.

Incidentally, the printer 1010 according to the present embodiment can be used as a color printer (color image forming apparatus) for forming color images by developing the latent images borne on the photoconductor 1020 using the toner T contained in the developing devices, in a state where the developing devices are attached to the plurality of attach/detach sections 1050a, 1050b, 1050c, and 1050d. Furthermore, the printer 1010 can be used as a monochrome printer (monochrome image forming apparatus) for forming monochrome images by developing the latent images borne by the photoconductor 1020 using a toner T contained in the developing devices, in a state where developing devices containing toner T of the same color are attached to at least two of the plurality of attach/detach sections 1050a, 1050b, 1050c, and 1050d.

In the case in which the printer 1010 is used as a color printer, as shown in FIG. 18, four developing devices—black developing device 1051, magenta developing device 1053, cyan developing device 1052, and yellow developing device 1054—are attached to the four attach/detach sections 1050a, 1050b, 1050c, and 1050d of the developing device retaining unit 1050. The latent images formed on the photoconductor 1020 are developed by the toner T contained in the developing devices 1051, 1052, 1053, and 1054.

By rotating in one direction, the developing device retaining unit 1050 can move the four developing devices 1051, 1052, 1053, and 1054. In other words, the developing device retaining unit 1050 is rotatably disposed around a rotating shaft 1050e, and the four attach/detach sections are disposed in a manner surrounding the rotating shaft 1050e. When the developing device retaining unit 1050 rotates around the rotating shaft 1050e with the four developing devices 1051, 1052, 1053, and 1054 attached to the attach/detach sections, the four attached developing devices 1051, 1052, 1053, and 1054 are moved, maintaining their relative positions to each other. The developing devices 1051, 1052, 1053, and 1054 are moved to a position opposite the photoconductor 1020 when developing the latent images formed on the photoconductor 1020 using the toner T contained in the developing devices 1051, 1052, 1053, and 1054. When one page's worth of latent images has been developed using a certain developing device, the developing device retaining unit 1050 rotates 90°, sequentially moving the adjacent developing device to the position opposite the photoconductor 1020.

On the other hand, as shown in FIG. 19, in the case in which the printer 1010 is being used as a monochrome printer, developing devices containing toner of the same color are attached to at least two of the plurality of attach/detach sections on the developing device retaining unit 1050. The latent images formed on the photoconductor 1020 are developed by the toner T of the same color contained in the attached developing devices 1051, 1052, 1053, and 1054. According to the present embodiment, the black developing devices 1051 are attached to the three attach/detach sections 1050a, 1050b, and 1050c of the four attach/detach sections 1050a, 1050b, 1050c, and 1050d. By rotating the developing device retaining unit 1050, one of the three attached black developing devices 51 is moved to the position opposite the photoconductor 1020. The latent images formed on the photoconductor 1020 are developed by the black toner T contained in the developing device moved to the position opposite the photoconductor 1020, by suitably moving the position of the three attached black developing devices 1051. The developing devices are described in greater detail below.

The primary transferring unit 1060 is a device for transferring a toner image formed on the photoconductor 1020 to the intermediate transferring body 1070.

The intermediate transferring body 1070 is an endless belt formed of layers of semiconductive coating material on a surface layer of an aluminum evaporation layer on the surface of a polyethylene terephthalate (PET) film, and is rotationally driven at approximately the same speed as the photoconductor 1020.

The second transferring unit 1080 is a device for transferring a toner image formed on the intermediate transferring body 1070 to a medium such as paper, film, or cloth.

The fixing unit 1090 is a device for fusing to the medium the toner image transferred onto the medium, and making the fused image permanent.

The cleaning unit 1075 is disposed between the primary transferring unit 1060 and the charging unit 1030, and is provided with a cleaning blade 1076 made of rubber and abutting the surface of the photoconductor 1020. The cleaning unit 1075 uses the cleaning blade 1076 to wipe away and thereby remove any toner T remaining on the photoreceptor 1020, after the toner image has been transferred to the intermediate transferring body 1070 by the primary transferring unit 1060.

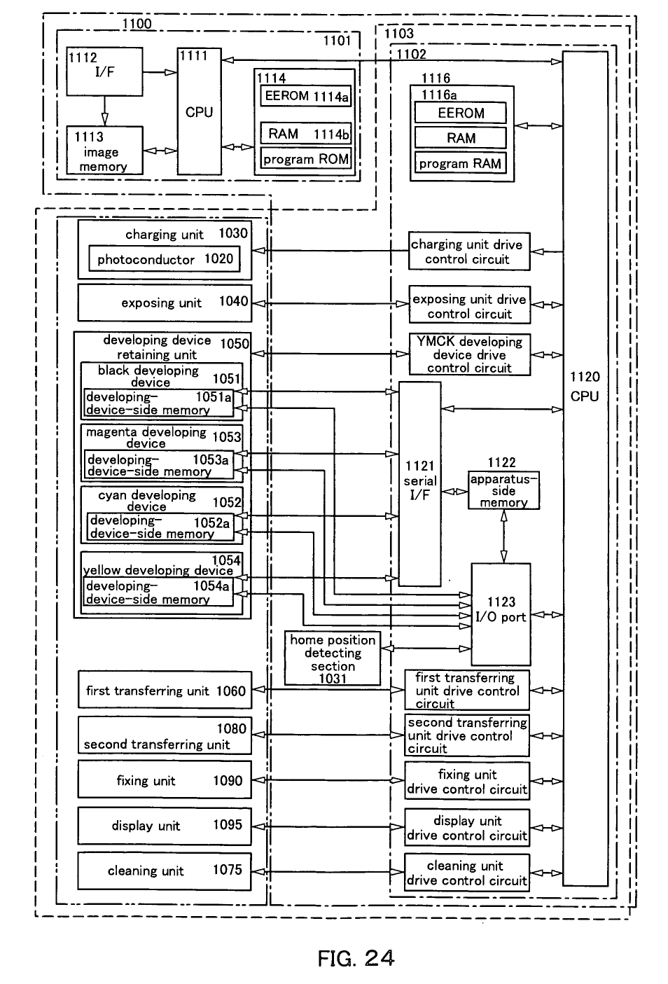

The control unit 1100 is provided with a controller section 1101 and a unit controller 1102 (FIG. 24). The controller section 1101 communicates with the external computer, and the unit controller 1102 forms images by controlling the various units. The controller section 1101 and the unit controller 1102 are connected via an interface. The controller section 1101 is equivalent to a “controller,” the various units and the unit controller, described above, are equivalent to an “image-forming section” 1103.

### ===Configuration Example of Developing Device===

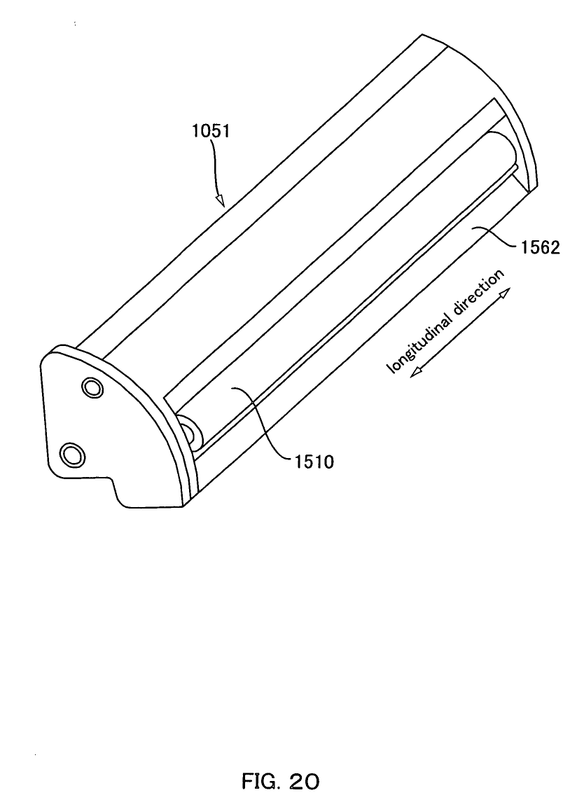

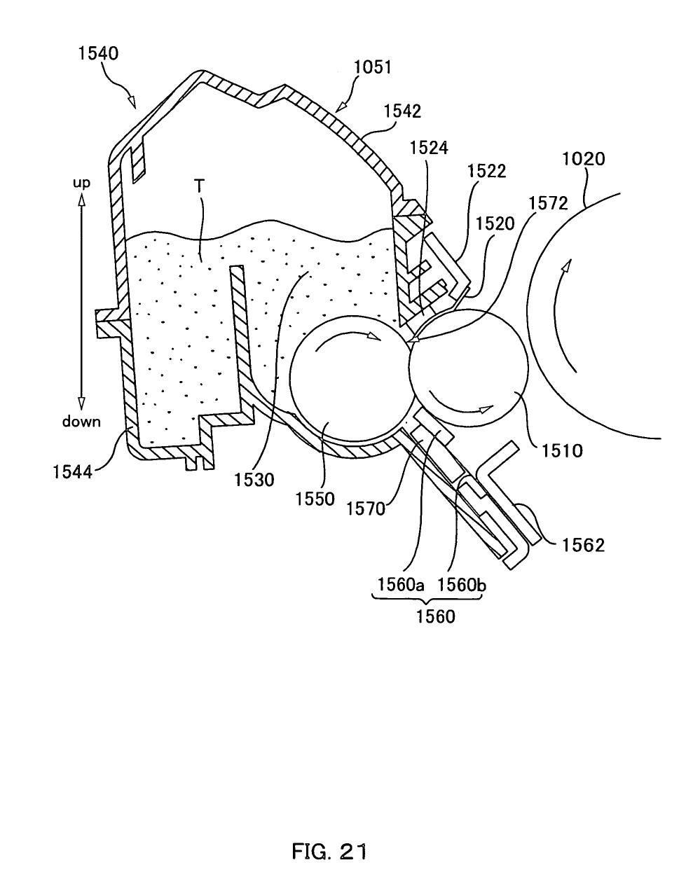

Next, a configuration example of the developing devices is described using FIG. 20 and FIG. 21. FIG. 20 is a conceptual diagram of the developing device, and FIG. 21 is a cross-sectional view showing the major component elements of the developing device. The cross-sectional view shown in FIG. 21 shows a cross-section cutting the developing device lengthwise along a vertical surface shown in FIG. 20. In FIG. 21, as in FIG. 18, the up and down directions are shown by an arrow, and a state is shown in which the black developing device 1051 is located at a developing position opposite the photoconductor 1020.

The black developing device 1051 which contains black (K) toner, the magenta developing device 1053 which contains magenta (M) toner, the cyan developing device 1052 which contains cyan (C) toner, and the yellow developing device 1054 which contains yellow (Y) toner can be attached to the developing device retaining unit 1050, but since the configuration of each developing device is the same, a description will be given of only the black developing device 1051.

The black developing device 1051 is provided with a developing roller 1510 as an image-bearing roller, a seal member 1520, a toner containing section 1530, a housing 1540, a toner supplying roller 1550, a regulating blade 1560, and so on.

The developing roller 1510 bears the toner T and moves the toner T to a developing position opposite the photoconductor 1020. As shown in FIG. 20, the developing roller 1510 is supported lengthwise on both side portions and is rotatable around a central shaft. As shown in FIG. 21, the developing roller 1510 rotates in a direction (counter-clockwise in FIG. 21) which is opposite to the direction of rotation of the photoconductor 1020 (clockwise in FIG. 21). As shown in FIG. 21, the developing roller 1510 of the black developing device 1051 and the photoconductor 1020 are opposed across an interval. That is, the black developing device 1051 develops the latent image formed on the photoconductor 1020 without being in contact therewith. It should be noted that when developing the latent image formed on the photoconductor 1020, an alternating electric field is formed between the developing roller 1510 and the photoconductor 1020.

The seal member 1520 prevents the toner T in the black developing device 1051 from leaking outside the device, and also collects the toner T on the developing roller 1510, after the developing roller 510 has passed the developing position, into the developing device without wiping it away. The seal member 1520 is a seal made of polyethylene film or the like, and is pushed against the developing roller 1510 by the elastic force of the seal-urging member 1524 which is disposed opposite the developing roller 1510 and is made of Moltoprene, etc.

The housing 1540 is formed by adhering a plurality of cast housing portions. As shown in FIG. 21, the housing 1540 is provided with an opening 1572 which connects to the exterior of the housing 1540, and the developing roller 1510, described above, is disposed in a state partially exposed, with its circumference surface facing the opening 1572 from the outside of the housing 1540. The regulating blade 1560, which is described below, is also disposed in a state partially facing the opening 1572 from the outside of the housing 1540.

The housing 1540 forms a toner containing section 1530 capable of containing the toner T.

The toner supplying roller 1550 is disposed on the toner containing section 1530, described above, and supplies the toner T contained in the toner containing section 1530 to the developing roller 1510. The toner supplying roller 1550 is made of polyurethane foam, for example, and abuts the developing roller 1510 in a state of elastic deformation. The toner supplying roller 1550 is disposed on the lower portion of the toner containing section 1530, while the toner T contained in the toner containing section 1530 is supplied to the developing roller 1510 by the toner supplying roller 1550 at the bottom portion of the toner containing section 1530. The toner supplying roller 1550 rotates in a direction (in FIG. 21, the clockwise direction) that is opposite the direction of rotation of the developing roller 1510 (in FIG. 21, the counterclockwise direction), around a central shaft. It should be noted that the toner supplying roller 1550 has the function of supplying the toner T that is contained in the toner containing section 1530 to the developing roller 1510 as well as the function of wiping away from the developing roller 1510 toner T that remains on the developing roller 1510 after developing.

The regulating blade 1560 regulates the thickness of the toner T layer borne by the developing roller 1510, and adds a charge to the toner T borne by the developing roller 1510. The regulating blade 1560 is provided with a rubber section 1560a and a rubber-supporting section 1560b. The rubber section 1560a is made of silicon rubber or urethane rubber, for example, and the rubber-supporting section 1560b is a thin plate of phosphor bronze or stainless steel, for example, and has spring properties. The rubber section 1560a is supported by the rubber section 1560b, and the rubber-supporting section 1560b is attached to the housing 1540 via a blade-supporting metal plate 1562, with one end portion supported by being sandwiched between a pair of blade-supporting metal plates 1562. A blade-backing member 1570, made of Moltoprene or the like, is disposed on the opposite side of the developing roller 1510 on the regulating blade 1560.

Here, the rubber section 1560a is pushed against the developing roller 1510 by the elastic force created by the flexure of the rubber-supporting section 1560b. The blade-backing member 1570 prevents the toner T from entering in between the rubber supporting section 1560b and the housing 1560, stabilizing the elastic force created by the flexure of the rubber supporting section 1560b, and, by biasing the rubber section 1560a toward the developing roller 1540 from directly behind the rubber section 1560a, pushes the rubber section 1560a against the developing roller 1510. Accordingly, the blade-backing member 1570 improves the uniform abutting property of the rubber section 1560a against the developing roller 1510.

In the black developing device 1051 thus configured, the toner supplying roller 1550 supplies the toner T contained in the toner containing section 1530 to the developing roller 1510. The toner T that is supplied to the developing roller 1510 is brought to the abutting position of the regulating blade 1560 as the developing roller 1510 rotates, and when the toner T passes the abutting position, the thickness of its layer is regulated, and a charge is added. The toner T on the developing roller 1510, whose layer thickness has been regulated, is brought to the developing position opposite the photoconductor 1020 by further rotation of the developing roller 1510, and is supplied for developing the latent image formed on the photoconductor 1020 in an alternating electric field at the developing position. The toner T on the developing roller 1510 that has passed the developing position by further rotation of the developing roller 1510 passes the seal member 1520 and is collected in the developing device without being wiped away by the seal member 1520.

The developing devices 1051, 1052, 1053, and 1054 are provided with memory storing elements for storing information related to color information of the toner contained in the developing devices, the amount of toner remaining, the rotation time of the developing roller 1510, and so on, such as serial EEPROM or other types of non-volatile storage memory (hereafter also referred to as developing-device-side memory) 1051a, 1052a, 1053a, and 1054a.

This developing-device-side memory 1051a, 1052a, 1053a, and 1054a is connected electrically to the main-body controller section 1102 and the unit controller 1102 when developing-device-side connectors 1051b, 1052b, 1053b, and 1054b disposed on one end surface of the developing device abut an apparatus-side connector 1034 disposed on the apparatus (printer) body when needed.

### ===Overview of Developing Device Retaining Unit===

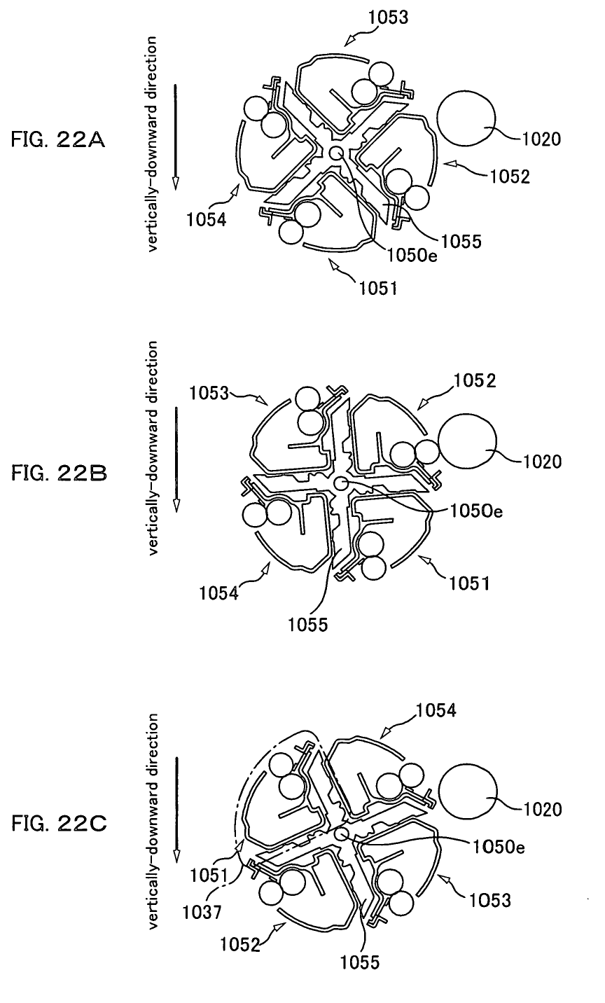

An overview of the developing device retaining unit 1050 is described next, with reference to FIG. 22A through FIG. 22C. Note also that in this section, for convenience's sake, a description is given of an example of a case in which the developing devices 1051, 1052, 1053, and 1054 are attached to the four attach/detach sections 1050a, 1050b, 1050c, and 1050d, but the description is also applicable to a case in which the developing devices containing developer of the same color are attached to at least two of the four attach/detach sections 1050a, 1050b, 1050c, and 1050d.

The developing device retaining unit 1050 is provided with a rotating shaft 1050e located in the center thereof. A supporting frame 1055 for holding the developing devices is fixed to the rotating shaft 1050e. The rotating shaft 1050e is provided across two frame-side plates (not shown) which form the body of the printer 1010, supported at each end. The shaft direction of the rotating shaft 1050e intersects with the vertical direction.

The supporting frame 1055 is outwardly provided at 90° intervals with the four attach/detach sections 1050a, 1050b, 1050c, and 1050d to which are removably attached the developing devices 1051, 1052, 1053, and 1054 of four different colors described above around the rotating shaft 1050e.

A pulse motor (not shown) is attached to the rotating shaft 1050e. Driving the pulse motor rotates the supporting frame 1055, thereby enabling positioning of the developing devices 1051, 1052, 1053, and 1054.

FIG. 22A through FIG. 22C show three stopped positions of the rotating developing device retaining unit 1050. FIG. 22A shows the standby position when waiting for execution of image formation, which is also the “home position,” or the stopped position which acts as the reference position for the rotation direction of the developing device retaining unit 1050. FIG. 22B shows the connector attach/detach position where the developing-device-side connector 1051b on the black developing device 1051 attached to the developing device retaining unit 1050 is attached opposite the apparatus-side connector 1034, which is provided to the apparatus body side. FIG. 22C shows the attach/detach position of the black developing device 1051.

In FIG. 22B and FIG. 22C, the connector attach/detach position and the developing device attach/detach position are shown for the black developing device 1051, but the positions achieved by rotating the developing device retaining unit 1050 90° at a time are the connector attach/detach positions and developing device attach/detach positions for each developing device.

First, the home position shown in FIG. 22A is described. A home position detecting section 1031 (FIG. 24) is provided to one end of the rotating shaft 1050e on the developing device retaining unit 1050 for detecting the home position. The home position detecting section 1031 is made up of a disc for generating signals which is fixed to one end of the rotating shaft 1050e, a home position sensor provided with a photo interrupter made up of a light-emitting portion and a light-receiving portion, and so on. The surrounding edge portion of the disc is disposed in a manner positioned between the light-emitting portion and the light-receiving portion of the home position sensor, and when a slit portion formed in the disc moves into a detecting position of the home position sensor, the output signal from the home position sensor changes from low to high. The home position of the developing device retaining unit 1050 is detected based on this change in the signal level and the number of pulses from the pulse motor. The apparatus is configured to enable positioning the developing and other positions of each developing device using this home position as a reference.

FIG. 22B is the connector attach/detach position of the black developing device 1051 attached to the attach/detach position 1050a after the pulse motor has been rotated a predetermined number of pulses from the home position. At this connector attach/detach position, the developing-device-side connector 1051b on the black developing device 1051 attached to the developing device retaining unit 1050 opposes the apparatus-side connector 1034 provided to the attachment body, thus making it possible to abut or separate the connectors.

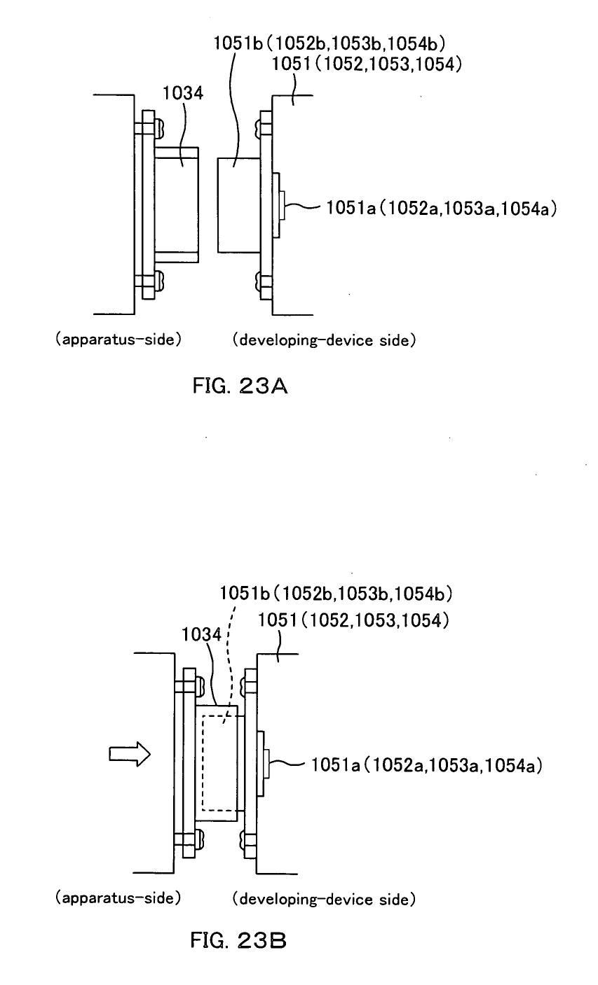

The description is further enlarged, with reference to FIG. 23A and FIG. 23B. FIG. 23A relates to a separated position and FIG. 23B relates to an abutted position.

FIG. 23A shows a state in which the apparatus-side connector 1034 and the developing-device-side connector 1051b on the black developing device 1051 are separated. The apparatus-side connector 1034 is separably and movably configured with respect to the black developing device 1051, and moves as needed in a direction toward the black developing device 1051 as needed (the direction of the arrow shown in FIG. 23B). As shown in FIG. 23B, the apparatus-side connector 1034 thus abuts the developing-device-side connector 1051b on the black developing device 1051, the developing-device-side memory 1051a which is attached to the black developing device 1051 is electrically connected to the unit controller 1102 on the control unit 1100, and communication is performed between the developing-device-side memory 1051a and the apparatus body.

Conversely, the apparatus-side connector 1034 moves in a direction away from the black developing device 1051 (the opposite direction from the direction shown by the arrow in FIG. 23B), from a state shown in FIG. 23B in which the apparatus-side connector 1034 and developing-device-side connector 1051b on the black developing device 1051 are abutting. As shown in FIG. 23A, the apparatus-side connector 1034 thus separates from the developing-device-side connector 1051b on the black developing device 1051.

The movement of the apparatus-side connector 1034 is realized, for example, by a mechanism (not shown) made up of a pulse motor, plurality of gears connected to the pulse motor, and an eccentric cam connector to the gears. In other words, rotating the pulse motor by a predetermined number of pulses causes the mechanism to move the apparatus-side connector 1034 by a distance corresponding to the number of pulses from a predetermined separated position, thus positioning the apparatus-side connector 1034 at a predetermined abutting position. Conversely, rotating the pulse motor in reverse by a predetermined number of pulses causes the mechanism to move the apparatus-side connector 1034 by a distance corresponding to the number of pulses from the predetermined abutting position, thus positioning the apparatus-side connector 1034 at the predetermined separated position.

The connector attach/detach position with respect to the black developing device 1051 is the developing position of the cyan developing device 1052 at which the developing roller 1510 of the cyan developing device 1052 opposes the photoconductor 1020. In other words, The connector attach/detach position of the developing device retaining unit 1050 as relates to the black developing device 1051 is the developing position of the developing device retaining unit 1050 as relates to the cyan developing device 1052. When the pulse motor rotates the developing device retaining unit 1050 90° counter-clockwise, the connector attach/detach position of the yellow developing device 1054 and the developing position of the black developing device 1051 are achieved, while rotating the developing device retaining unit 1050 90° at a time clockwise sequentially achieves the connector attach/detach positions and the developing positions for each developing device.

An attach/detach-dedicated opening 1037 through which one developing device can pass and an interior cover (not shown) which can openably and closably covers the attach/detach-dedicated opening are provided to one of the two frame-side plates which support the developing device retaining unit 1050 and constitute the body of the printer 1010. As shown in FIG. 22C, the attach/detach-dedicated opening 1037 is formed at a position such that when the developing device retaining unit 1050 is rotated and a developing device is stopped at a set developing device attach/detach position, only that developing device (here, the black developing device 1051) can be pulled out and removed in the direction along the rotating shaft 1050e. The attach/detach-dedicated opening 1037 is formed slightly larger than the outer shape of the developing device, so not only can a developing device be removed at the developing device attach/detach position, but a new developing device can also be attached to the supporting frame 1055 by inserting the developing device in a direction along the rotating shaft 1050e through the attach/detach-dedicated opening 1037. While the developing device retaining unit 1050 is positioned anywhere other than the developing device attach/detach position, attachment or removal of the developing device is restricted by the frame-side plates.

A locking mechanism (not shown) is provided for securely fixing the positioning of the developing device retaining unit 1050 at the above position.

### ===Overview of Control Unit===

The configuration of the control unit 1100 is described next with reference to FIG. 24. FIG. 24 is a block diagram showing the control unit 1100 of the printer 1010.

The controller section 1101 is provided with a CPU 1111, an interface 1112 for connecting to a computer (not shown), an image memory 1113 for storing image signals and so on input from the computer, and a controller-section-side memory 1114 which is made up of an electrically rewritable EEPROM 1114a, a RAM 1114b, a program ROM provided with various control programs, and so on. Various types of information such as image signals are sent from the computer, which is connected to the printer 1010, to the controller section 1101.

The controller section 1101 is provided with a function for converting red, green, and blue RGB data sent as an image signal from the computer, for example, into yellow, magenta, cyan, and black YMCK image data, and storing the converted YMCK image data in the image memory 1113. When the printer 1010 is being used as a monochrome printer, the RGB data is converted to black image data and the converted black image data is stored in the image memory 1113. The controller section 1101 is provided with a function for sending various types of information to the connected computer. The controller section 1101 is further provided with a function for counting a number of pixels to be developed when forming toner images of various colors based on the converted YMCK image data, calculating the consumption amount of the toner forecast to be consumed when forming the image based on the YMCK image data, and output this information to the unit controller 1102. In the case in which the printer is being used as a monochrome printer, the forecast consumption amount of toner is calculated by counting the number of pixels to be developed when forming the black toner image based on the converted black image data, and this information is output to the unit controller 1102.

Model information is stored in the EEPROM 1114a as information on the apparatus, indicating whether the printer 1010 is being used as a color printer or as a monochrome printer. A more detailed discussion is provided below, but the CPU 1111 receives from the unit controller 1102 in a predetermined timing attachment information on which of the above-mentioned four attach/detach positions the developing devices are attached to and information on the developing devices, etc. Based on this attachment information, the model information in the EEPROM 1114a is rewritten as needed. The model information is written in the EEPROM 1114a as a single bit of data, a value of 0 indicating that the printer 1010 is being used as a color printer and a value of 1 indicating that the printer 1010 is being used as a monochrome printer. This model information is rewritten in the RAM 1114b information based on the EEPROM 1114a when the power is turned on to the printer 1010.

The information on the developing devices includes the remaining amount of developer contained in each of the developing devices and rotation time of the developing rollers provided to the developing devices, for example. For the remaining amount of developer, a ratio in which the amount of developer contained in the unused developing device is assumed to be 100% is stored in a predetermined region of the EEPROM 1114a. For the number of rotations of the developing rollers, the rotation time from the moment the developing device was started to be used is stored in a predetermined region of the EEPROM 1114a. This information on the developing devices is rewritten when the information stored in the memory is output to the controller section 1102 as a response from the unit controller 1101 to a request output from the controller section 1101.

The unit controller 1102 is, for example, provided with a CPU 1120, a unit-controller-side memory 1116 which is made up of an electrically rewritable EEPROM 1116a, a RAM, a program ROM provided with various control programs, and so on, and drive control circuits for driving various apparatus units (the charging unit 1030, the exposing unit 1040, the first transferring unit 1060, the cleaning unit 1075, the secondary image transferring unit 1080, the fixing unit 1090, and the display unit 1095) and the developing device retaining unit 1050.

The CPU 1120 is connected to a serial EEPROM or other non-volatile storing element (hereafter referred to as the apparatus-side memory) 1122 via a serial interface 1121. The apparatus-side memory 1122 stored data needed for apparatus control. Not only the apparatus-side memory 1122, but also the developing device-side memories 1051a, 1052a, 1053a, and 1054a provided to the developing devices 1051, 1052, 1053, and 1054 are connected to the CPU 1120 via the serial interface 1121, making data transfer between the apparatus-side memory 1122 and the developing-device-side memory 1051a, 1052a, 1053a, and 1054a possible, as well as making input of a chip select signal CS possible to the developing device-side memories 1051a, 1052a, 1053a, and 1054a via an I/O port 1123. The CPU 1120 is also connected to the home position detecting section 1031 via the I/O port 1123.

The CPU 1120 in the unit controller 1102 is electrically connected to the drive control circuits and controls the drive control circuits based on control signals from the CPU 1111 in the controller section 1101. In other words, the unit controller 1102 controls the various units and the developing device retaining unit 1050 based on signals input from the controller section 1101 while detecting the state of the units and the developing device retaining unit 1050 by receiving signals from the sensors and so on provided to each unit.

The CPU 1120 controls the drive control circuits based on the model information described above. That is, when the model information value is 0, the CPU 1111 controls the units and the developing device retaining unit 1050 of the printer 1010 as a color printer, and when the model information value is 1, the CPU 1111 controls the units and the developing device retaining unit 1050 of the printer 1010 as a monochrome printer.

The CPU 1120 can communicate with the developing device-side memories 1051a, 1052a, 1053a, and 1054a when one of the developing device connectors located at the connector attach/detach position is connected to the apparatus-side connector 1034. The CPU 1120 acquires various information on the developing device from the developing device-side memories 1051a, 1052a, 1053a, and 1054a in the developing device connected to the apparatus-side connector 1034. The developing device information includes, for example, attachment information on which of the four attach/detach sections provided to the developing device retaining unit 1050 the developing device is attached, color information on the toner contained in the attached developing device, remaining amount information on the contained toner, rotation time information on the developing roller, and so on, the acquired information being stored in a predetermined region in the apparatus-side memory 1122 in the unit controller 1102 in correspondence with each developing device.

For example, if the printer 10 is being used as a color printer, four developing devices containing developers of four mutually different colors (black developing device 1051, magenta developing device 1053, cyan developing device 1052, and yellow developing device 1054) being attached to the four attach/detach sections, the CPU 1120 detects that these developing devices are attached to the four attach/detach sections by accessing the developing device-side memories of each developing device. A “1” is stored in the predetermined region of the apparatus-side memory 1122 indicating that those developing devices are attached. At this time, the CPU 1120 also acquires information from each developing device, and stores this information to regions in the apparatus-side memory 1122 corresponding to each attach/detach position as binary information indicating the color and the remaining amount of toner contained in the attached developing units and the rotation time of the developing rollers. If, of the four attach/detach sections, developing devices containing black toner are attached to the three attach/detach sections 1050a, 1050b, and 1050c and the printer 1010 is thus being used as a monochrome printer, the CPU 1120 detects that those developing devices are attached to those three attach/detach sections by accessing the developing device-side memories of the three developing devices. The CPU 11120 then stores a 1, indicating that the developing devices are attached, to the predetermined regions in the apparatus-side memory 1122, and stores a 0, indicating that the developing devices are not attached, to the regions corresponding to the other attach/detach sections 1050b and 1050d. At this time, the CPU 1120 also acquires information from each developing device, and stores this information to regions in the apparatus-side memory 1122 corresponding to each attach/detach position as binary information indicating the color (black) and the remaining amount of toner contained in the attached developing devices and the rotation time of the developing rollers.

Then the CPU 1120 detects the information indicating the toner consumption amount output from the controller section 1101, subtracts the toner consumption amount from the remaining amount of toner stored in the apparatus-side memory 1122, and stores to the apparatus-side memory 1122 the calculated remaining amount of toner. The CPU 1120 is provided with a function for outputting to the controller section 1101 the information indicating the remaining amount of toner stored in the apparatus-side memory 1122 in response to a request for toner remaining amount information from the controller section 1101.

The CPU 1120 calculates the rotation time of the developing roller from the information indicating the printing size and the number of sheets printed, included in the print requests from the controller section 1101, and stores this in the apparatus-side memory 1122. The CPU 1120 is provided with a function for outputting to the controller section 1101 the information indicating the rotation time of the developing rollers stored in the apparatus-side memory 1122 in response to a request for rotation time information of the developing rollers from the controller section 1101.

The CPU 1120 rotates the developing device retaining unit 1050 based on information on the developing devices and so on. For example, in the case in which a plurality of sheets is printed continuously using only a black developing device, the developing device retaining unit 1050 is rotated once every time printing of the set number of sheets is complete, in order to shake the contained toner. In the case in which two or more black developing devices are attached, if, for example, the remaining amount of toner in a certain developing device becomes equal to or below a predetermined remaining amount, another developing device which is attached is moved to the developing position by rotating the developing device retaining unit 1050. Furthermore, when the rotation time of a developing roller of one of the attached developing devices is equal to or longer than a set predetermined rotation time, another attached developing device is moved to the developing position or the developing device whose rotation time has become equal to or longer than the predetermined time is moved to the attach/detach position by rotating the developing device retaining unit 1050. This control for rotating the developing device retaining unit 1050 is executed by control of the unit controller 1102 based on the various acquired information.

### ===Printer Operation ===

Below follows a description of an operation of the printer 1010. The printer 1010 according to the present embodiment can be used as a color printer with a plurality of developing devices which contain toner of mutually differing colors are attached to a plurality of attach/detach sections on the developing device retaining unit 1050, and can be used as a monochrome printer with developing devices containing toner of the same color attached to at least two of the attach/detach sections of the plurality of attach/detach sections.

The printer 1010 according to the present embodiment is set to execute predetermined operations based on information in the attached developing devices. The information in the developing devices includes, for example, information indicating a case in which the remaining amount of toner contained in the developing devices is equal to or below a predetermined amount, or a case in which the rotation time of the developing rollers provided to the developing devices is equal to or longer than a predetermined time, or information indicating that an event has occurred in which the fact that development will no longer be able to be performed must be forewarned. The predetermined operations include an operation to announce an event by displaying to the display unit 1095, an operation to move a developing device which has entered a state in which development cannot be performed to a developing device attach/detach position, a bias setting operation for adjusting image quality, an exposure power adjustment setting operation for adjusting image quality, and so on.

The remaining amount of toner mentioned above is arrived at by subtracting the amount of toner consumed by printing operations, thereby indicating a forecast remaining amount. As described above, the amount of developer contained in an unused developing device (the initial amount) is set as 100%, and the remaining amount of toner is indicated as a ratio to that initial amount, and stored in the apparatus-side memory 1122. In the present embodiment, the controller section 1101 designates a designated developing device and announces by displaying a warning to the effect that “The toner is running low” to the display unit 1095 when the remaining amount is determined to be 10% or less. That is, the event of the remaining amount becoming equal to or below 10% is an event which should forewarn that development will become impossible to perform, and the predetermined operation here is to display “The toner has run out,” for example, to the display device 1095. When the remaining amount of toner falls equal to or below 5%, the developing device enters a state in which development can no longer be performed, and the controller section 1101 is set to move the developing device and announce through a display to the effect that “The toner has run out” or “Replace the developing device.” In other words, the event of the remaining amount falling equal to or below 5% is an event in which development can no longer be performed, and the predetermined operation is, for example, to move the developing device which has entered a state in which development cannot be performed to the attach/detach position after completing the printing operation currently being processed, and displaying “The toner has run out” or “Replace the developing device,” for example, to the display unit 1095.

The rotation time of the developing roller is stored by adding the predetermined rotation time every time an image is formed on a single medium. That is, the rotation time of the developing roller is indicated as a cumulative rotation time from a developing roller rotation time of 0 for an unused developing device. The predetermined rotation time is set in correspondence with the size of the medium on which the image is formed. For example, in the case in which the developing roller rotates for five seconds when developing an A4 sized image, the controller section 101 is set such that 5 is added to the corresponding developing device information stored in the apparatus-side memory 1122 every time a single medium is developed. If, as a result of this addition, the rotation time passes 1,000 seconds, the unit controller 1102 determines that the relevant developing device is in a state in which development cannot be performed. When the controller section 1101 detects this event, it is set to move the developing device and display “Replace the developing device” to the display unit 1095. In other words, the event of the rotation time of the developing roller reaching 1,000 seconds is an event in which development can no longer be performed, and the predetermined operation is, for example, to move the developing device which has entered a state in which development cannot be performed to the attach/detach position after completing the printing operation currently being processed, and displaying “Replace the developing device,” for example, to the display unit 1095.

In the present embodiment, the predetermined operation is described using as examples a case in which the remaining amount of toner contained in a developing device becomes equal to or below a predetermined amount, and a case in which the rotation time of the developing roller provided to a developing device becomes equal to or longer than a predetermined time.

### <Initial Operations of Printer>

First, a description is given of initial operations from when the power on the printer 1010 is turned through to when it enters standby mode for waiting for a printing instruction, these initial operations being executed both when the printer 1010 is being used as a color printer and when the printer 1010 is being used as a monochrome printer. During these initial operations, the controller section 1101 of the printer 1010 communicates with the unit controller 1102 and acquires information on the attached developing devices. Based on the acquired information, the printer 1010 begins operation either as a color printer or as a monochrome printer. In the present embodiment, it is assumed that the printer 1010 begins operation as a monochrome printer.

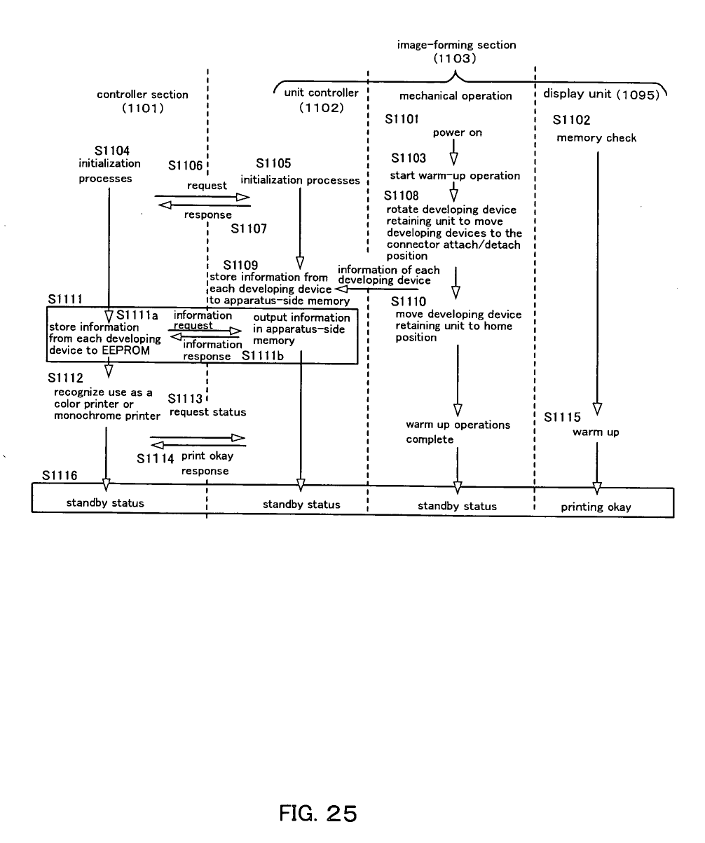

FIG. 25 is a view explaining the initial operations of the printer. When the power is turned on (S1101), the printer 1010 displays “checking memory . . . ” for example, to the display unit 1095 (S1102) and the controller section 101 initializes the image memory 1113, the EEPROM 1114a, and so on (S1104), while the unit controller 1101 initializes the apparatus-side memory 1122 and soon (S1105). The controller section 1101 sends a request to the unit controller 1102 for verifying whether the predetermined communication is possible or not (S1106). Once the unit controller 1102 receives this request, a response indicating that communication is possible is sent to the controller section 1101 (S1107), and communication between the controller section 1101 and the unit controller 1102 begins.

When the power is turned on (S1101), the unit controller 1102 rotates the developing device retaining unit 1050, thereby moving the four attach/detach sections to the connector attach/detach position in sequence (S1108). In the case in which the apparatus-side connector 1034 is moved and a developing device is attached to the attach/detach section located at the connector attach/detach position, information is acquired which stored in the developing-device-side memory in that attached developing device (S1109). The information that is read from the developing devices includes color information on the contained toner, remaining amount information on the contained toner, information indicating rotation time of the developing rollers, and so on, and is stored for each developing device in a predetermined region of the apparatus-side memory 1122. Once the information is acquired from each developing device, the unit controller 1102 moves the developing device retaining unit 1050 to the home position based on the output of the home position detecting section 1031 (S1110). At this time, the unit controller 1102 concurrently executes predetermined warm-up operations of the image-forming section 1103 (S1103). The warm-up operations of the image-forming section 1103 include all operations needed for executing printing, such as, for example, emitting light from the light source of the exposing unit 1040, turning on the heater of the fixing unit 1090, rotating and thereby cleaning the photoconductor 1020 and the intermediate transferring body 1070, and so on.

During the warm-up operations of the image-forming section 1103, the controller section 1101 acquires the information on the developing devices stored in the apparatus-side memory 1122 for storage in the EEPROM 1114a of the controller section 1101 (S1111). At this time, the controller section 1101 outputs to the unit controller 1102 an information request requesting information indicating the remaining amounts of toner for each color, the rotation times of the developing rollers, and so on (S111a). The unit controller 1102 outputs an information response to the controller section 1101 indicating the remaining amounts of toner for each color, the rotation time of the developing rollers, and so on (S1111b). After receiving the information response, the controller section 1101 operates the printer 10 as a color printer, for example, if Y, M, C, and K developing devices are detected as being attached to the four attach/detach sections based on the information in the apparatus-side memory 1122, or as a monochrome printer, if two or more developing devices of the same color, for example black developing devices, are detected as being attached (S1112).

While the unit controller 1102 is executing the warm-up operations, the controller section 1101 outputs at suitable intervals status requests for requesting status information indicating the state of the image-forming section 1103 (S1113). Upon receiving this request, the unit controller 1102 detects the output from sensors and the like provided to each unit, and if the warm-up operations are finished, outputs to the controller section 1101 a response indicating that printing is possible, and if the warm-up operations are not finished, outputs to the controller section 1101 a response indicating that printing is not possible (S1114). If the response from the unit controller 1101 indicates that printing is not possible, the controller section 1102 displays “Warming up . . . ” for example, to the display unit 1095 (S1115). When status information regarding the status of the image-forming section 1103 is received indicating that printing is possible, “Ready to print” for example, is displayed to the display unit 1095, and the printer 1010 enters standby status (S1116).

<Multi-Page Monochrome Printing Processes and Operations when the Printer is Being Used as a Monochrome Printer>

In the second embodiment, a case is described in which the printer 1010 is being used as a monochrome printer, with K developing devices being attached to the three attach/detach sections 1050a, 1050b, and 1050c of the four attach/detach sections 1050a, 1050b, 1050c, and 1050d provided to the developing device retaining unit 1050. In the following description the K developing device 1051 attached to the attach/detach section 1050a is called the first K developing device, the K developing device 1051 attached to the attach/detach section 1050b is called the second K developing device, and the K developing device 1051 attached to the attach/detach section 1050c is called the third K developing device.

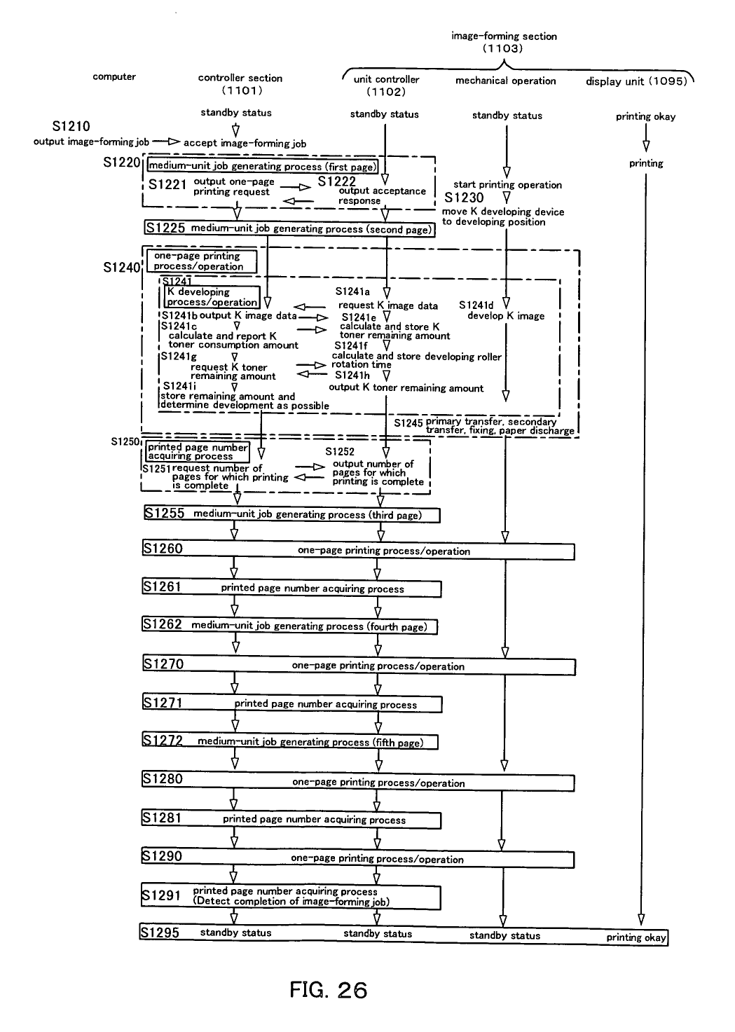

FIG. 26 is a view explaining processes and operations when executing monochrome printing of five pages in the case in which the printer 1010 is being used as a monochrome printer. As shown, the printing process begins when image signals and control signals—that is, a print command and image data for executing color printing of five sheets (five pages) on A4 sized paper as a medium—from the computer (not shown), connected in a manner allowing two-way communication, are input to the printer 1010 in standby status via the interface 1112 (S1210). The number of sheets (number of pages) to print is thus designated and the printing process to be executed, which is generated by the print command and image data for executing printing which are input to the printer, is hereafter called a “image-forming job.” Based on this image-forming job, a medium-unit job, which is the printing process executed on one sheet of the medium, is generated for the designated number of sheets. That is, the medium-unit job is generated for the designated number of sheets, and printing of one page is executed based on the generated medium-unit job, thereby completing the image-forming job.

Based on the image-forming job, the controller section 1101 outputs to the unit controller 1102 in a suitable timing a one-page print request for requesting execution of a color printing process for one page, or in other words of a medium-unit job (S1221). Upon receiving the one-page print request, the unit controller 1102 detects the status of each unit in the image-forming section 1103, and if the status allows printing, outputs to the controller section 1101 an acceptance response for accepting the one-page print request (S1222). A single medium-unit job is thereby generated and the printing process begins. Hereafter, the process by which a single medium-unit job is generated in this way is referred to as a medium-unit job generating process (S1220). As regards the one-page print request, the controller section 1102 and the unit controller 1101 communicate while the unit controller 1102 is controlling the various units, so no medium-unit job is generated during a set interval.

It is taken that two medium-unit jobs have been generated between the controller section 1101 and the unit controller 1102 before two medium-unit job generating processes are executed and development of the K image in the printing operation of the first page is begun (S1220, S1225).

The unit controller 1102 rotates the developing device retaining unit 1050 from the home position thereby moving the first black developing device (K developing device) 1051 to the developing position (S1230). Once the first K developing device 1051 has been moved to the developing position, the unit controller 1102 outputs a request to the controller section 1101 requesting K image data (S1241a). Upon receiving this request, the controller section 1101 outputs the K image data to the unit controller 1102 (S1241b) while also calculating and then outputting to the unit controller 1102 the toner consumption amount consumed when performing development based on the K image data (S1241c). The unit controller 1102 executes the developing operation (S1241d), while also subtracting the received consumption amount from the remaining amount of the toner in the first K developing device 1051 stored in the apparatus-side memory 1122, calculating the remaining amount of the toner after development, and rewriting the information in the apparatus-side memory 1122 (S1241e). The unit controller 1102 adds 5 to the rotation time of the developing roller of the first K developing device 1051 stored in the apparatus-side memory 1122, calculates the rotation time of the developing roller after development (the cumulative rotation time), and rewrites the information in the apparatus-side memory 1122 (S1241f). At this time, the unit controller 1102 detects that the rotation time of the developing roller of the first K developing device 1051 has not reached 1,000 seconds. The controller section 1101 outputs to the unit controller 1102 in a suitable timing an information request requesting information indicating the remaining amount of the toner after development and after development due to the medium-unit job (S1241g). The unit controller 1102 outputs to the controller section 1101 the information indicating the remaining amount of the K toner and the information indicating the rotation time of the developing roller, which are stored in the apparatus-side memory 1122 (S1241h). The controller section 1101 rewrites the information in the EEPROM 1114a based on the acquired information indicating the remaining amount of the K toner (S1241i). At this time, the controller section 1101 determines whether or not the acquired information indicating the remaining amount of the K toner is information indicating 10% or lower or 5% or lower, and whether or not the acquired information indicating the rotation time of the developing roller is information indicating 1,000 seconds or more. Here, it is taken to be that the information indicating the remaining amount of the K toner is greater than 10%, and that the information indicating the rotation time of the developing roller is less than 1,000 seconds, so the controller section 1101 determines that developing is possible, and continues the printing process. The processes from the unit controller 1102 requesting the controller section 1101 for the K image data until the controller section 1101 rewrites the information in the EEROM 1114a in this way is hereafter referred to as the K developing process/operation (S1244).

When development using the K toner is finished, a K toner image is formed on the intermediate transferring member 1070. This K toner image is transferred to the paper, which is supplied by the supply tray, by the second transferring unit 1080, made into a permanent image by the fixing unit 1090, and ejected (S1245). Thus, the K developing process/operation (S1241), primary image transfer, secondary image transfer, fixing, and ejection (S1245) are executed during the printing process for one page through one medium-unit job, when the printer 1010 is being used as a monochrome printer. The processes and operations from the K developing process/operation (S1241) until the ejection (S1245) are hereafter referred to as a one-page printing process/operation (S1240). The remaining amount of toner in the first K developing device calculated during this one-page printing process/operation is taken to be more than 10% and the rotation time of the developing roller on the first K developing device to be less than 1,000 seconds.

The controller section 1101 outputs to the unit controller 1102 in a suitable timing a request for acquiring the number of pages for which printing is complete (S1251). Once a printing operation for one page is finished, the unit controller 1102 outputs a response to the controller section 1101 indicating that the printing operation for one page has finished (S1252). The process of checking the number of pages for which printing is finished every time printing of one page finishes is hereafter referred to as the printed page number verification process (S1250).

Between the controller section 1101 and the unit controller 1102, the medium-unit job generating process is executed for generating the medium-unit job for the third page, and the third medium-unit job is generated (S1306).

When the developing operation for one page through the first medium-unit job finishes, the unit controller 1102 executes the one-page printing process/operation for the second page (S1260). The remaining amounts of toner in each developing device calculated during this one-page printing process/operation are taken to be more than 10% and the rotation time of the developing rollers on each developing device to be less than 1,000 seconds.

When the one-page printing process/operation for the second page is finished, a printed page number acquiring process is executed (S1261). In this process, the unit controller 1102 outputs to the controller section 1101 a response indicating that the printing operation for the second page is finished.

Between the controller section 1101 and the unit controller 1102, the medium-unit job generating process is executed for generating the medium-unit job for the fourth page, and the fourth medium-unit job is generated (S1262).

When the developing operation for one page through the second medium-unit job finishes, the unit controller 1102 executes the one-page printing process/operation for the third page (S1270). The remaining amounts of toner in each developing device calculated during this one-page printing process/operation are taken to be more than 10% and the rotation time of the developing rollers on each developing device to be less than 1,000 seconds.

When the one-page printing process/operation for the third page is finished, a printed page number acquiring process is executed (S1271). In this process, the unit controller 1102 outputs to the controller section 1101 a response indicating that the printing operation for the third page is finished.

Between the controller section 1101 and the unit controller 1102, the medium-unit job generating process is executed for generating the medium-unit job for the fifth page, and the fifth medium-unit job is generated (S1272).

When the developing operation for one page through the third medium-unit job finishes, the unit controller 1102 executes the one-page printing process/operation for the fourth page (S1280). The remaining amounts of toner in each developing device calculated during this one-page printing process/operation are taken to be more than 10% and the rotation time of the developing rollers on each developing device to be less than 1,000 seconds.

When the one-page printing process/operation for the fourth page is finished, a printed page number acquiring process is executed (S1281). In this process, the unit controller 1102 outputs to the controller section 1101 a response indicating that the printing operation for the fourth page is finished.

When the developing operation for one page through the fourth medium-unit job finishes, the unit controller 1102 executes the one-page printing process/operation for the fifth page (S1290). The remaining amounts of toner in each developing device calculated during this one-page printing process/operation are taken to be more than 10% and the rotation time of the developing rollers on each developing device to be less than 1,000 seconds.

When the one-page printing process/operation for the fifth page is finished, a printed page number acquiring process is executed (S1291). In this process, the unit controller 1102 outputs to the controller section 1101 a response indicating that the printing operation for the fifth page is finished. If, at this time, the number of pages to print as designated by the image-forming job is output as the response, the controller section 1101 detects that the image-forming job is finished. The printer 1010 enters standby status and the controller section 1101 displays “Ready to print,” for example, to the display unit 1095 (S1295).

Now a description is given of the processes and operations in a case in which a plurality of pages is printed when the printer 1010 is being used as a color printer. When the printer 1010 is being used as a color printer, of the processes and operations of the monochrome printer, the one-page printing process/operation (S1240) is different. In other words, when the color printer 1010 is being used as a color printer, differences are that the one-page printing process/operation (S1240) causes not only the K image developing process/operation (S1241), but also a Y image developing process/operation, an M image developing process/operation, and a C image developing process/operation to be executed, and that the developing devices of each color move in sequence to the developing position for every developing operation using the developing devices of each color. The K image developing process/operation (S1241) only differs from the Y image developing process/operation, the M image developing process/operation, and the C image developing process/operation in the toner contained in each developing device, while the processes and operations in developing are the same.

<Monochrome Printer Operation when the Remaining Amount of Toner in all The Developing Devices is Equal to or Lower than a Predetermined Amount>

Next follows a description of processes and operations of the printer 10 in the case in which the remaining amount of toner in all the attached K developing devices is equal to or below 5%, when the printer 1010 is being used as a monochrome printer. In this example, the focus is on the remaining amount of toner, so descriptions of the process for calculating the rotation time of the developing rollers and the determination of whether or not the rotation time is equal to or greater than 1,000 seconds are omitted. Here, the controller section 1101 acquires the information for the three developing devices stored in the apparatus-side memory 1122 during the initial operations. The acquired information is assumed to be information indicating that the remaining amount of toner in the first K developing device 1051 and the second K developing device 1051 is 6% for both, and information indicating that the remaining amount of toner in the third K developing device 1051 is 11%. At this time, the controller section 1101 detects that the first through third K developing devices are attached, that the remaining amount of toner in the first and second K developing devices is less than 10%, and that the remaining amount of toner in the third K developing device is more than 10%, and determines that development is possible with all the first through third K developing devices.

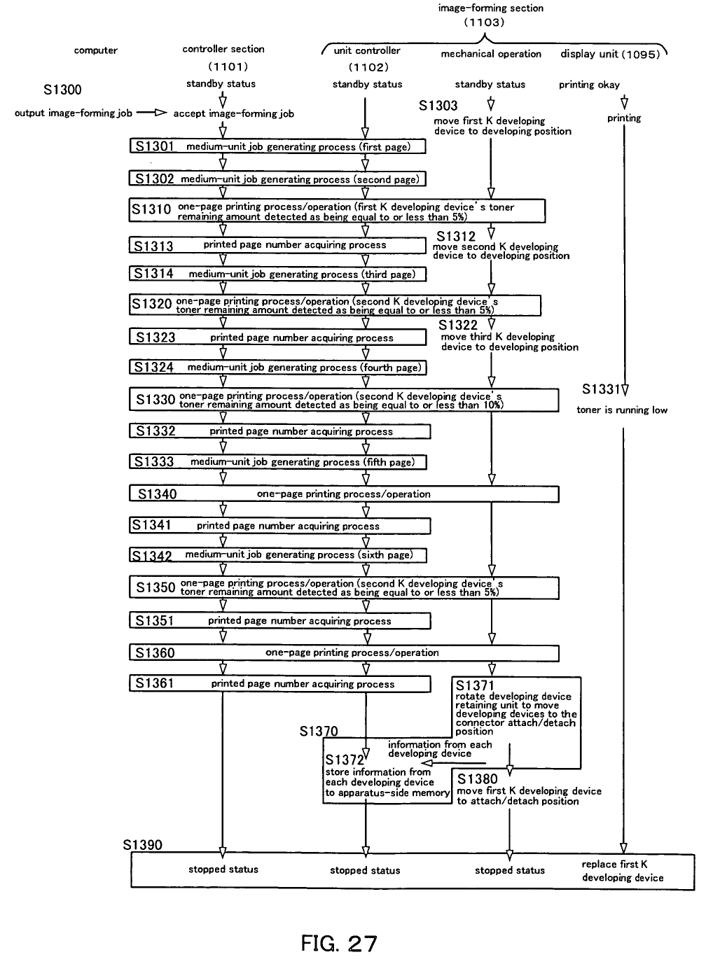

FIG. 27 is a view explaining processes and operation of the printer when the remaining amount of toner in all the K developing devices falls equal to or below 5% when the printer 1010 is being used as a monochrome printer.

The printing process begins when an image-forming job is input from computer (not shown), connected in a manner allowing two-way communication, to the printer 1010 for executing monochrome printing of eight pages (S1300). Again, it is taken that two medium-unit jobs have been generated between the controller section 1101 and the unit controller 1102 before two medium-unit job generating processes are executed and development of the K image in the first medium-unit job is begun (S1301, S1302).

The unit controller 1102 rotates the developing device retaining unit 1050 from the home position, thereby moving the first K developing device 1051 to the developing position (S1303), and executes a one-page printing process/operation for the first page based on the first medium-unit job (S1310). The remaining amount of toner of the first K developing device calculated during this one-page printing process/operation is 4%, and the unit controller 1102 detects that the remaining amount of toner of the first developing device 1051 is equal to or less than 5%. The controller section 1101 acquires the information from the unit controller 1102, and determines that the first K developing device 1051 is in a state in which development cannot be performed.

On the other hand, the unit controller 1102 continues and then stops the one-page printing process/operation of the first page. At this time, the unit controller 1102 has already detected that the second and third K developing devices, which contain toner of the same color as the toner in the first K developing device, are attached to attach/detach section 1050b and 1050c. Furthermore, the unit controller 1102 detects that, of the second K developing device and the third K developing device, the second K developing device has a shorter moving distance when being moved to the developing position, by rotating the developing device retaining unit 1050 in one direction. For this reason, the unit controller 1102 rotates the developing device retaining unit 1050 and moves the second K developing device 1051 to the developing position (S1312).

When the one-page printing process/operation for the first page is finished, a printed page number acquiring process is executed (S1313). In this process, the unit controller 1102 outputs to the controller section 1101 a response indicating that the printing operation for the first page is finished.

Between the controller section 1101 and the unit controller 1102, the medium-unit job generating process is executed for generating the medium-unit job for the third page, and the third medium-unit job is generated (S1314).

The unit controller 1102 executes the one-page printing process/operation for the second page based on the second medium-unit job, in the same way as the one-page printing process/operation for the second page (S1320). The remaining amount of toner of the second K developing device calculated during this one-page printing process/operation is 4%, and the unit controller 1102 detects that the remaining amount of toner of the second developing device 1051 is equal to or less than 5%. The controller section 1101 acquires the information from the unit controller 1102, and determines that the second K developing device 1051 is in a state in which development cannot be performed.

On the other hand, the unit controller 1102 continues and then stops the one-page printing process/operation of the first page. At this time, the unit controller 1102 has already detected that the third K developing device, which contains toner of the same color as the toner in the second K developing device, is attached to attach/detach section 1050c. For this reason, the unit controller 1102 rotates the developing device retaining unit 1050 and moves the third K developing device 1051 to the developing position (S1322).

When the one-page printing process/operation for the second page is finished, a printed page number acquiring process is executed (S1323). In this process, the unit controller 1102 outputs to the controller section 1101 a response indicating that the printing operation for the first page is finished.

Between the controller section 1101 and the unit controller 1102, the medium-unit job generating process is executed for generating the medium-unit job for the fourth page, and the fourth medium-unit job is generated (S1324).

The unit controller 1102 executes the one-page printing process/operation for the third page, based on the third medium-unit job (S1330). Through the one-page printing process/operation for the third page, information that the remaining amount of toner in the third K developing device is 9%, for example, is stored in the EEPROM 1114a. The controller section 1101 detects that the remaining amount of toner in all the K developing devices has fallen below 10% by the remaining amount of toner in the third K developing device falling below 10%, and displays “The toner has run out of ink,” for example, to the display unit 1095 (S1331).

When the one-page printing process/operation for the third page is finished, a printed page number acquiring process is executed (S1332). In this process, the unit controller 1102 outputs to the controller section 1101 a response indicating that the printing operation for the third page is finished.

Between the controller section 1101 and the unit controller 1102, the medium-unit job generating process is executed for generating the medium-unit job for the fifth page, and the fifth medium-unit job is generated (S1333).

The unit controller 1102 executes the one-page printing process/operation for the fourth page, based on the fourth medium-unit job (S1340). Through the one-page printing process/operation for the fourth page, information that the remaining amount of toner in the third K developing device is 7%, for example, is stored in the EEPROM 1114a. The controller section 1101 continues the developing operation, because the remaining amount of toner in the third K developing device is also above 5%.

When the one-page printing process/operation for the fourth page is finished, a printed page number acquiring process is executed (S1341). In this process, the unit controller 1102 outputs to the controller section 1101 a response indicating that the printing operation for the fourth page is finished.

Between the controller section 1101 and the unit controller 1102, the medium-unit job generating process is executed for generating the medium-unit job for the sixth page, and the sixth medium-unit job is generated (S1342).

The unit controller 1102 executes the one-page printing process/operation for the fifth page, based on the fifth medium-unit job (S1350). The remaining amount of toner of the fifth K developing device calculated during this one-page printing process/operation is 5%, and the unit controller 1102 detects that the remaining amount of toner of the third developing device 1051 is equal to or less than 5%. The controller section 1101 acquires the information from the unit controller 1102, and determines that the third K developing device 1051 is in a state in which development cannot be performed. The controller section 1101 thereafter stops the process for outputting one-page printing requests.

When the one-page printing process/operation for the fifth page is finished, a printed page number acquiring process is executed (S1351). In this process, the unit controller 1102 outputs to the controller section 1101 a response indicating that the printing operation for the fifth page is finished. At this point, six medium-unit jobs have been generated, and the developing operation based on the five medium-unit jobs has finished. The printer 1010 executes the one-page printing process/operation for the sixth page based on the remaining one medium-unit job (S1360).

When the one-page printing process/operation for the sixth page is finished, a printed page number acquiring process is executed (S1361). As a result of printed page number acquiring process, the controller section 1101 detects that the printing based on the sixth medium-unit jobs already generated has finished.

The unit controller 1102 then moves each of the attached developing devices to the connector attach/detach position in sequence by rotating the developing device retaining unit 1050 (S1371). The apparatus-body side connector 1034 is moved and the information such as the information on the remaining amount of toner stored in the apparatus-side memory 1122 is stored in the developing-device-side memory of each developing device (S1372). The process of acquiring information stored in the apparatus-side memory 1122 and storing it in the developing-device-side memory of each developing device is hereafter referred to as the memory information acquiring process (S1370). Furthermore, the developing device retaining unit 1050 is rotated, thereby moving the first K developing device 1051, with which developing can no longer be performed, to the developing device attach/detach position (S1380). The controller section 1101 then displays “Replace the K developing device” or “The toner has run out” for example, to the display unit 1095 and the printer 1010 enters a state in which operation is stopped (S1390).

<Monochrome Printer Operation when the Rotation Time of All the Developing Rollers is Equal to or Longer than a Predetermined Time>

Next follows a description of processes and operations of the printer 10 in the case in which the rotation time of all the developing rollers on the K developing devices is 1,000 seconds or more, when the printer 1010 is being used as a monochrome printer. In this example, the focus is on the rotation time of the developing rollers, so descriptions of the process for calculating the remaining amount of toner and determining whether or not the remaining amount of toner is equal to or below 5% are omitted. Here, the controller section 1101 acquires the information for the three developing devices stored in the apparatus-side memory 1122 during the initial operations. The acquired information is assumed to be information indicating that the rotation time for the developing rollers on the first K developing device through the third K developing device is 995 seconds. At this time, the unit controller 1102 determines that development can be performed with both the first and second K developing devices as the rotation time of the developing rollers of the first through the third K developing devices is less than 1,000 seconds.

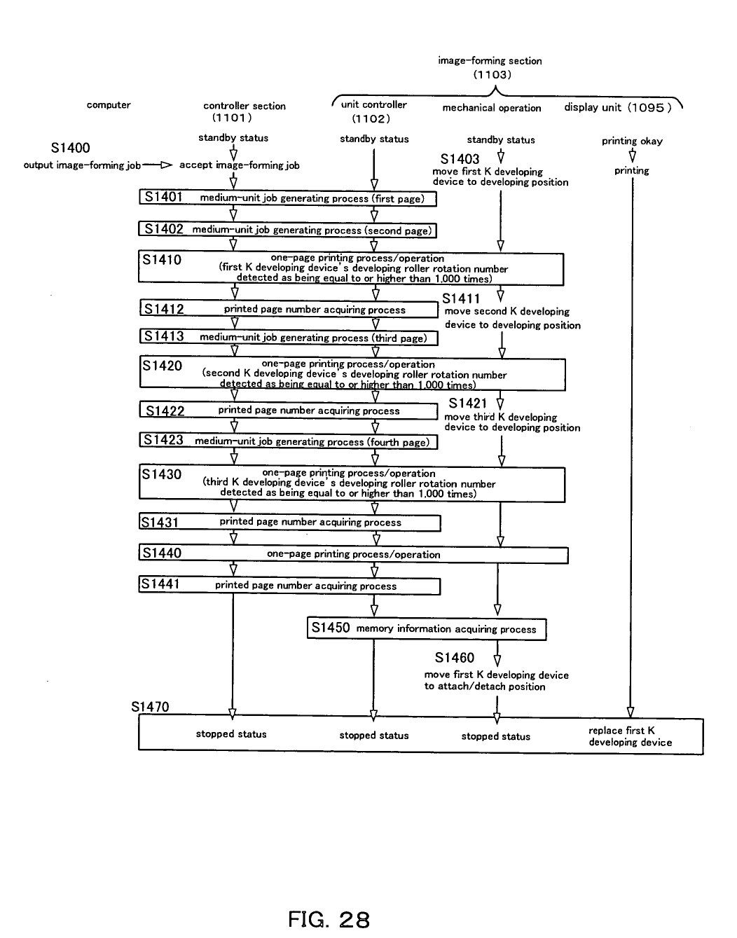

FIG. 28 is a view explaining processes and operation of the printer 10 when the rotation time of a developing roller of all the K developing devices rises 1,000 or more seconds when the printer 10 is being used as a monochrome printer.

The printing process begins when an image-forming job is input from a computer (not shown), connected in a manner allowing two-way communication, to the printer 1010 for executing monochrome printing of five pages of A4 size (S1400). Again, it is taken that two medium-unit jobs have been generated between the controller section 1101 and the unit controller 1102 before two medium-unit job generating processes are executed and development of the K image in the first medium-unit job is begun (S1401, S1402).

The unit controller 1102 rotates the developing device retaining unit 1050 from the home position, thereby moving the first K developing device 1051 to the developing position (S1403), and executes a one-page printing process/operation for the first page based on the first medium-unit job (S1410). The calculated rotation time of the developing roller on the first K developing device 1051 calculated during this one-page printing process/operation reaches 1,000 seconds, and the unit controller 1102 detects that the rotation time of the developing roller on the first K developing device 1051 is 1,000 or more seconds. The controller section 1101 acquires the information from the unit controller 1102, and determines that the first K developing device 1051 is in a state in which development cannot be performed.

On the other hand, the unit controller 1102 continues and then stops the one-page printing process/operation of the first page. At this time, the unit controller 1102 has already detected that the second and third K developing devices, which contain toner of the same color as the toner in the first K developing device and with which development is possible, are attached to attach/detach section 1050b and 1050c. Furthermore, the controller 1101 detects that, of the second K developing device and the third K developing device, the second K developing device has a shorter moving distance when being moved to the developing position, by rotating the developing device retaining unit 1050 in one direction. For this reason, the unit controller 1102 rotates the developing device retaining unit 1050 and moves the second K developing device 1051 to the developing position (S1411).

When the one-page printing process/operation for the first page is finished, a printed page number acquiring process is executed (S1412). In this process, the unit controller 1102 outputs to the controller section 1101 a response indicating that the printing operation for the first page is finished.

Between the controller section 1101 and the unit controller 1102, the medium-unit job generating process is executed for generating the medium-unit job for the third page, and the third medium-unit job is generated (S1413).

The unit controller 1102 executes the one-page printing process/operation for the second page based on the second medium-unit job, in the same way as the one-page printing process/operation for the second page (S1420). The rotation time of the developing roller on the second K developing device 1051 calculated during this one-page printing process/operation for the second page reaches 1,000 seconds, and the unit controller 1102 detects that the rotation time of the developing roller on the second K developing device 1051 is 1,000 or more seconds. The controller section 1101 acquires the information from the unit controller 1102, and determines that the second K developing device 1051 is in a state in which development cannot be performed.

On the other hand, the unit controller 1102 continues the developing operation of the K image and stops the one-page printing process/operation for the second medium-unit job. At this time, the unit controller 1102 has already detected that the third K developing device, which contains toner of the same color as the toner in the second K developing device and with which development is possible, is attached to attach/detach section 1050c. For this reason, the unit controller 1102 rotates the developing device retaining unit 1050 and moves the third K developing device 1051 to the developing position (S1421).

When the one-page printing process/operation for the second page is finished, a printed page number acquiring process is executed (S1422). In this process, the unit controller 1102 outputs to the controller section 1101 a response indicating that the printing operation for the first page is finished.

Between the controller section 1101 and the unit controller 1102, the medium-unit job generating process is executed for generating the medium-unit job for the fourth page, and the fourth medium-unit job is generated (S1423).

The unit controller 1102 executes the one-page printing process/operation for the third page, based on the third medium-unit job (S1430). The rotation time of the developing roller on the third K developing device 1051 calculated during this one-page printing process/operation for the third page reaches 1,000 seconds, and the unit controller 1102 detects that the rotation time of the developing roller on the third K developing device 1051 is 1,000 or more seconds. The controller section 1101 acquires from the unit controller 1102 in a suitable timing the rotation time of the developing roller on the third developing device 1051 after development through the medium-unit job, and rewrites the information in the EEPROM 1114a based on the acquired information indicating the rotation time of the developing roller on the third K developing device 1051. At this time, the controller section 1101 detects that the rotation time of the developing roller on the third developing device 1051 is 1,000 or more seconds, and determines that the third K developing device is in a state in which development cannot be performed. The controller section 1101 thereafter stops the process for outputting one-page printing requests. The unit controller 1102 continues the developing operation of the K image and stops the one-page printing process/operation for the third medium-unit job.

When the one-page printing process/operation for the third page is finished, a printed page number acquiring process is executed (S1431).

After the one-page printing process/operation of the third page, the controller section 1101 outputs a one-page print request for requesting the fifth medium-unit job (S1432). At this point, four medium-unit jobs have been generated, and the developing operation based on the three medium-unit jobs has finished. The printer 1010 executes the one-page printing process/operation for the fourth page based on the remaining one medium-unit job (S1440).

When the one-page printing process/operation for the fourth page is finished, a printed page number acquiring process is executed (S1441). As a result of printed page number acquiring process, the controller section 1101 detects that the printing based on the four medium-unit jobs already generated has finished.

The unit controller 1102 executes a memory information acquiring process (S1450) and stores in the developing-device-side memory of the two developing devices information such as information indicating the rotation time of the developing roller in the two developing devices stored in the apparatus-side memory 1122. Furthermore, the developing device retaining unit 1050 is rotated, thereby moving the first K developing device 1051, with which developing can no longer be performed, to the developing device attach/detach position (S1460). The controller section 1101 then displays “Replace the first developing device,” for example, to the display unit 1095 and the printer 1010 enters a state in which operation is stopped (S1470).

### <Characteristic of the Printer According to the Second Embodiment>

With the printer 1010 according to the second embodiment, a plurality of developing devices containing toner of the same color are attached, when the printer 1010 is being used as a monochrome printer. When an event is detected in which the remaining amount of toner in all the attached developing devices becomes equal to or below a predetermined amount or the rotation time of the developing rollers becomes equal to or above a predetermined time, thereby making development impossible, this event is displayed to the display unit 1095, and the developing device with which development is no longer possible is moved to a developing device attach/detach position. In other words, even if an event is detected in which the attached developing devices have entered a state in which development cannot be performed, no operations are performed in the middle of an image-forming job such as displaying these events to the display unit 1095 or moving the developing device with which development cannot be performed to the developing device attach/detach position. Throughput can therefore be improved, since printing operations are not interrupted in the middle of an image-forming job, when the entire monochrome printer is in a state in which development can be performed.

The other developing unit with the shortest moving distance to the developing position is moved to the developing position when one of the developing devices is no longer able to perform development. In other words, a developing device, with which development can be performed, can be moved to the developing position in the shortest time when one of the developing devices can no longer develop. A drop in throughput can therefore be suppressed because the time to move the developing device is short.

Since development can be continued until a state is entered in which development cannot be performed by any of the developing devices, the possibility of interruption is low, even in the case in which printing is performed on a large volume of paper, etc., at a single time, making this kind of image forming apparatus particularly effective in the case in which printing is performed on a large volume of paper, etc., at a single time.

Furthermore, an event in which development cannot be performed is announced by being displayed to the display unit 1095 when a state is entered in which development cannot be performed with any of the developing devices, so the event is not announced if development can no longer be performed by some of the developing devices. In other words, a user etc. cannot find out about an event in which development cannot be performed by one of the developing devices until development cannot be performed by all of the developing devices. For this reason, the user can use the image forming apparatus in the same way as in the case in which development is being performed with one development device, until development cannot be performed with all the developing devices.

After forming images based on the medium-unit jobs already generated when an event is detected in which all the developing devices have entered a state in which development can no longer be performed, image-forming operations are not interrupted in the middle of the medium-unit job, executing operations such as displaying the events to the display unit 1095 or moving the developing device with which development can no longer be performed to the developing device attach/detach position. In other words, since the image-forming operation is not interrupted with the image only partially formed based on the generated medium-unit job, it is possible to form an image without wasting toner or paper used in the image-forming operation only partially executed. Since the image-forming operation based on the generated medium-unit job is stopped and the image is formed based on a newly-generated medium-unit job after the event, in which development can no longer be performed, is resolved, control is easy.

With the printer according to the second embodiment, when it is necessary to forewarn that a state will be entered in which development can no longer be performed, due to the remaining amount of toner in all the developing devices becoming equal to or below a predetermined amount, “The toner is running low,” for example, is displayed to the display unit 1095, so the user etc. can find out about the event before a state is entered in which development cannot be performed. For this reason, the user etc. can prepare a new developing device before development becomes impossible to perform. The developing operation can therefore be continued by changing the prepared developing device immediately when the remaining amount of toner contained in a developing device becomes equal to or below the predetermined amount.

In the second embodiment, a case in which a remaining amount of toner becomes equal to or below a predetermined amount and a case in which a rotation time of a developing roller becomes equal to or longer than a predetermined time were described as examples of a state in which development cannot be performed with a developing device, but it is also possible to move the developing device with which development can no longer be performed to the developing position or announce the event after an image is formed based on a medium-unit job already generated when either of those two cases arises.

In the second embodiment, the rotation time of a developing roller was calculated using the amount of time the roller rotated, but this may be converted to the rotation time of the developing roller by counting the number of rotations of the developing roller or the number of sheets printed.

Further, in the second embodiment, an example was described in which two developing devices are attached to the developing device retaining unit 1050 in the case in which the printer 10 is used as a monochrome printer, but it is also possible for developing devices containing toner of the same color to be attached to at least two of the attach/detach sections. If, for example, three or four developing devices are attached, printing can be performed without changing any developing device for even longer periods of time.

Whether the printer 10 is being used as a color printer or as a monochrome printer, the developing device with development can no longer be performed is moved to the attach/detach position, so the developing device can easily be replaced without the user having to check, move, or otherwise engage in any bothersome operations regarding the developing device which can no longer perform development.

### ===Other Examples According to the Second Embodiment==

An image forming apparatus, for example, according to the present invention in the second embodiment is described above, but the foregoing second embodiment of the invention is for the purpose of elucidating the present invention and is not to be interpreted as limiting the present invention. The invention can of course be altered and improved without departing from the gist thereof and includes functional equivalents.

In the second embodiment, an intermediate image transfer type laser beam printer was described as an example of the image forming apparatus, but the present invention can also be adopted for various other types of image forming apparatuses, such as laser beam printers that are not of the intermediate image transfer type, copying machines, and facsimiles.

Furthermore, in the second embodiment, a description was given using as an example an image forming apparatus provided with rotary-type developing apparatuses, but the present invention may, without being limited to this, be adopted for image forming apparatuses provided with tandem-type developing apparatuses.

In the second embodiment, when an event occurs in which development cannot be performed by all the attached developing devices, an example in which the event is announced to the display unit 1095 and an example in which one of the developing devices is moved to the attach/detach position were noted, but the operations to be executed when an event occurs in which development cannot be performed with all of the attached developing devices are not limited to this. For example, in the case in which the remaining amount of toner contained in the developing devices becomes equal to or below a predetermined amount, or in the case in which a drop in toner darkness is detected by a toner darkness detecting means, a bias setting operation for adjusting image quality or an exposure power adjustment setting operation for adjusting image quality can be executed, for example. When the remaining amount of toner falls because of repeated printing, the amount of toner whose charged amount is below a stipulated value increases, thereby presenting the risk of a drop in image quality. By executing the bias setting operation and the exposure power adjustment setting operation, a favorable image can be printed. In other words, if the remaining amount of toner drops in any of the developing devices, there is a risk that throughput might drop, if only the bias setting operation or the exposure power adjustment setting operation are executed. For this reason, until the remaining amount of toner in all the developing devices falls below the predetermined amount, executing printing processes by changing the developing devices and not executing the bias setting operation or the exposure power adjustment setting operation makes it possible to improve throughput, as the probability of the bias setting operation or exposure power adjustment setting operation being executed in the middle of an image-forming job falls. Furthermore, in the event that the toner containing section is provided to the exterior of the developing device, a toner supplying operation may be executed.

In the second embodiment, a description was given of an example in which the remaining amount of toner is calculated by the unit controller 1102 based on the consumption amount calculated by the controller section 1101, but the remaining amount of toner may be calculated the consumption amount by providing a remaining amount detecting means to the developing device or by counting the number of printed pages.

In the second embodiment, the rotation time of a developing roller was calculated using the amount of time the roller rotated, but this may be converted to the rotation time of the developing roller by counting the number of rotations of the developing roller or the number of sheets printed.

Furthermore, in the second embodiment, communication was performed between the developing-device-side memory and the apparatus body by abutting the apparatus-side connectors against the developing-device-side connectors, but without being limited to this, the communication may be performed, for example, without causing a developing device-side member to come in contact with an apparatus-side member.

The photoconductor, too, may not be limited to a so-called photodetection roller, configured by providing a photosensitive layer to an outer circumference surface on a cylindrical conductive material, but may be configured by providing a photosensitive layer to an outer circumference surface on a belt-type conductive material.

Furthermore, in the second embodiment, an example was described in which the K developing devices are attached when the printer 10 is being used as a monochrome printer, but the attached developing devices are not limited to the K developing devices as long as they are developing devices that contain toner of the same color.

### <Configuration of the Image Forming System>

An image forming system serving as an example of the second embodiment of the present invention is described with reference to the drawings.

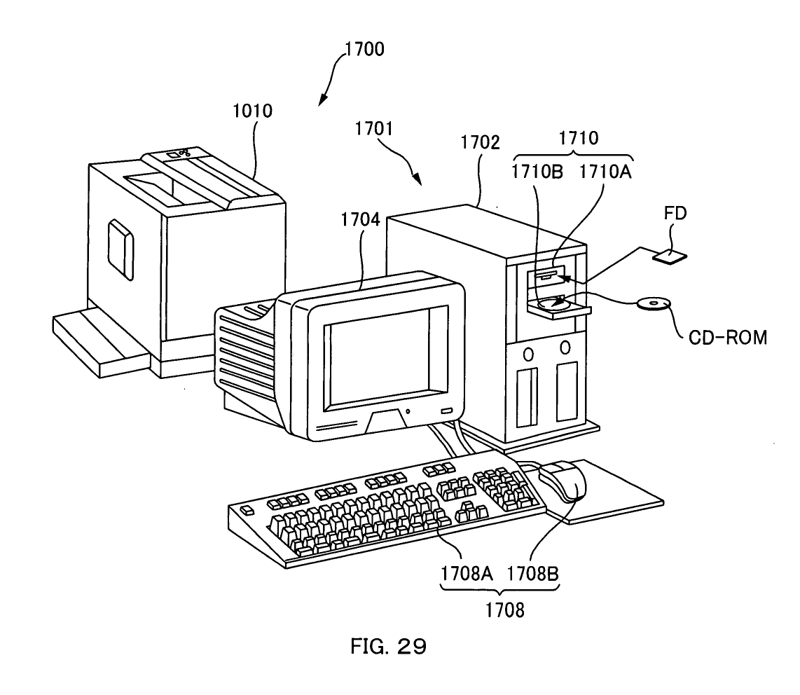

FIG. 29 is an explanatory drawing showing the external configuration of an image forming system. An image forming system 1700 is made up of a computer 1701 and a laser-beam printer (hereafter also referred to as a printer) 1010, acting as an image forming apparatus, being connected to allow two-way communication therebetween.

The computer 1701 is provided with a main computer unit 1702, a display device 1704 as a displaying section, an input device 1708, and a reading device 1710. In this example, the main computer unit 1702 is accommodated within a mini-tower type housing; however, this is not a limitation. A CRT (cathode ray tube), plasma display, or liquid crystal display device, for example, is generally used as the display device 1704, but this is not a limitation. In this embodiment, the input device 1708 is a keyboard 1708A and a mouse 1708B, but there is no limitation to these. In this embodiment, a flexible disk drive device 1710a and a CD-ROM drive device 1710B are used as the reading device 1710, but there is no limitation to these, and the reading device 710 may also be a MO (magnet optical) disk drive device or a DVD (digital versatile disk), for example.

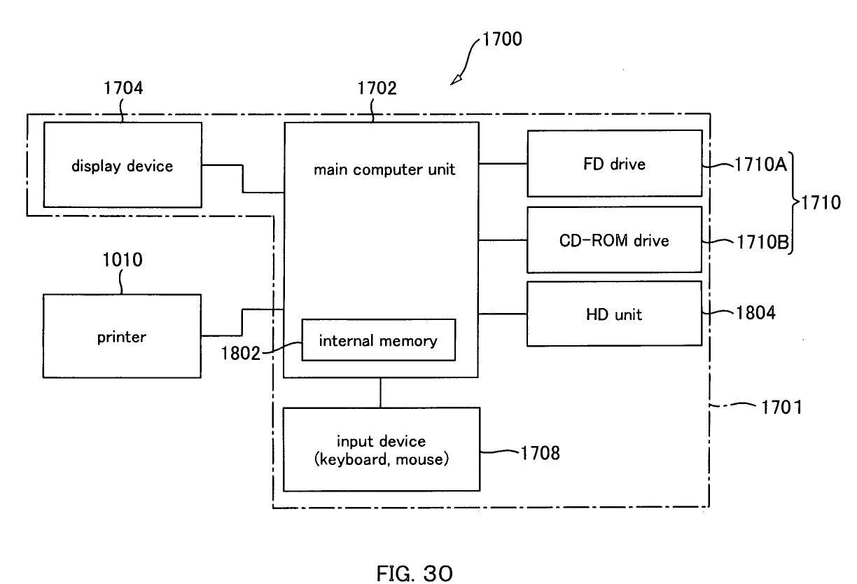

FIG. 30 is a block diagram showing the configuration of the image forming system shown in FIG. 29. An internal memory 1802 such as a RAM is provided within the housing accommodating the main computer unit 1702, and also an external memory such as a hard disk drive unit 1804 are provided.

In the above description, an example was described in which the computer 1701 is provided with the main computer unit 1702, the display device 1704, the input device 1708, and the reading device 1710; however, this is not a limitation. For example, the computer 1701 may be provided with either the input device 1702 or the reading device 1704, or configured with the main computer body 1708 and the display device 1710, in which a touch panel is provided to the screen.

1. An image forming apparatus for forming images, comprising:
an image bearing member for bearing a latent image; and
a plurality of attach/detach sections to and from which developing units can be attached and detached, each developing unit containing a developer and being adapted to develop the latent image using the developer;
wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units;
wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units;
wherein by moving one of the developing units attached to the plurality of attach/detach sections to a predetermined attach/detach position, the moved developing unit is replaceable with another developing unit which has not been attached; and
wherein the timing for moving a predetermined developing unit to the attach/detach position when an event occurs in which development cannot be performed by the predetermined developing unit is different for when the image forming apparatus is being used as the color image forming apparatus and for when the image forming apparatus is being used as the monochrome image forming apparatus.

2. An image forming apparatus according to claim 1, comprising:
an image-forming section for forming an image on a medium by developing the latent image; and
a controller for causing the image-forming section to form the image;
wherein a medium-unit job in which the image-forming section forms an image on a single medium is generated by
the controller suitably outputting, to the image-forming section, a request for requesting formation of an image on a single medium, and
the image-forming section outputting, to the controller, an acceptance response indicating that the request has been accepted, if image formation is possible; and
wherein the timing for moving the predetermined developing unit to the attach/detach position when the image forming apparatus is being used as the color image forming apparatus comes after forming the image according to the medium-unit job which has already been generated when an event occurs in which development cannot be performed by the predetermined developing unit.

3. An image forming apparatus according to claim 1, wherein:
formation of an image is started when the controller accepts an image-formation job that causes generation of at least one medium-unit job; and
in a case where an other developing unit with which development can be performed and which contains developer of the same color as the developer contained in the predetermined developing unit is attached to any of the plurality of attach/detach sections when an event occurs in which development cannot be performed by the predetermined developing unit,
the timing for moving the predetermined developing unit to the attach/detach position when the image forming apparatus is being used as a monochrome image forming apparatus comes after moving the other developing unit, with which development can be performed, to a developing position and forming images based on all the medium-unit jobs generated by the image-forming job using the moved developing unit.

4. An image forming apparatus according to claim 1, wherein:
in a case where an event occurs in which development cannot be performed with any of the attached developing units when the image forming apparatus is being used as the monochrome image forming apparatus,
the developing units in which the event of not being able to perform development has occurred are moved to the attach/detach position after forming images based on the medium-unit jobs already generated.

5. An image forming apparatus according to claim 2, wherein:
an event in which development cannot be performed by the predetermined developing unit means that a remaining amount of developer contained in the predetermined developing unit is equal to or below a predetermined amount;
the controller acquires, from the image-forming section, remaining amount information indicating the remaining amount of developer contained in the attached developing units and is able to determine, based on the acquired remaining amount information, whether or not the remaining amount of developer contained in the developing units is equal to or below the predetermined amount; and
in a case where the controller determines that the remaining amount of developer in any of the attached developing units is equal to or below the predetermined amount when the image forming apparatus is being used as a color image forming apparatus,
the controller does not output the request to the image-forming section.

6. An image forming apparatus according to claim 5, wherein:
in a case where the remaining amount of developer in the predetermined developing unit is equal to or below the predetermined amount and an other developing unit with which development can be performed and which contains developer of the same color as the developer contained in the predetermined developing unit is attached to any of the plurality of attach/detach sections when the image forming apparatus is being used as a monochrome image forming apparatus,
the controller outputs the request to the image-forming section.

7. An image forming apparatus according to claim 2, wherein:
each of the developing units is provided with a rotatably-supported developer-bearing roller for bearing the developer;
an event in which development cannot be performed by the predetermined developing unit means that a rotation time of the developer-bearing roller provided to the predetermined developing unit is equal to or longer than a predetermined time;
the controller acquires rotation information which indicates the rotation time of the developer-bearing rollers of the attached developing units and is able to determine whether or not the rotation time of the developer-bearing rollers of the developing units is equal to or longer than the predetermined time based on the acquired rotation information; and
in a case where the controller determines that the rotation time of the developer-bearing rollers of any of the attached developing units is equal to or longer than the predetermined time when the image forming apparatus is being used as a color image forming apparatus,
the controller does not output the request to the image-forming section.

8. An image forming apparatus according to claim 7, wherein:
in a case where the rotation time of the developer-bearing roller of the predetermined developing unit is equal to or longer than the predetermined time and an other developing unit with which development can be performed and which contains developer of the same color as the developer contained in the predetermined developing unit is attached to any of the plurality of attach/detach sections when the image forming apparatus is being used as a monochrome image forming apparatus,
the controller outputs the request to the image-forming section.

9. An image forming apparatus for forming images, comprising:
an image bearing member for bearing a latent image;
a plurality of attach/detach sections to and from which developing units can be attached and detached, each developing unit containing a developer and being adapted to develop the latent image using the developer;
an image-forming section for forming an image on a medium by developing the latent image; and
a controller for causing the image-forming section to form the image;
wherein each of the developing units is provided with a rotatably-supported developer-bearing roller for bearing the developer;
wherein the controller acquires rotation information which indicates a rotation time of the developer-bearing rollers of the attached developing units and is able to determine whether or not the rotation time of the developer-bearing rollers of the developing units is equal to or longer than a predetermined time based on the acquired rotation information;
wherein the controller acquires, from the image-forming section, remaining amount information indicating a remaining amount of developer contained in the attached developing units and is able to determine, based on the acquired remaining amount information, whether or not the remaining amount of developer contained in the developing units is equal to or below a predetermined amount;
wherein a medium-unit job in which the image-forming section forms an image on a single medium is generated by
the controller suitably outputting, to the image-forming section, a request for requesting formation of an image on a single medium, and
the image-forming section outputting, to the controller, an acceptance response indicating that the request has been accepted, if image formation is possible;
wherein formation of an image is started when the controller accepts an image-formation job that causes generation of at least one medium-unit job;
wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units;
wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units;
wherein by moving one of the developing units attached to the plurality of attach/detach sections to a predetermined attach/detach position, the moved developing unit is replaceable with another developing unit which has not been attached;
wherein in a case where the image forming apparatus is being used as the color image forming apparatus,
if the controller determines, as an event in which development cannot be performed by a predetermined developing unit, that the remaining amount of developer in any of the attached developing units is equal to or below the predetermined amount, and determines that the rotation time of the developer-bearing rollers of any of the attached developing units is equal to or longer than the predetermined time,
then the controller does not output the request to the image-forming section, and
when an event in which development cannot be performed by the predetermined developing unit occurs, the timing for moving the predetermined developing unit to the attach/detach position comes after forming an image according to the medium-unit job which has already been generated when the event has occurred; and
wherein in a case where the image forming apparatus is being used as the monochrome image forming apparatus,
if an other developing unit with which development can be performed and which contains developer of the same color as the developer contained in the predetermined developing unit is attached to any of the plurality of attach/detach sections when the controller determines, as the event in which development cannot be performed by the predetermined developing unit, that the remaining amount of developer in any of the attached developing units is equal to or below the predetermined amount, and determines that the rotation time of the developer-bearing rollers of any of the attached developing units is equal to or longer than the predetermined time,
then the controller outputs the request to the image-forming section,
when an event occurs in which development cannot be performed by the predetermined developing unit, the other developing unit, with which development can be performed, is moved to a position of the predetermined developing unit and images are formed according to all the medium-unit jobs generated by the image-forming job using the moved developing unit, and
the timing for moving the predetermined developing unit to the attach/detach position is after forming images based on the medium-unit jobs which have already been generated when an event occurs in which development cannot be performed with any of the attached developing units.

10. A computer-readable medium for making an image forming apparatus operate, the image forming apparatus including:
an image bearing member for bearing a latent image; and
a plurality of attach/detach sections to and from which developing units can be attached and detached, each developing unit containing a developer and being adapted to develop the latent image using the developer;
wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units;
wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units; and
wherein by moving one of the developing units attached to the plurality of attach/detach sections to a predetermined attach/detach position, the moved developing unit is replaceable with another developing unit which has not been attached;
the computer-readable medium comprising:
a code for moving, in a case where the image forming apparatus is being used as the color image forming apparatus, a predetermined developing unit to the attach/detach position at a predetermined timing when an event occurs in which development cannot be performed by the predetermined developing unit; and
a code for moving, in a case where the image forming apparatus is being used as the monochrome image forming apparatus, the predetermined developing unit to the attach/detach position at a timing different from the predetermined timing when an event occurs in which development cannot be performed by the predetermined developing unit.

11. An image forming system comprising:
(a) a computer; and
(b) an image forming apparatus for forming images and being connected to the computer, the image forming apparatus including:
an image bearing member for bearing a latent image; and
a plurality of attach/detach sections to and from which developing units can be attached and detached, each developing unit containing a developer and being adapted to develop the latent image using the developer;
wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units;
wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units;
wherein by moving one of the developing units attached to the plurality of attach/detach sections to a predetermined attach/detach position, the moved developing unit is replaceable with another developing unit which has not been attached; and
wherein the timing for moving a predetermined developing unit to the attach/detach position when an event occurs in which development cannot be performed by the predetermined developing unit is different for when the image forming apparatus is being used as the color image forming apparatus and for when the image forming apparatus is being used as the monochrome image forming apparatus.

12. An image forming method which uses an image forming apparatus for forming images, comprising:
(a) in a case where the image forming apparatus is being used as a color image forming apparatus for forming a color image by developing a latent image using developer contained in attached developing units in a state where a plurality of developing units for containing developer of mutually differing colors and developing the latent image borne by an image bearing member using the developer are respectively attached to a plurality of attach/detach sections to and from which the developing units can be attached and detached,
a step of moving, at a predetermined timing, one developing unit from among the developing units which are attached to the plurality of attach/detach sections to a predetermined attach/detach position where the developing unit can be replaced with another developing unit which has not been attached, when an event occurs in which development cannot be performed by a predetermined developing unit; and
(b) in a case where the image forming apparatus is being used as a monochrome image forming apparatus for forming a monochrome image by developing the latent image borne by the image bearing member using developer contained in the developing units in a state where the developing units containing developer of the same color are attached to at least two attach/detach sections of the plurality of attach/detach sections,
a step of moving, at a timing different from that for when the image forming apparatus is being used as the color image forming apparatus, one developing unit from among the developing units which are attached to the plurality of attach/detach sections to the attach/detach position, when an event occurs in which development cannot be performed by the predetermined developing unit.

13. An image forming apparatus for forming images, comprising:
an image bearing member for bearing a latent image;
a plurality of attach/detach sections to and from which developing units can be attached and detached, each developing unit containing a developer and being adapted to develop the latent image using the developer; and
an announcing section for announcing information indicating an event when an event requiring announcement occurs;
wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units;
wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units; and
wherein a timing for announcing, through the announcing section, information indicating an event when an event occurs in which development cannot be performed by the predetermined developing unit is different for when the image forming apparatus is being used as the color image forming apparatus and for when the image forming apparatus is being used as the monochrome image forming apparatus.

14. An image forming apparatus according to claim 13, wherein:
the information indicating the event is information urging that the predetermined developing unit be replaced with another developing unit which has not been attached.

15. An image forming apparatus according to claim 13, comprising:
an image-forming section for forming an image on a medium by developing the latent image; and
a controller for causing the image-forming section to form the image;
wherein a medium-unit job in which the image-forming section forms an image on a single medium is generated by
the controller suitably outputting, to the image-forming section, a request for requesting formation of an image on a single medium, and
the image-forming section outputting, to the controller, an acceptance response indicating that the request has been accepted, if image formation is possible; and
wherein the timing for announcing the information indicating the event through the announcing section when the image forming apparatus is being used as the color image forming apparatus comes after forming the image according to the medium-unit job which has already been generated when an event occurs in which development cannot be performed by the predetermined developing unit.

16. An image forming apparatus according to claim 13, wherein:
formation of an image is started when the controller accepts an image-formation job that causes generation of at least one medium-unit job; and
in a case where an other developing unit with which development can be performed and which contains developer of the same color as the developer contained in the predetermined developing unit is attached to any of the plurality of attach/detach sections when an event occurs in which development cannot be performed by the predetermined developing unit,
the timing for announcing the information indicating the event through the announcing section when the image forming apparatus is being used as a monochrome image forming apparatus comes after moving the other developing unit, with which development can be performed, to a position of the predetermined developing unit and forming images based on all the medium-unit jobs generated by the image-forming job using the moved developing unit.

17. An image forming apparatus according to claim 16, wherein:
in a case where an event occurs in which development cannot be performed with any of the attached developing units when the image forming apparatus is being used as the monochrome image forming apparatus,
the information indicating the event is announced through the announcing section after forming images based on the medium-unit jobs already generated.

18. An image forming apparatus according to claim 15, wherein:
an event in which development cannot be performed by the predetermined developing unit means that a remaining amount of developer contained in the predetermined developing unit is equal to or below a predetermined amount;
the controller acquires, from the image-forming section, remaining amount information indicating the remaining amount of developer contained in the attached developing units and is able to determine, based on the acquired remaining amount information, whether or not the remaining amount of developer contained in the developing units is equal to or below the predetermined amount; and
in a case where the controller determines that the remaining amount of developer in any of the attached developing units is equal to or below the predetermined amount when the image forming apparatus is being used as a color image forming apparatus,
the controller does not output the request to the image-forming section.

19. An image forming apparatus according to claim 18, wherein:
in a case where the remaining amount of developer in the predetermined developing unit is equal to or below the predetermined amount and an other developing unit with which development can be performed and which contains developer of the same color as the developer contained in the predetermined developing unit is attached to any of the plurality of attach/detach sections when the image forming apparatus is being used as a monochrome image forming apparatus,
the controller outputs the request to the image-forming section.

20. An image forming apparatus according to claim 15, wherein:
each of the developing units is provided with a rotatably-supported developer-bearing roller for bearing the developer;
an event in which development cannot be performed by the predetermined developing unit means that a rotation time of the developer-bearing roller provided to the predetermined developing unit is equal to or longer than a predetermined time;
the controller acquires rotation information which indicates the rotation time of the developer-bearing rollers of the attached developing units and is able to determine whether or not the rotation time of the developer-bearing rollers of the developing units is equal to or longer than the predetermined time based on the acquired rotation information; and
in a case where the controller determines that the rotation time of the developer-bearing rollers of any of the attached developing units is equal to or longer than the predetermined time when the image forming apparatus is being used as a color image forming apparatus,
the controller does not output the request to the image-forming section.

21. An image forming apparatus according to claim 20, wherein:
in a case where the rotation time of the developer-bearing roller of the predetermined developing unit is equal to or longer than the predetermined time and an other developing unit with which development can be performed and which contains developer of the same color as the developer contained in the predetermined developing unit is attached to any of the plurality of attach/detach sections when the image forming apparatus is being used as a monochrome image forming apparatus,
the controller outputs the request to the image-forming section.

22. An image forming apparatus for forming images, comprising:
an image bearing member for bearing a latent image;
a plurality of attach/detach sections to and from which developing units can be attached and detached, each developing unit containing a developer and being adapted to develop the latent image using the developer;
an image-forming section for forming an image on a medium by developing the latent image;
a controller for causing the image-forming section to form the image; and
an announcing section for announcing information indicating an event when an event requiring announcement occurs;
wherein each of the developing units is provided with a rotatably-supported developer-bearing roller for bearing the developer;
wherein the controller acquires, from the image-forming section, remaining amount information indicating a remaining amount of developer contained in the attached developing units and is able to determine, based on the acquired remaining amount information, whether or not the remaining amount of developer contained in the developing units is equal to or below a predetermined amount;
wherein the controller acquires rotation information which indicates a rotation time of the developer-bearing rollers of the attached developing units and is able to determine whether or not the rotation time of the developer-bearing rollers of the developing units is equal to or longer than a predetermined time based on the acquired rotation information;
wherein a medium-unit job in which the image-forming section forms an image on a single medium is generated by
the controller suitably outputting, to the image-forming section, a request for requesting formation of an image on a single medium, and
the image-forming section outputting, to the controller, an acceptance response indicating that the request has been accepted, if image formation is possible;
wherein formation of an image is started when the controller accepts an image-formation job that causes generation of at least one medium-unit job;
wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units;
wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units;
wherein in a case where the image forming apparatus is being used as the color image forming apparatus,
if the controller determines, as an event in which development cannot be performed by a predetermined developing unit, that the remaining amount of developer in any of the attached developing units is equal to or below the predetermined amount, and the image-forming section determines that the rotation time of the developer-bearing rollers of any of the attached developing units is equal to or longer than the predetermined time, then the controller does not output the request to the image-forming section, and
when an event in which development cannot be performed by the predetermined developing unit occurs, the information indicating the event is announced through the announcing section after forming an image according to the medium-unit job which has already been generated; and
wherein in a case where the image forming apparatus is being used as a monochrome image forming apparatus,
if an other developing unit with which development can be performed and which contains developer of the same color as the developer contained in the predetermined developing unit is attached to any of the plurality of attach/detach sections when the event in which development cannot be performed by the predetermined developing unit occurs due to the remaining amount of developer in the predetermined developing unit being equal to or below the predetermined amount, and when the event in which development cannot be performed by the predetermined developing unit occurs due to the rotation time of the developer-bearing roller of the predetermined developing unit being equal to or longer than the predetermined time,
then the controller outputs the request to the image-forming section, and
when an event occurs in which development cannot be performed by the predetermined developing unit, the information indicating the event is announced through the announcing section after moving the other developing unit, with which development can be performed, to a position of the predetermined developing unit and forming images according to all the medium-unit jobs generated by the image-forming job using the moved developing unit.

23. A computer-readable medium for making an image forming apparatus operate, the image forming apparatus including:
an image bearing member for bearing a latent image;
a plurality of attach/detach sections to and from which developing units can be attached and detached, each developing unit containing a developer and being adapted to develop the latent image using the developer; and
an announcing section for announcing information indicating an event when an event requiring announcement occurs;
wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units; and
wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units;
the computer-readable medium comprising:
a code for announcing, when an event occurs in which development cannot be performed by a predetermined developing unit, information indicating the event through the announcing section at a predetermined timing in a case where the image forming apparatus is being used as the color image forming apparatus; and
a code for announcing, when an event occurs in which development cannot be performed by the predetermined developing unit, information indicating the event through the announcing section at a timing different from the predetermined timing in a case where the image forming apparatus is being used as the monochrome image forming apparatus.

24. An image forming system comprising:
(a) a computer body; and
(b) an image forming apparatus for forming images and being connected to the computer, the image forming apparatus including:
an image bearing member for bearing a latent image;
a plurality of attach/detach sections to and from which developing units can be attached and detached, each developing unit containing a developer and being adapted to develop the latent image using the developer; and
an announcing section for announcing information indicating an event when an event requiring announcement occurs;
wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units;
wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units; and
wherein a timing for announcing, through the announcing section, information indicating an event when an event occurs in which development cannot be performed by the predetermined developing unit is different for when the image forming apparatus is being used as the color image forming apparatus and for when the image forming apparatus is being used as the monochrome image forming apparatus.

25. An image forming method which uses an image forming apparatus for forming images, comprising:
(a) in a case where the image forming apparatus is being used as a color image forming apparatus for forming a color image by developing a latent image using developer contained in attached developing units in a state where a plurality of developing units for containing developer of mutually differing colors and developing the latent image borne by an image bearing member using the developer are respectively attached to a plurality of attach/detach sections to and from which the developing units can be attached and detached,
a step of announcing, at a predetermined timing, information indicating an event through the announcing section, when an event occurs in which development cannot be performed by a predetermined developing unit; and
(b) in a case where the image forming apparatus is being used as a monochrome image forming apparatus for forming a monochrome image by developing the latent image borne by the image bearing member using developer contained in the developing units in a state where the developing units containing developer of the same color are attached to at least two attach/detach sections of the plurality of attach/detach sections,
a step of announcing, at a timing different from that for when the image forming apparatus is being used as the color image forming apparatus, information indicating an event through the announcing section, when an event occurs in which development cannot be performed by the predetermined developing unit.

26. An image forming apparatus for forming images, comprising:
an image bearing member for bearing a latent image; and
a plurality of attach/detach sections to and from which developing units can be attached and detached, each developing unit containing a developer and being adapted to develop the latent image using the developer;
wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units;
wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units;
wherein by moving one of the developing units attached to the plurality of attach/detach sections to a predetermined attach/detach position, the moved developing unit is replaceable with another developing unit which has not been attached; and
wherein an operation for moving a predetermined developing unit to the attach/detach position when an event occurs in which development cannot be performed by the predetermined developing unit is different for when the image forming apparatus is being used as the color image forming apparatus and for when the image forming apparatus is being used as the monochrome image forming apparatus.

27. An image forming apparatus according to claim 26, comprising:
an image-forming section for forming an image on a medium by developing the latent image; and
a controller for causing the image-forming section to form the image;
wherein a medium-unit job in which the image-forming section forms an image on a single medium is generated by
the controller suitably outputting, to the image-forming section, a request for requesting formation of an image on a single medium, and
the image-forming section outputting, to the controller, an acceptance response indicating that the request has been accepted, if image formation is possible; and
wherein, when the image forming apparatus is being used as the color image forming apparatus, the predetermined developing unit is moved to the attach/detach position after forming the image according to the medium-unit job which has already been generated when an event occurs in which development cannot be performed by the predetermined developing unit.

28. An image forming apparatus according to claim 26, wherein:
formation of an image is started when the controller accepts an image-formation job that causes generation of at least one medium-unit job; and
in a case where the image forming apparatus is being used as a monochrome image forming apparatus and an other developing unit with which development can be performed and which contains developer of the same color as the developer contained in the predetermined developing unit is attached to any of the plurality of attach/detach sections when an event occurs in which development cannot be performed by the predetermined developing unit,
the predetermined developing unit is moved to the attach/detach position after moving the other developing unit, with which development can be performed, to a developing position and forming images based on all the medium-unit jobs generated by the image-forming job using the moved developing unit.

29. An image forming apparatus according to claim 26, wherein:
in a case where an event occurs in which development cannot be performed with any of the attached developing units when the image forming apparatus is being used as the monochrome image forming apparatus,
the developing units in which the event of not being able to perform development has occurred are moved to the attach/detach position after forming images based on the medium-unit jobs already generated.

30. An image forming apparatus according to claim 27, wherein:
an event in which development cannot be performed by the predetermined developing unit means that a remaining amount of developer contained in the predetermined developing unit is equal to or below a predetermined amount;
the controller acquires, from the image-forming section, remaining amount information indicating the remaining amount of developer contained in the attached developing units and is able to determine, based on the acquired remaining amount information, whether or not the remaining amount of developer contained in the developing units is equal to or below the predetermined amount; and
in a case where the controller determines that the remaining amount of developer in any of the attached developing units is equal to or below the predetermined amount when the image forming apparatus is being used as a color image forming apparatus,
the controller does not output the request to the image-forming section.

31. An image forming apparatus according to claim 30, wherein:
in a case where the remaining amount of developer in the predetermined developing unit is equal to or below the predetermined amount and an other developing unit with which development can be performed and which contains developer of the same color as the developer contained in the predetermined developing unit is attached to any of the plurality of attach/detach sections when the image forming apparatus is being used as a monochrome image forming apparatus,
the controller outputs the request to the image-forming section.

32. An image forming apparatus according to claim 27, wherein:
each of the developing units is provided with a rotatably-supported developer-bearing roller for bearing the developer;
an event in which development cannot be performed by the predetermined developing unit means that a rotation time of the developer-bearing roller provided to the predetermined developing unit is equal to or longer than a predetermined time;
the controller acquires rotation information which indicates the rotation time of the developer-bearing rollers of the attached developing units and is able to determine whether or not the rotation time of the developer-bearing rollers of the developing units is equal to or longer than the predetermined time based on the acquired rotation information; and
in a case where the controller determines that the rotation time of the developer-bearing rollers of any of the attached developing units is equal to or longer than the predetermined time when the image forming apparatus is being used as a color image forming apparatus,
the controller does not output the request to the image-forming section.

33. An image forming apparatus according to claim 32, wherein:
in a case where the rotation time of the developer-bearing roller of the predetermined developing unit is equal to or longer than the predetermined time and an other developing unit with which development can be performed and which contains developer of the same color as the developer contained in the predetermined developing unit is attached to any of the plurality of attach/detach sections when the image forming apparatus is being used as a monochrome image forming apparatus,
the controller outputs the request to the image-forming section.

34. An image forming apparatus for forming images, comprising:
an image bearing member for bearing a latent image;
a plurality of attach/detach sections to and from which developing units can be attached and detached, each developing unit containing a developer and being adapted to develop the latent image using the developer;
an image-forming section for forming an image on a medium by developing the latent image; and
a controller for causing the image-forming section to form the image;
wherein each of the developing units is provided with a rotatably-supported developer-bearing roller for bearing the developer;
wherein the controller acquires, from the image-forming section, remaining amount information indicating a remaining amount of developer contained in the attached developing units and is able to determine, based on the acquired remaining amount information, whether or not the remaining amount of developer contained in the developing units is equal to or below a predetermined amount;
wherein the controller acquires rotation information which indicates a rotation time of the developer-bearing rollers of the attached developing units and is able to determine whether or not the rotation time of the developer-bearing rollers of the developing units is equal to or longer than a predetermined time based on the acquired rotation information;
wherein a medium-unit job in which the image-forming section forms an image on a single medium is generated by
the controller suitably outputting, to the image-forming section, a request for requesting formation of an image on a single medium, and
the image-forming section outputting, to the controller, an acceptance response indicating that the request has been accepted, if image formation is possible;
wherein formation of an image is started when the controller accepts an image-formation job that causes generation of at least one medium-unit job;
wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units;
wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units;
wherein by moving one of the developing units attached to the plurality of attach/detach sections to a predetermined attach/detach position, the moved developing unit is replaceable with another developing unit which has not been attached;
wherein in a case where the image forming apparatus is being used as the color image forming apparatus,
if the controller determines, as an event in which development cannot be performed by a predetermined developing unit, that the remaining amount of developer in any of the attached developing units is equal to or below the predetermined amount, and determines that the rotation time of the developer-bearing rollers of any of the attached developing units is equal to or longer than the predetermined time,
then the controller does not output the request to the image-forming section, and
when an event in which development cannot be performed by the predetermined developing unit occurs, the predetermined developing unit is moved to the attach/detach position after forming an image according to the medium-unit job which has already been generated; and
wherein in a case where the image forming apparatus is being used as a monochrome image forming apparatus,
if an other developing unit with which development can be performed and which contains developer of the same color as the developer contained in the predetermined developing unit is attached to any of the plurality of attach/detach sections when the event in which development cannot be performed by the predetermined developing unit occurs due to the remaining amount of developer in the predetermined developing unit being equal to or below the predetermined amount, and when the event in which development cannot be performed by the predetermined developing unit occurs due to the rotation time of the developer-bearing roller of the predetermined developing unit being equal to or longer than the predetermined time,
then the controller outputs the request to the image-forming section, and
when an event occurs in which development cannot be performed by the predetermined developing unit, the predetermined developing unit is moved to the attach/detach position after moving the other developing unit, with which development can be performed, to a position of the predetermined developing unit and forming images according to all the medium-unit jobs generated by the image-forming job using the moved developing unit.

35. A computer-readable medium for making an image forming apparatus operate, the image forming apparatus including:
an image bearing member for bearing a latent image; and
a plurality of attach/detach sections to and from which developing units can be attached and detached, each developing unit containing a developer and being adapted to develop the latent image using the developer;
wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units;
wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units; and
wherein by moving one of the developing units attached to the plurality of attach/detach sections to a predetermined attach/detach position, the moved developing unit is replaceable with another developing unit which has not been attached;
the computer-readable medium comprising:
a code for executing, in a case where the image forming apparatus is being used as the color image forming apparatus, an operation of moving a predetermined developing unit to the attach/detach position when an event occurs in which development cannot be performed by the predetermined developing unit; and
a code for moving, in a case where the image forming apparatus is being used as the monochrome image forming apparatus, the predetermined developing unit to the attach/detach position according to an operation different from the above-mentioned operation of moving the predetermined developing unit to the attach/detach position when an event occurs in which development cannot be performed by the predetermined developing unit.

36. An image forming system comprising:
(a) a computer; and
(b) an image forming apparatus for forming images and being connected to the computer, the image forming apparatus including:
an image bearing member for bearing a latent image; and
a plurality of attach/detach sections to and from which developing units can be attached and detached, each developing unit containing a developer and being adapted to develop the latent image using the developer;
wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units;
wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units;
wherein by moving one of the developing units attached to the plurality of attach/detach sections to a predetermined attach/detach position, the moved developing unit is replaceable with another developing unit which has not been attached; and
wherein an operation for moving a predetermined developing unit to the attach/detach position when an event occurs in which development cannot be performed by the predetermined developing unit is different for when the image forming apparatus is being used as the color image forming apparatus and for when the image forming apparatus is being used as the monochrome image forming apparatus.

37. An image forming system comprising:
(a) a computer; and
(b) an image forming apparatus for forming images and being connected to the computer, the image forming apparatus including:
an image bearing member for bearing a latent image; and
a plurality of attach/detach sections to and from which developing units can be attached and detached, each developing unit containing a developer and being adapted to develop the latent image using the developer;
wherein, in a state where a plurality of the developing units which contain developer of mutually differing colors are respectively attached to the plurality of attach/detach sections, the image forming apparatus is usable as a color image forming apparatus for forming a color image by developing the latent image borne by the image bearing member using the developer contained in the attached developing units;
wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units;
wherein by moving one of the developing units attached to the plurality of attach/detach sections to a predetermined attach/detach position, the moved developing unit is replaceable with another developing unit which has not been attached; and
wherein an operation for moving a predetermined developing unit to the attach/detach position when an event occurs in which development cannot be performed by the predetermined developing unit is different for when the image forming apparatus is being used as the color image forming apparatus and for when the image forming apparatus is being used as the monochrome image forming apparatus.

38. An image forming apparatus for forming images, comprising:
an image bearing member for bearing a latent image; and
a plurality of attach/detach sections to and from which developing units can be attached and detached, each developing unit containing a developer and being adapted to develop the latent image using the developer;
wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units;
wherein a predetermined operation is executed based on information indicating a state of the developing unit; and
wherein the predetermined operation is executed when an event in which all of the attached developing units have entered a predetermined state is detected based on the information, when the image forming apparatus is being used as the monochrome image forming apparatus.

39. An image forming apparatus according to claim 38, comprising:
an image-forming section for forming an image on a medium by developing the latent image; and
a controller for causing the image-forming section to form the image;
wherein a medium-unit job in which the image-forming section forms an image on a single medium is generated by
the controller suitably outputting, to the image-forming section, a request for requesting formation of an image on a single medium, and
the image-forming section outputting, to the controller, an acceptance response indicating that the request has been accepted, if image formation is possible; and
wherein the predetermined operation is executed after forming the image according to the medium-unit job which has already been generated at the time of detection of the event of entering the predetermined state.

40. An image forming apparatus according to claim 38, wherein:
the predetermined state is a state of not being able to perform development with the developing unit.

41. An image forming apparatus according to claim 40, wherein:
the state of not being able to perform development is when a remaining amount of developer contained in the developing unit is equal to or below a predetermined amount.

42. An image forming apparatus according to claim 40, wherein:
each of the developing units is provided with a rotatably-supported developer-bearing roller for bearing the developer; and
the state of not being able to perform development is when a rotation time of the developer-bearing roller is equal to or longer than a predetermined time.

43. An image forming apparatus according to claim 39, comprising:
an announcing section for announcing information for indicating an event when an event requiring announcement occurs; and
the predetermined operation is an operation of announcing, with the announcing section, an event in which a state of not being able to perform development with the developing unit has been entered.

44. An image forming apparatus according to claim 39, wherein:
by moving, to a predetermined attach/detach position, one developing unit from among the developing units attached to the plurality of attach/detach sections, the moved developing unit can be replaced with an other developing unit which has not been attached; and
the predetermined operation is an operation of moving, to the attach/detach position, a developing unit which has entered a state of not being able to perform development.

45. An image forming apparatus according to claim 38, wherein:
each of the developing units can perform development after being moved to a predetermined developing position; and
in a case where a state of not being able to perform development with one of the attached developing units is entered when the image forming apparatus is being used as the monochrome image forming apparatus, an other developing unit with which development can be performed is moved to the developing position.

46. An image forming apparatus according to claim 45, wherein:
in a case where a plurality of the other developing units with which development can be performed are attached, the developing unit with the shortest moving distance to the developing position is moved to the developing position.

47. An image forming apparatus according to claim 38, wherein:
the predetermined state is a state in which a state of not being able to perform development with the developing unit should be forewarned.

48. An image forming apparatus according to claim 47, comprising:
an announcing section for announcing information for indicating an event when an event requiring announcement occurs;
wherein the predetermined operation is an operation of announcing with the announcing section an event in which the state, in which the state of not being able to perform development with the developing unit should be forewarned, has been entered.

49. An image forming apparatus according to claim 47, wherein:
the state of not being able to perform development is when a remaining amount of developer contained in the developing unit is equal to or below a predetermined amount.

50. An image forming apparatus for forming images, comprising:
an image bearing member for bearing a latent image;
a plurality of attach/detach sections to and from which developing units can be attached and detached, each developing unit containing a developer and being adapted to develop the latent image using the developer;
an image-forming section for forming an image on a medium by developing the latent image;
a controller for causing the image-forming section to form the image; and
an announcing section for announcing information for indicating an event when an event requiring announcement occurs;
wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units;
wherein each of the developing units can perform development after being moved to a predetermined developing position;
wherein by moving, to a predetermined attach/detach position, one developing unit from among the developing units attached to the plurality of attach/detach sections, the moved developing unit can be replaced with an other developing unit which has not been attached;
wherein a medium-unit job in which the image-forming section forms an image on a single medium is generated by
the controller suitably outputting, to the image-forming section, a request for requesting formation of an image on a single medium, and
the image-forming section outputting, to the controller, an acceptance response indicating that the request has been accepted, if image formation is possible;
wherein a predetermined operation is executed based on information indicating a state of the developing unit; and
wherein, in a case where the image forming apparatus is being used as the monochrome image forming apparatus:
when an event, in which a state is entered where a state that a remaining amount of developer contained in the developing units is equal to or below a predetermined amount should be forewarned, is detected, the event is announced with the announcing section,
when an event, in which the remaining amount of developer contained in any of the attached developing units has become equal to or below the predetermined amount, is detected, the developing unit with the shortest moving distance to the developing position, among other attached developing units with which development can be performed, is moved to the developing position, and
when an event in which the remaining amount of developer contained in all of the attached developing units has become equal to or below the predetermined amount is detected, the developing units in which the remaining amount of developer has become equal to or below the predetermined amount are moved to the attach/detach section after forming an image according to the medium-unit job which has already been generated,
based on the above-mentioned information.

51. A computer-readable medium for making an image forming apparatus operate, the image forming apparatus including:
an image bearing member for bearing a latent image; and
a plurality of attach/detach sections to and from which developing units can be attached and detached, each developing unit containing a developer and being adapted to develop the latent image using the developer;
wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units;
the computer-readable medium comprising:
a code for executing, in a case where the image forming apparatus which executes a predetermined operation based on information indicating a state of the developing unit is being used as the monochrome image forming apparatus, the predetermined operation when an event in which all of the attached developing units have entered a predetermined state is detected based on the information.

52. An image forming system comprising:
(a) a computer; and
(b) an image forming apparatus for forming images and being connected to the computer, the image forming apparatus including:
an image bearing member for bearing a latent image; and
a plurality of attach/detach sections to and from which developing units can be attached and detached, each developing unit containing a developer and being adapted to develop the latent image using the developer;
wherein, in a state where the developing units which contain developer of the same color are attached to at least two of the attach/detach sections of the plurality of attach/detach sections, the image forming apparatus is usable as a monochrome image forming apparatus for forming a monochrome image by developing the latent image borne by the image bearing member using the developer which is contained in those developing units; and
wherein the image forming apparatus executes a predetermined operation based on information indicating a state of the developing unit;
wherein the predetermined operation is executed when an event in which all of the attached developing units have entered a predetermined state is detected based on the information, when the image forming apparatus is being used as the monochrome image forming apparatus.

53. An image forming method which uses an image forming apparatus for forming images, comprising:
(a) in a case where the image forming apparatus is being used as a monochrome image forming apparatus for forming a monochrome image by developing a latent image borne by an image bearing member using developer contained in developing units, in a state in which the developing units which contain developer of the same color for developing the latent image borne by the image bearing member are attached to at least two attach/detach sections of a plurality of attach/detach sections to and from which the developing units for developing the latent image can be attached and detached,
a step of detecting, based on information indicating a state of the developing unit, an event in which all the attached developing units have entered a predetermined state; and
(b) a step of executing a predetermined operation when the event is detected.
